(19) United States
(12) Patent Application Publication
(10) Pub. No.: US 2010/0176733 A1
(43) Pub. Date: Jul. 15, 2010

(54) Automated Dimming Methods and Systems For Lighting

(75) Inventor: Ray James King, Carolina Beach, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: PureSpectrum, Inc.

(21) Appl. No.: 12/434,403

(22) Filed: May 1, 2009

Related U.S. Application Data
(63) Continuation-in-part of application No. 12/397,921, filed on Mar. 4, 2009.
Application No. 12/397,921 is a continuation-in-part of application No. 12/353,551, filed on Jan. 14, 2009.

(51) Int. Cl. H05B 37/02

(52) U.S. Cl. 315/158; 315/297; 315/224; 315/210

(57) ABSTRACT

Automated control systems and methods for lighting systems are described herein. In certain embodiments, the control systems include either an improved dimmable ballast, an improved dimmer circuit, or both. The control systems are suitable for various applications including a light harvesting system and a security lighting system.

### CROSS REFERENCE TO RELATED APPLICATIONS

This application is a continuation-in-part of U.S. application Ser. No. 12/397,921, filed Mar. 4, 2009, and a continuation-in-part of U.S. application Ser. No. 12/353,551, filed Jan. 14, 2009, both of which are herein incorporated by reference in their entireties.

### FIELD OF THE INVENTION

The present invention disclosed herein relates generally to energy saving electronic lighting devices and, more particularly, to methods and apparatus for automated dimming of light sources in an efficient and effective manner.

### BACKGROUND OF THE INVENTION

In the field of electronic lighting ballasts, some light sources (e.g., gas discharge lamps, fluorescent lamps, etc.) generally present a negative resistance, which causes a power source to increase the amount of current provided to the light source. If not limited, the light source, or the power source, or both, would encounter a catastrophic failure. As a result, a ballast circuit is typically provided to limit the current that the power source provides to the light source.

In many applications, it is desirable to be able to dim the light source. In residential applications, dimmers are often used to create a desirable lighting atmosphere (“mood” lighting) and/or save energy. However, conventional dimmer circuits were initially designed for resistive loads, such as incandescent light bulbs. In addition, such dimmer circuits were designed to operated with loads greater than 40 watts. Using a conventional dimmer with a conventional ballast operating with a fluorescent light, can lead to problems, because fluorescent lights are not resistive loads, but reactive loads that are primarily capacitive in nature. Furthermore, many fluorescent lights, such as compact fluorescent lamps, are less than 40 watts. Thus, using a convention dimmer on a fluorescent light can lead to flicker or limited operability (dimming) of the light source. Thus, this can preclude use of a dimmer with a single conventional compact fluorescent light bulb in a lamp. As a result, conventional dimmers are typically not operated with light sources that require ballast circuits that limit the amount of current. Thus, there is a need for a two-wire dimmer that can work with fluorescent lights.

Fluorescent ballasts have been adapted to permit automated dimming of fluorescent lamps. In “daylight harvesting,” shown diagrammatically in FIG. 1, a photosensor measures the amount of illumination present in a room, for example at a worker's station, or the amount of light entering a window or skylight, or present outside the building. The system alters the level of electric lighting according to the amount of daylight that contributes to illumination. An “open loop” system relies only on the measured daylight and does not feed back information about the overall illumination in the work area. A “closed loop” system measures and feeds back such information, taking into consideration the effect of adjustments made to electric lighting levels. Dimming electric lighting is an advantageous way to make such adjustments.

Typically, a controller determines whether the measured illumination is increasing or decreasing and adjusts electric lighting in proportion to the amount of desired illumination that is being provided by sunlight. The controller generates control signals to vary the power to electric lighting circuits. In the case of fluorescent lighting, the required dimmable ballast can be in the controller, or can be associated with a light fixture and receive control signals from the controller for the purpose of setting the amount of dimming needed at a particular time.

The system design typically defines control zones comprising one or more simultaneously controlled fixtures. Each group of fixtures must be wired so that each member fixture can be subject to logical control. Factors influencing which fixtures to group in a control zone include the distance of the fixtures from windows, and their proximity to a work surface or location of a particular activity. Having many control zones increases flexibility and control accuracy, but also increases cost and installation complexity.

In many prior art systems, due to the design of the ballast, the energy savings achieved by dimming a light fixture does not always correspond to the reduction in light. In other words, when the light output is reduced by 25% through dimming, the energy consumption may drop by less than 25%. For some applications, such as daylight harvesting (where the main goal is saving energy), such a lack of corresponding energy savings diminishes the potential benefits of the daylight harvesting system.

From the foregoing, it may be seen that the cost of a dimmable ballast has a significant impact on the overall cost of a daylight harvesting installation. A low cost dimmable ballast that can be installed with each fixture would allow a designer to provide more control zones and allow more flexibility in setting up or altering control zones without increasing cost. Making each fixture a separate zone may be possible. If such a ballast is compatible with the DALI (Digital Addressable Lighting Interface) lighting control protocol, individual fixtures can be dimmed individually in a daylight harvesting system. Retrofitting existing non-dimmable fixtures with dimmable ballasts may become economically feasible.

Furthermore, a dimmer circuit and dimmable ballast that not only have a relatively small number of components assembled at a relatively low cost, but also achieve energy savings nearly proportional to the amount of reduction in light output through dimming, would prove advantageous in automated dimming systems.

### SUMMARY OF THE INVENTION

Systems and methods for automatically adjusting lighting are disclosed which seek to address needs described above. One such system for automatically adjusting a light source in response to a control signal, comprises a controller configured to generate a control signal based on a parameter associated with an area that the light source is positioned to illuminate; a ballast circuit configured to be coupled to receive a time-varying DC voltage at a first node with respect to a second node, the DC voltage varying at twice a line frequency, and the DC voltage being rectified from an AC voltage power source alternating at the line frequency, wherein the ballast circuit is configured to present a DC voltage varying at twice the line frequency across the first terminal and the second terminal of a bypass capacitor, wherein the ballast circuit is further configured to allow the DC voltage to drop to 15% or less of a peak value of the DC voltage every half cycle of the line frequency and the ballast circuit comprising a first switch coupled to the first node operable to selectively couple the first node to a resonant circuit, the resonant circuit having a resonant frequency less than a first frequency and configured to be coupled to a light source, wherein the resonant circuit stores energy during a first portion of a cycle of the first frequency, and a second switch operable to selectively couple the resonant circuit to the second node during a second portion of the cycle of the first frequency; the first and second switches being configured to be coupled to provide an operating voltage to the light source positioned to provide illumination to the area; and a dimming circuit coupled to the controller and to the ballast circuit, the dimming circuit configured to receive and modify an AC line voltage based on the control signal to produce the time-varying DC voltage. In one embodiment of the invention, the system further comprises a sensor positioned to monitor the parameter in the area as the parameter changes over time. The parameter may be selected from the group consisting of: illumination level in the area; occupancy of the area; time of day in the area. The system may be applied advantageously in a daylight harvesting system, for example. In another embodiment, the parameter is a first parameter and the controller is configured to generate a control signal based on the first parameter and on a second parameter associated with the area. A second sensor may be provided to monitor the second parameter.

Another system according to the present invention for automatically adjusting illumination of an area in response to a control signal, comprises a ballast circuit coupled to a light source, the ballast circuit configured to be coupled to receive a time-varying DC voltage at a first node with respect to a second node, the DC voltage varying at twice a line frequency, and the DC voltage being rectified from an AC voltage power source alternating at the line frequency, wherein the ballast circuit is configured to present the DC voltage varying at twice the line frequency across a first terminal and a second terminal of a bypass capacitor, wherein the ballast circuit is further configured to allow the DC voltage drops to 15% or less of a peak value of the DC voltage every half cycle of the line frequency, and the ballast circuit comprising a first switch coupled to the first node operable to selectively couple the first node to a resonant circuit, the resonant circuit having a resonant frequency less than a first frequency and configured to be coupled to a light source, wherein the resonant circuit stores energy during a first portion of a cycle of the first frequency, and a second switch operable to selectively couple the resonant circuit to the second node during a second portion of the cycle of the first frequency; the first and second switches being coupled to provide an operating voltage to the light source; a power switch coupled to the ballast circuit, the power switch being selectively alterable from a first state in which the power switch allows an AC line voltage to the ballast circuit to a second state in which the power switch prevents the AC line voltage to the ballast circuit based on a control signal; and a controller configured to generate the control signal and to provide the control signal to the power switch so as to selectively alter the state of the power switch based on a parameter associated with an area the light source is positioned to illuminate. The system may include a plurality of the ballast circuits each coupled to one of a plurality of the light sources; and a plurality of the power switches each coupled to a respective one of the ballast circuits; in which case the controller is configured to be capable of selectively determining the content of the control signal for each of the power switches so as to selectively determine the state of each the power switches based on the parameter.

Another such system for automatically adjusting a light source in response to a control signal, comprises a controller configured to generate a control signal based on a parameter associated with an area a light source is positioned to illuminate; a dimmer circuit comprising a solid state switch configured to selectively couple a first node to a second node, wherein the first node receives a line voltage at a line frequency; a biasing circuit coupled with the controller and configured to actuate the solid state switch after a delay after the beginning of a half-cycle of the line frequency, the delay based on the control signal received from the controller; and a charge circuit coupled to the first node, the second node, and to a gate of the solid state switch, the charge circuit configured to maintain activation of the solid state switch for a period of time beginning with the actuating of the solid state switch and ending prior to ending of the half-cycle; and a dimmable ballast coupled receive a modified line voltage from the dimming circuit and coupled to provide an operating voltage to the light source positioned to provide illumination to the area. The dimmable ballast may, in one embodiment, be of the type described above. Again, the system may comprise one or more sensors positioned to monitor one or more parameters in the area, and the parameters may include, for example, illumination level in the area, occupancy of the area, or time of day in the area. In one embodiment, the solid state switch comprises a silicon controlled rectifier (SCR).

Another such system for automatically adjusting one or more light sources including a gas-discharge lamp in response to a control signal, comprises a controller configured to generate a control signal based on a parameter associated with an area one or more light sources including a gas-discharge lamp are positioned to illuminate; a dimming circuit coupled to the controller, the dimming circuit configured to receive and modify an AC line voltage based on the control signal to produce a time-varying DC voltage; and a ballast circuit configured to receive the time-varying DC voltage, the ballast circuit comprising a full wave bridge circuit configured to provide a rectified voltage during each half cycle of a line voltage frequency; a switching circuit configured to receive the rectified voltage and providing an alternating voltage at a switching frequency, the alternating voltage comprising a plurality of cycles with an envelope in a shape of the time varying DC voltage produced by the dimming circuit; a first capacitor configured across the output of the full wave bridge discharging energy at the switching frequency; a tank circuit configured to be coupled to the gas-discharge lamp in a cold cathode configuration, the gas-discharge lamp coupled to a first output node and a second output node, the tank circuit configured to receive the alternating voltage across a first and second input node, the tank circuit configured to generate an alternating output voltage across the first output node and the second output node in response to receiving the alternating voltage, wherein the alternating output voltage is sufficient to ionize the gas discharge lamp once every half cycle of the line voltage frequency, and wherein the alternating output voltage is insufficient to maintain ionization of the gas discharge lamp once every half cycle of the line frequency; the output of the gas-discharge lamp varying based on changes in the parameter. The tank circuit in one embodiment includes a tapped inductor comprising a first portion and a second portion, a second capacitor, and a third capacitor, wherein the tapped inductor is isolated from a first DC component of the alternating input voltage by the second capacitor, and wherein the tank circuit has a resonance frequency determined by the second portion of the inductor and the third capacitor. The dimming circuit may comprise a solid state switch configured to selectively couple a third node to a fourth node, wherein the third node receives a line voltage at a line frequency; a biasing circuit coupled with the controller and configured to actuate the solid state switch after a delay after the beginning of a half-cycle of the line frequency, the delay based on the control signal received from the controller; and a charge circuit coupled to said third node, the fourth node, and to a gate of the solid state switch, the charge circuit configured to maintain activation of the solid state switch for a period of time beginning with the actuating of the solid state switch and ending prior to ending of the half-cycle.

One such method for automatically adjusting lighting comprises a method of automatically adjusting a light source in response to changes in ambient illumination level, comprising: measuring the illumination level in an area; providing an AC line voltage at a line frequency to a dimming circuit; modifying the line voltage with the dimming circuit in response to the measured level of illumination in the area; utilizing the modified line voltage to charge energy in a non-electrolytic bypass capacitor that is discharged every half cycle at the line frequency, the bypass capacitor coupled to a first node and a second node; storing energy in the bypass capacitor to subsequently produce a high frequency current from the bypass capacitor; selectively coupling the bypass capacitor to a resonant circuit via the first node for a first time period, wherein coupling the resonant circuit to the first node results in an operating voltage at a light source, wherein the operating voltage at the light source is the result of the combination of at least a first current from an output of the dimming circuit at the line frequency and the high frequency current from the bypass capacitor; and selectively coupling the resonant circuit to the second node for a second time period, wherein coupling the second node generates a negative voltage in the resonant circuit at the light source and allows energy from the dimming circuit to be stored in the bypass capacitor. In one embodiment, the step of selectively coupling the bypass capacitor to a resonant circuit via the first node comprises coupling the resonant circuit to a first terminal of a rectifier wherein the rectifier produces an unfiltered DC voltage having a rectified sine wave shape at twice the line frequency, and when an AC voltage at the input of the rectifier crosses a zero voltage point, the voltage at the light source is insufficient to ionize the bulb.

Another such method for automatically adjusting lighting comprises a method of automatically adjusting a light source in response to changes in ambient illumination level, comprising: measuring the illumination level in an area; providing a line voltage at a line frequency to a first node in a dimming circuit; modifying the line voltage with the dimming circuit in response to the measured level of illumination in the area, comprising: actuating a solid state switch by a biasing circuit to couple the first node to a second node after a delay after the beginning of a half-cycle of the line frequency; controlling the delay based on variations in the measured illumination level; maintaining activation of the solid state switch, by a charge circuit coupled to the first node, the second node, and to a gate of the solid state switch, for a period of time beginning with the actuation and ending prior to ending of the half-cycle; and providing the modified line voltage to a dimmable ballast coupled to provide an operating voltage to a light source positioned to provide illumination to the area. In one embodiment the solid state switch comprises a silicon controlled rectifier (SCR).

Another such method for automatically adjusting lighting in response to changes in ambient illumination level, comprises illuminating an area by one or more light sources including a gas-discharge lamp; measuring the illumination level in the area; providing an AC line voltage at a line frequency to a dimming circuit; modifying the line voltage with the dimming circuit in response to the measured level of illumination in the area; receiving the modified line voltage at a ballast circuit; receiving an alternating input voltage at a first input node and a second input node at a tank circuit of the ballast circuit; generating an alternating output voltage at a third node in the tank circuit, wherein a first capacitor and an inductor are coupled in series between the first input node and the third node, wherein the inductor has a tap, the alternating output voltage is provided to a first terminal of the lamp, wherein the lamp has a second terminal coupled to the second input node; and charging a second capacitor in response to a third voltage generated at the tap wherein the second capacitor has a first terminal coupled to the tap and a second terminal coupled to the second input node.

Dimmer circuits for use with the automated dimming systems of the present application are disclosed. One such dimmer circuit includes a switch to selectively couple a first node to a second node. In particular, the first node receives a line voltage from a power source which is provided to the second node when the switch is biased ON. A biasing circuit is operable to actuate the switch after a delay during each half-cycle of the line voltage. Further, the delay of the biasing circuit is typically based on a setting provided by a user. A charge circuit provides energy to the switch for a period of time to maintain the actuation of the switch for a portion of the duration of the half-cycle. In particular, the charge circuit is operable to provide energy to the switch such that the switch remains biased in the event of an operating condition that, in some instances, would cause the switch to open prematurely. This operating condition is due to a ‘ringing current’ that can cause the switch to become prematurely unlatched, causing undesirable operation. Thus, the charge circuit ensures that once the switch is biased ON, it remains ON for a portion of the duration of the half cycle, specifically during the duration that the ringing current may occur.

The charge circuit generally comprises a circuit that generates a voltage from the line voltage. The voltage generated by the charge circuit is provided in part by energy stored in a capacitor, for example. However, if the voltage generated in the charge circuit exceeds a certain threshold, a further circuit is operable to remove excess voltage from the capacitor. Further, the charge circuit comprises a second switch that is implemented by a transistor in one embodiment to provide a current to the switch in response to the switch actuating.

Dimmable ballast circuits for use with the automated dimming systems of the present application also are disclosed. One such dimmable ballast circuit includes a power source coupled to a first node and a second node, the power source having a current that alternates at a line frequency. The first node and the second node are coupled to each other via a capacitor that stores high frequency energy and provides current at a first (high) frequency, which exceeds the line frequency of the power source and presents a high impedance to the line frequency. A DC voltage varying at twice the line frequency is present across the first terminal and the second terminal of this bypass capacitor, and further the DC voltage drops to 15% or less of a peak value of the DC voltage every half cycle of the line frequency. This capacitor is small enough in capacitance value relative to the load and the line frequency that it does not distort the rectified AC input from the power source. A first switch is operable to selectively couple the energy storage device to a resonant circuit via the first node. The resonant circuit has a resonant frequency and stores energy during a first portion of a cycle of the first frequency thereby causing light to be emitted. A second switch is operable to selectively couple the resonant circuit via the second node to cause energy stored in the resonant circuit to be substantially recycled via the capacitor. When the second switch closes, this reverses the voltage across the lamp during a second portion of the cycle at the first frequency, also causing light to be emitted.

### BRIEF DESCRIPTION OF THE DRAWINGS

FIG. 1 is a schematic diagram of an automated dimming system according to an embodiment of the present invention.

FIG. 2a is a block diagram of the system of FIG. 1 showing detail of a controller used in implementation of the embodiment.

FIGS. 2b and 2c show examples of computer devices that can be used to implement the present invention.

FIG. 3 is a block diagram of one embodiment of a dimming unit in accordance with aspects of the present invention.

FIG. 4 is a schematic diagram of an embodiment of a dimming circuit usable with automated dimming systems according to the present invention.

FIG. 5 is another schematic diagram of another embodiment of a circuit usable with automated dimming systems according to the present invention.

FIGS. 6a-6d depict embodiments of circuits for dimming a compact fluorescent bulb, usable with automated dimming systems according to the present invention.

FIGS. 7a and 7b represent different amounts of energy provided to a CFL at different dimming levels.

FIG. 8 represents one embodiment of a light harvesting system.

FIG. 9 represents another embodiment of the present invention in a light-dimming system.

FIGS. 10a-c illustrate a block diagram of one embodiment of a ballast circuit according to the principles of the present invention having a high power factor and usable with automated dimming systems according to the present invention, along with voltage waveforms produced therein.

FIGS. 11a and 11b are schematic diagrams of example ballast circuits usable with automated dimming systems according to the present invention.

FIG. 11c illustrates a voltage waveform diagram associated with the operation of an exemplary rectifier of the circuit of FIG. 11a.

FIG. 11d is a voltage waveform diagram that illustrates the operation of an exemplary regulator of the circuit of FIG. 11a.

FIGS. 12a and 12b are circuits that illustrate the operation of the example circuit of FIG. 11a.

FIG. 13 is a voltage waveform diagram that illustrates the voltage at the light source in the resonant circuit of FIG. 11a.

FIGS. 14a-c illustrates one embodiment of an inductor core used in the tank circuit of the ballast of FIG. 11a.

FIG. 15 illustrates another embodiment of a ballast usable with automated dimming systems according to the present invention, configured to operate in a cold cathode fluorescent bulb configuration.

FIG. 16 illustrates voltage waveforms associated with the cold cathode ballast during operation.

FIG. 17 illustrates the cold cathode ballast circuit with a dimmer circuit.

FIGS. 18a-b illustrate voltage waveforms associated with the cold cathode ballast with a dimmer.

FIG. 19 illustrates a cold cathode tank circuit coupled to an energy savings circuit.

FIG. 20 illustrates one embodiment of the tank circuit of the cold cathode ballast configured to generate a signal voltage.

FIG. 21 is a flow diagram of a process involving occupancy detection carried out in operation of an automated dimming system according to the present invention shown in FIGS. 1 and 2.

FIG. 22 is a flow diagram of a process involving illumination level detection carried out in operation of an automated dimming system according to the embodiment of the present invention shown in FIGS. 1 and 2.

### DETAILED DESCRIPTION

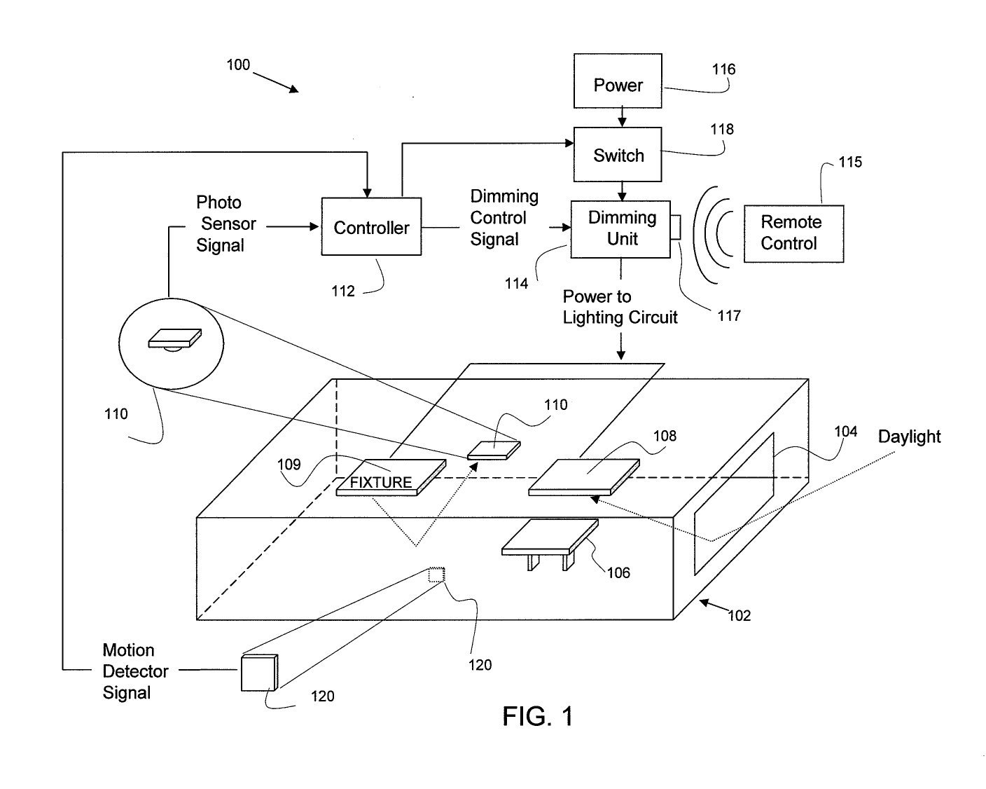

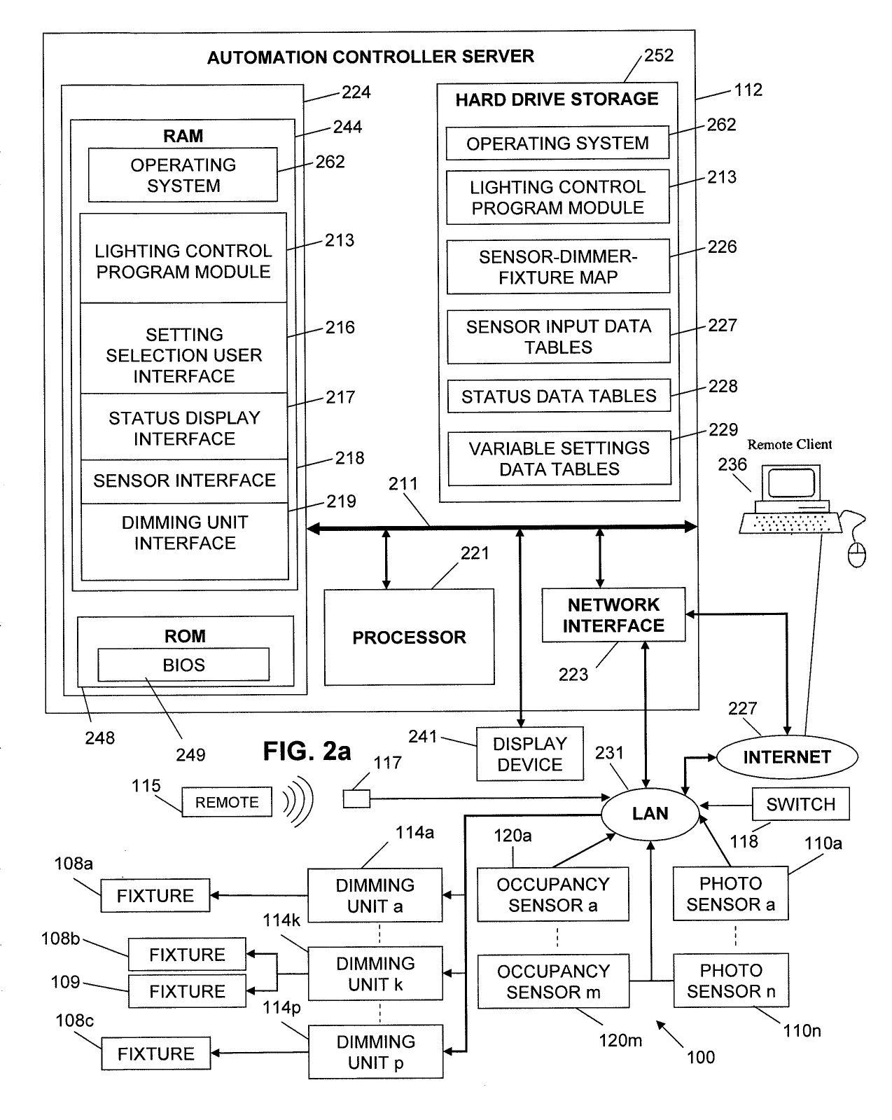

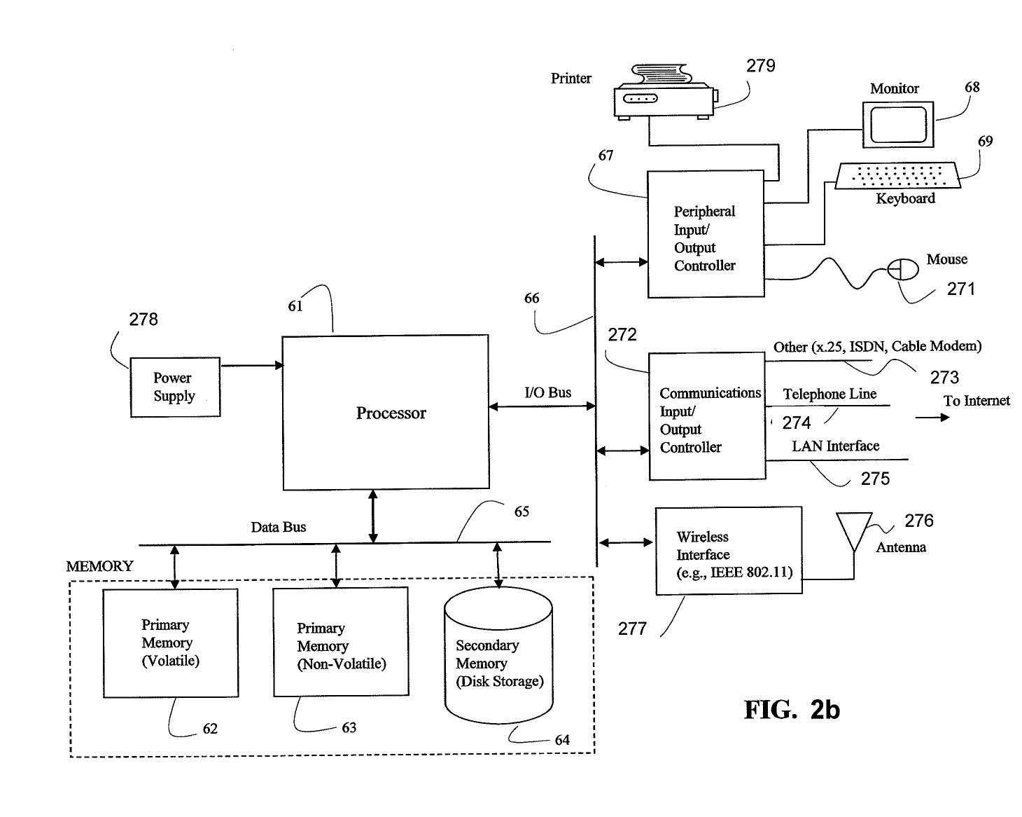

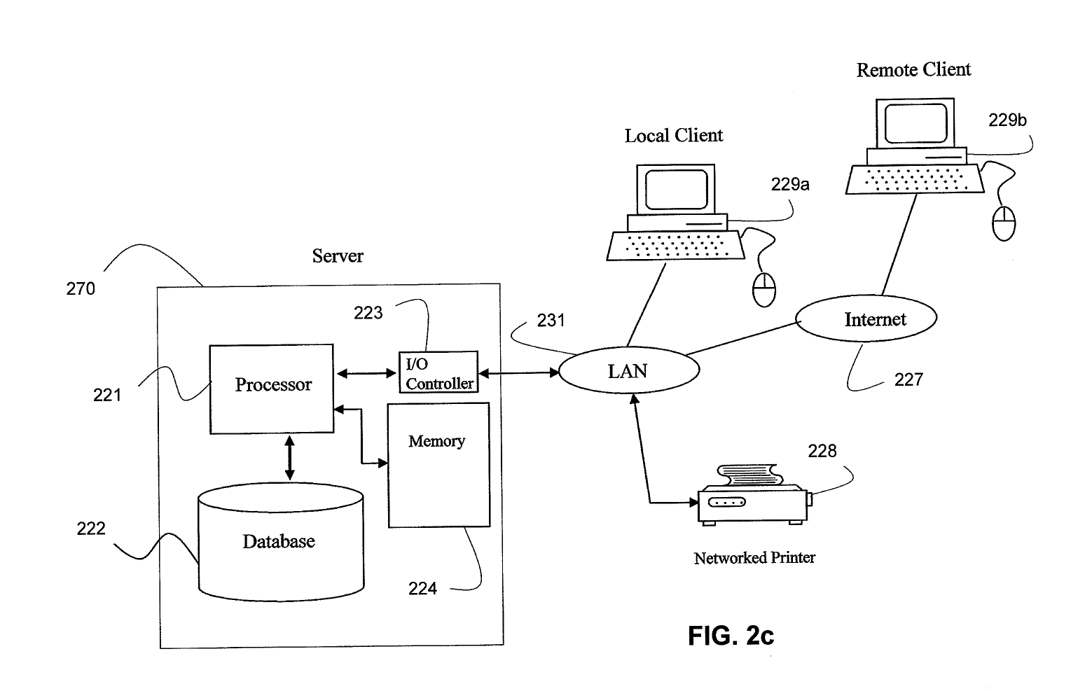

One application of a daylight harvesting system 100 according to the present invention, in an office environment, is shown diagrammatically and by way of example in FIG. 1. An office 102, shown in isolation from surrounding rooms of a building, includes a window 104, a table 106 providing a work surface, a ceiling fluorescent light fixture 108 between the table and the window, and a second ceiling fluorescent light fixture 109 spaced farther into the room from the window. The daylight harvesting system 100 (described in more detail below) includes a photosensor 110, here shown mounted on the ceiling spaced into the room suitable for closed loop control. In other embodiments, multiple photosensors may be provided. A controller 112 receives a signal from the photosensor or photosensors representing a measurement of the illumination in particular areas of the office from all sources. The photosensor 110, for example, may be positioned to measure illumination from daylight and electric sources on the work surface. The controller 112 may be a microprocessor or other computing device such as shown and described in connection with FIGS. 2a-c, programmed with executable computer code embodying the logic required to control the system as described herein. The controller 112 may be implemented as a server in a network environment. In the alternative, the controller functions are carried out by a logic controller programmed with firmware or a programmed logic array.

The controller 112 is configured to provide a dimming control signal to a dimming unit 114. The dimming control unit controls the power supplied to the ballast, and therefore the light output, for each light fixture in a control group. In one embodiment, the fixtures 108 and 109 are controlled separately, so that during daylight hours fixture 108 is made brighter than fixture 109, which is closer to the window and therefore in an area receiving more sunlight. As the sun sets or the window becomes shadowed, the fixtures will become closer in their controlled output. If the window were on a long wall of the room 102 between the fixtures 108 and 109, then in another embodiment the fixtures might be in the same control group receiving the same power supply changes from the dimming unit 114. A signal generated by an occupancy sensor 120 positioned to monitor the presence of any person in the room 102 may also be directed to the controller 112. The occupancy sensor may be, for example, a conventional motion detector or a conventional infrared body heat sensor. The controller may use the occupancy sensor signal to dim or turn off the light fixtures 108 and/or 109 when the room is unoccupied. For this purpose, the controller 112 measures each duration of lack of occupancy and compares it to minimum duration data stored in a digital memory selected to indicate lack of an occupant. When the measured duration of lack of occupancy exceeds the stored minimum, the controller instructs the dimming unit 114 to dim the lights, or instructs a digitally controllable power switch 118 providing power from an electric power supply 116 to the dimming unit 144 to disable power to the dimming unit. Upon receiving a subsequent signal from the occupancy sensor 120 indicating the presence of a person in the room 102, the controller will instruct the power switch 118 to enable power to be provided from the power supply 116 to the dimming unit 114 and instruct the dimming unit 114 to bring the lights up to a level responsive to the photosensor signal. If the motion sensor is positioned in a safety zone where light will always be provided, such as an interior hallway or stairwell, the power to the light fixtures may remain enabled and a low illumination level maintained despite an extended lack of motion.

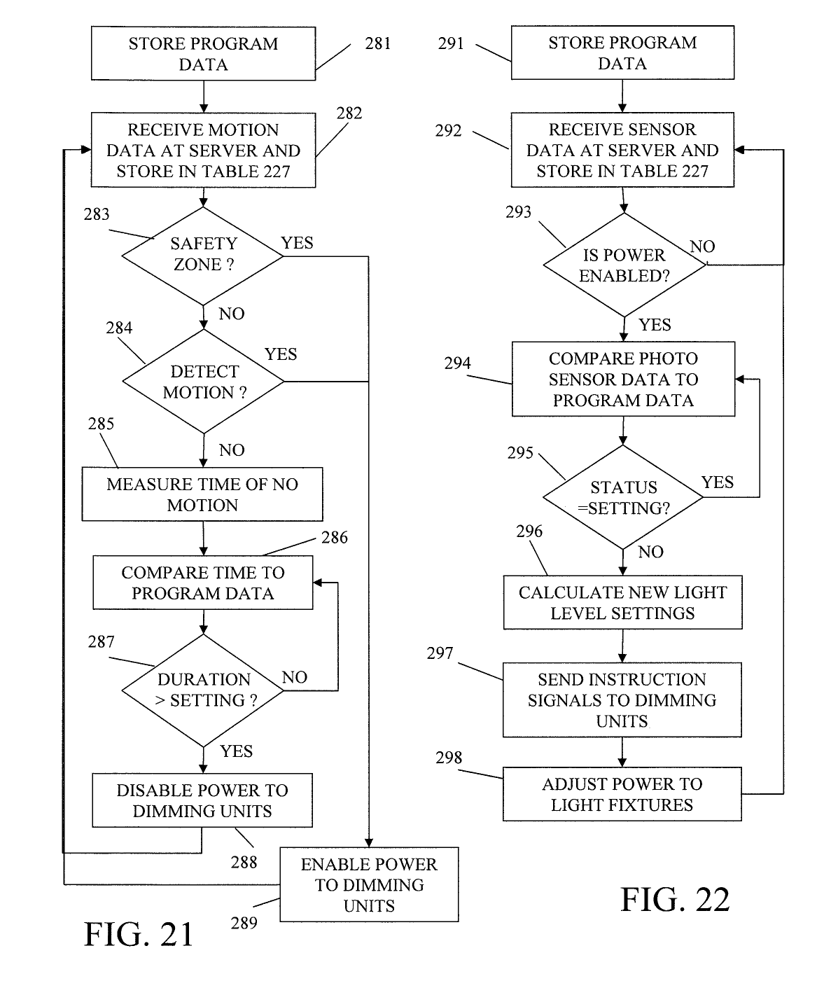

The manner in which the dimming unit 114 controls the output of a light source is described below in connection with FIGS. 21 and 22.

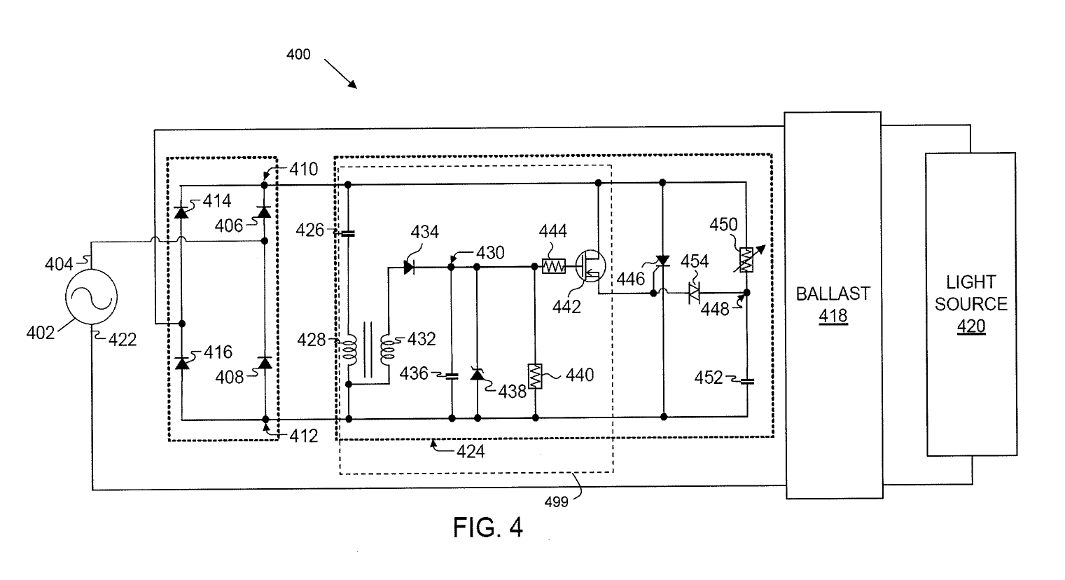

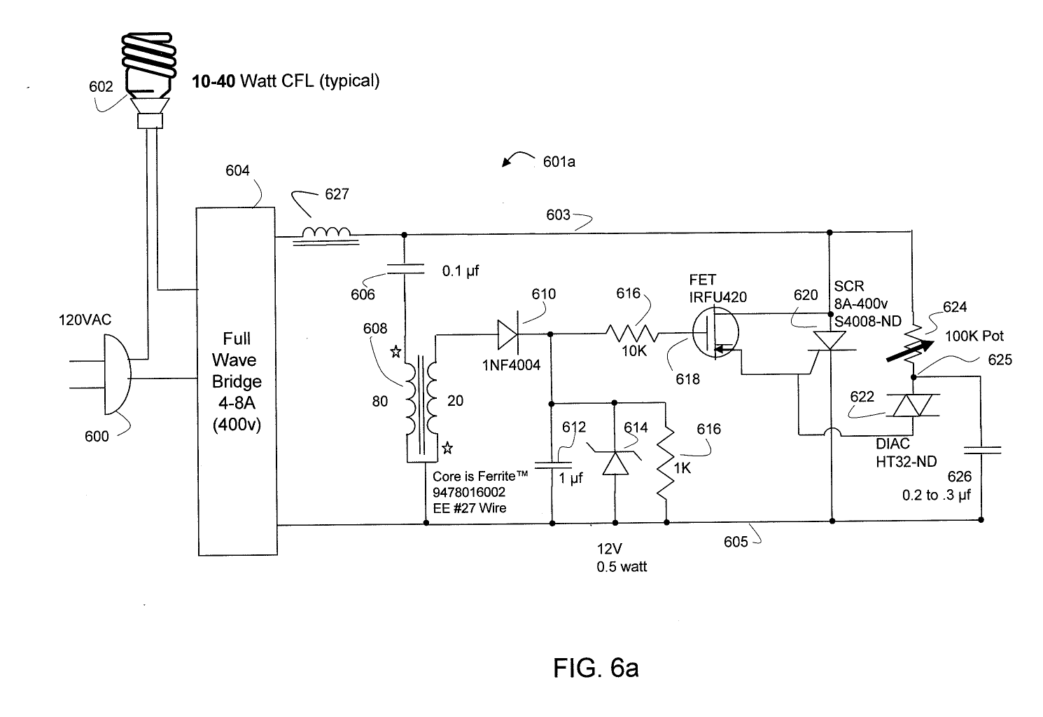

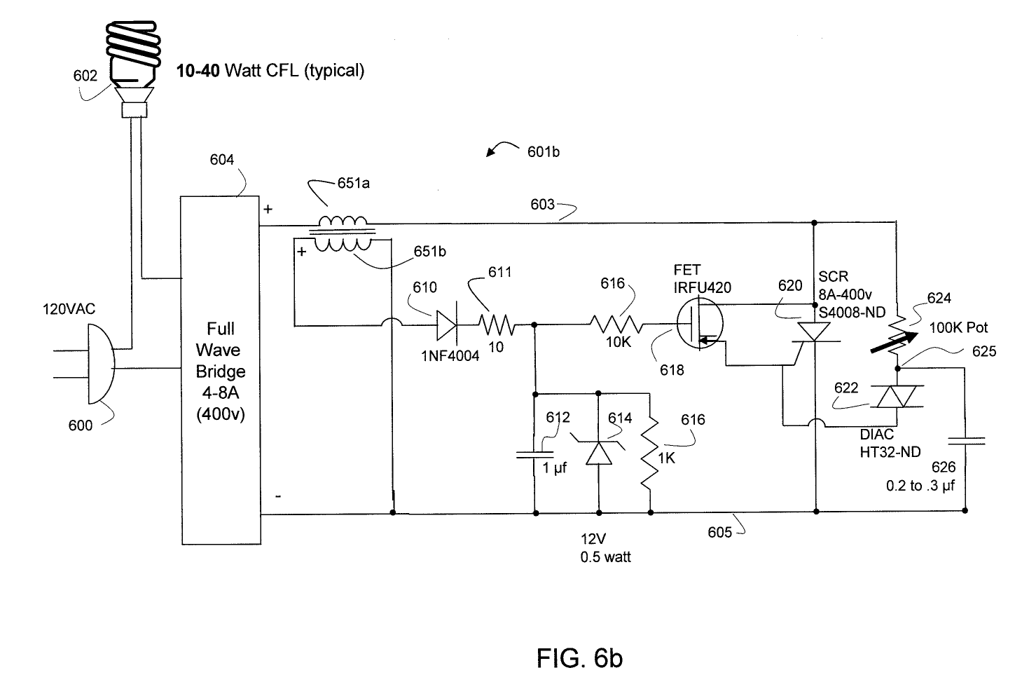

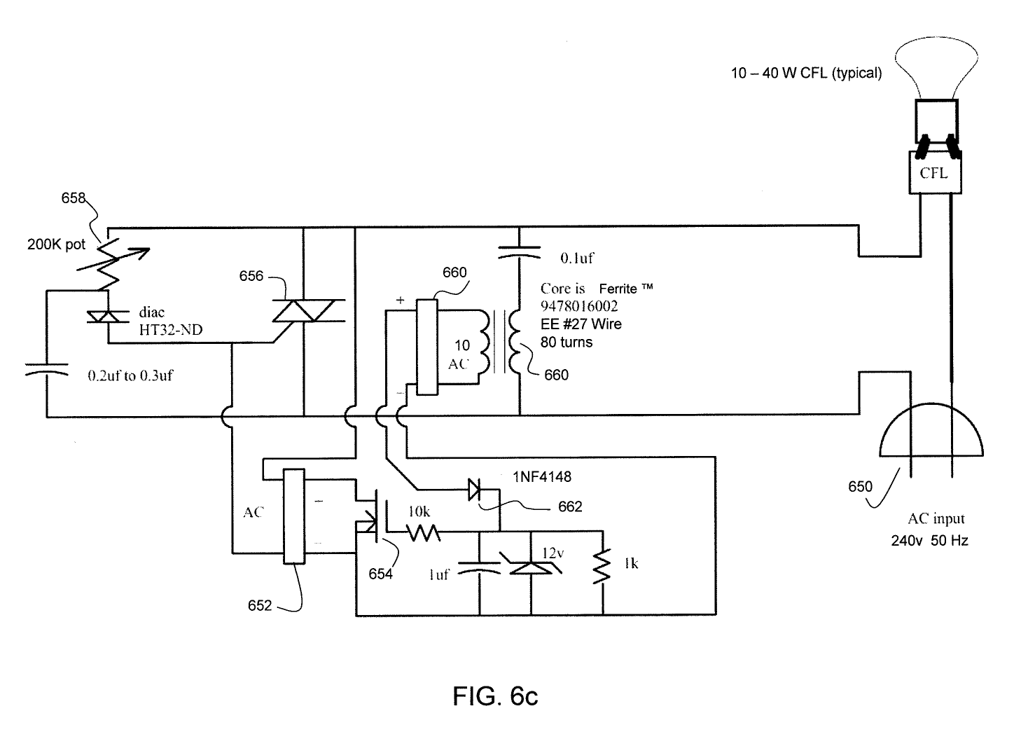

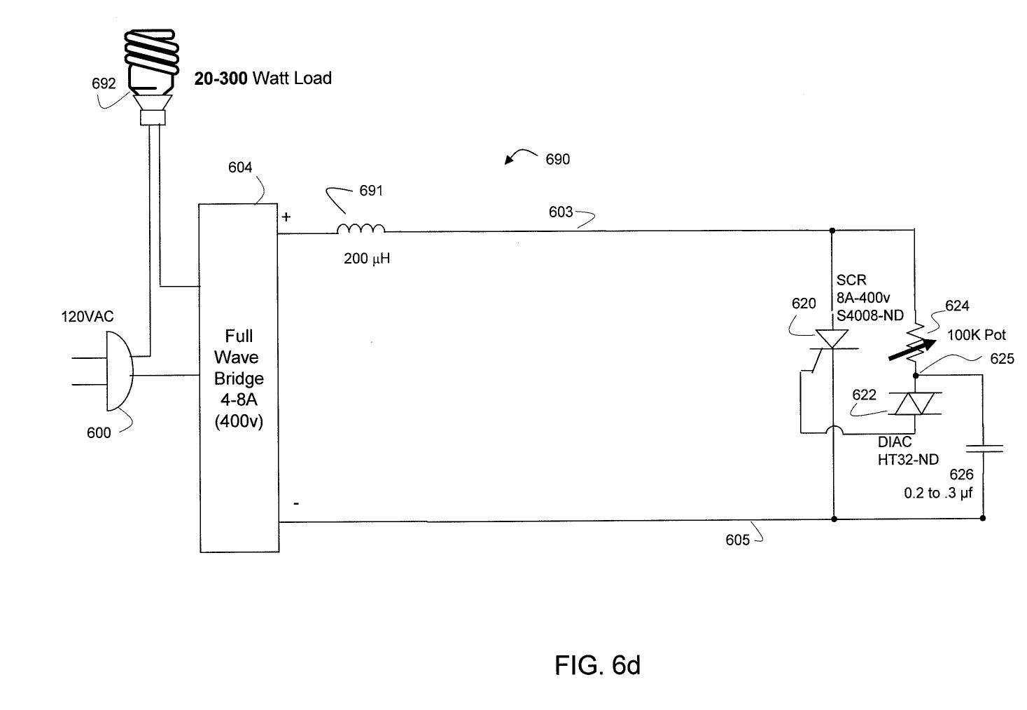

In the alternative, the dimming unit 114 can be controlled by signals from a manually operated potentiometer control 115 which sends control signals to alter, in a well known manner, the setting of a potentiometer (see description below in connection with FIGS. 4 and 6) within the dimming unit 114. In FIGS. 1 and 2a, the control 115 is shown as a wireless remote control whose wireless signals are received by a receiver 117 of the dimming unit. The receiver 117 is coupled via the LAN 231, described below, to provide the signals to the potentiometer. Alternatively, the control 115 may be hardwired to the dimming unit.

In another embodiment, illumination of an area may be varied in response to similar parameters (illumination level, occupancy, time of day, etc.) by turning on or off one or more light sources, rather than dimming light sources. This approach may be referred to as time cycling or time proportioning. In this embodiment, the dimming unit 114 is omitted from the system, and the power switch 118 is instructed by the controller 112 when to alter the state of a light fixture by turning it on or off, When a plurality of light sources are used to illuminate the area, the controller may be configured to provide to the power switch of each light fixture a control signal having content instructing the addressable power switch to set the state of the light fixtures to on or off in a particular spatial pattern with respect to the area, in order to reduce or increase its illumination by the group of light sources. Furthermore, the controller may be configured to rotate over time which of the group of fixtures is switched on or off to create desired patterns, so as to even out the effect of repeated cycling on and off on the fixtures of the group.

In a variation of this embodiment, the dimmer units 114 may be included in the system and may be used to gradually transition those light sources that are to be turned on or off. For example, assume the controller 112 has determined from sensor data that less illumination is needed in an area being monitored, and that one portion of a group of light fixtures should be turned off. The area might be, for example, a large room containing many cubicles, monitored by one or more photosensors, and lit by ceiling fixtures coupled to a common controller 112. Rather than addressing the power switches 118 of the portion of fixtures to be turned off, the controller may first address the respective dimming units 114 and cause the fixtures to be slowly dimmed over a short time chosen to last as short as a few seconds (for example 10 seconds) or as long as a few minutes (for example 2 minutes), and then cause the respective power switches to disable power to the fixtures.

The approach just described has the benefit of avoiding abrupt changes in lighting level that may be annoying to or noticeable by persons in the area. Whereas dimming all of the fixtures in the area to reach the same illumination level would lower the power factor of the group of fixtures, this approach leaves one portion of the group undimmed, maintaining their original power factor. Dimming a portion of the fixtures over a short period of time and then turning them off will not significantly decrease the power factor over a longer period of illuminating the area. The same approach may be implemented when fixtures that are off are to be turned on.

The ballast circuits disclosed in detail below are particularly suitable for use in the time proportioning embodiments just described because they are better adapted to repeated cycling of power on and off to the ballast. In many other ballasts in the prior art, the presence of a power factor correction circuit can result in an initial current surge when the ballast is initially turned on, such that repeatedly turning on a ballast (and particularly a plurality of ballasts) repeatedly creates current surges onto power supply lines. Thus, while the power factor correction circuitry in prior art ballasts improves the power factor during normal operation, it typically fails to eliminate surges when the ballast is initially turned on. In contrast, the ballast circuits disclosed herein experience no surge problem under on/off cycling conditions.

Also, when using dimmers to gradually increase illumination of the fixtures to full, many prior fluorescent ballasts present the problem that the ballast must first ignite the lamp at full brightness and then dim it to the requested level. Thus persons in an illuminated area might see an initial bright flash even when the light is initially turned on to a low level. Ballasts disclosed herein operate in a manner that allows a fluorescent lamp to come on initially at the requested dimming level.

### System Implementation

FIG. 2a provides a schematic diagram of an automation controller server 112 according to one exemplary embodiment of the invention. As shown, the server 112 may include a processor 221 that communicates with other elements within the server 112 via a system interface or bus 211. The processor 221 could be, for example, a central processing unit, microprocessor, microcontroller, programmable gate array, or some other device that processes data. Also interfacing with the server 112 of this exemplary embodiment is a display device 241 for receiving and displaying output data, for example showing the status of the automation system 100. The display may include, for example, a monitor, cathode ray tube (CRT), liquid crystal display (LCD), or other such device. Other embodiments may use a personal computer for such an output device. The server 112 may further include an internal memory 224, which includes both random access memory (RAM) 244 and read only memory (ROM) 248. The computer's ROM 248 may be used to store a basic input/output system 249 (BIOS), containing the basic routines that help to transfer information between elements within the server 112.

In addition, the automation controller server 112 may include at least one storage device 252, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 252 communicate with the system bus 211 by an appropriate interface. The storage devices 252 and their associated computer-readable media provide nonvolatile storage. The computer-readable media described above could be replaced by any other type of computer-readable media known in the art. Such media include, for example, magnetic cassettes, flash memory cards, digital video disks, and Bernoulli cartridges.

A number of program modules comprising, for example, one or more computer-readable program code portions executable by the processor 221, may be stored by the various storage devices 252 and within RAM 244. Such program modules may include an operating system 262, a lighting control program module 213, and numerous other modules (not shown) for various functions of an automated dimming system. The lighting control module 213 controls certain aspects of the operation of the server 112, as is described in more detail herein, with the assistance of the processor 221 and the operating system 262. The lighting control program module 213 contains software needed to present and administer the rating control system 100 as described herein, including a setting selection user interface module 216, a sensor interface 218, a dimming unit interface 219 and a status display interface module 217.

The storage device 252 may also include data repositories or databases of program and output data (as described above) that may be contained in one or more data tables, such as SQL data tables. In the alternative, such data may be stored in another device elsewhere on the network. The data tables include a table or map 226 of the relationship between the various photo and occupancy sensors, dimming units, and light fixtures, one or more tables 227 of data received from the sensors (optionally kept for performance analysis, for example), one or more system status tables 228 storing the output instructions sent to dimming units, and one or more tables 229 of user definable settings indicating at what level lighting fixtures should be set in response to variations in sensor data. The desired settings may take into consideration many factors. For example, separate settings may be established to maintain hallway lighting at a safe level.

The time and date at which particular data were received or sent may be stored with the data in tables 226, 227, 228, and 229. Status reports may be compiled from stored current sensor readings and current dimming level instructions. Analyses of the performance of the system can be conducted using historical data from the storage device 252 and the relevant times and dates.

Also located within the server 112 is a network interface 223, for interfacing and communicating with other elements of a computer network, such as a remote client device 236 which a user can utilize to run a browser and access the user interfaces of the system 100 as described herein via the Internet 227. For example, a user may be able to adjust settings stored in the tables 229 from a remote client device 236 couple to the server 112 by the Internet 227 or a local area network 231. It will be appreciated by one of ordinary skill in the art that one or more of the server 112 components may be located geographically remotely from other server 112 components. Furthermore, one or more of the components may be combined, and additional components performing functions described herein may be included in the server 112.

Various elements of the system 100 may be coupled to the server 112 by one or more hardwired or wireless networks described in more detail below. In FIG. 2a, the network interface 223 facilitates communications between the server 112 and both the LAN 231 and the Internet 227. A plurality of photo sensors 110a . . . 110n are shown linked to provide signals via the LAN to the server 112, the signals representing measured light levels in respective areas monitored by the photo sensors. Similarly, a plurality of occupancy sensors 120a . . . 120m are shown linked to provide signals via the LAN to the server 112, the signals representing measured occupancy in respective areas monitored by the occupancy sensors. Also, a plurality of dimming units 114a . . . 114p are shown linked to receive signals via the LAN from the server 112, the signals carrying instructions for setting dimming levels in associated light fixtures 108 and 109. In FIG. 2a, for example, dimming unit 114a controls dimming of a single fixture 108a, whereas dimming unit 114k controls multiple fixtures 108b and 109 at the same level, and dimming unit 114p controls fixture 108c. Dimming units 114a, 114k, and 114p may each provide different power output to their respectively controlled fixtures to provide different illumination levels from each fixture or group of fixtures. A dimming unit 114 at a particular location may include a single dimmer circuit as described herein, or multiple dimmer circuits may be included within a single enclosure or on a common printed circuit board.

Although FIG. 2a shows these communications via the LAN 231, the components could communicate with the server 112 via the Internet 227 or other wireless or hardwired network.

Some method steps of the present invention may involve updating computer memories or transferring information from one computer memory to another. Other examples of computer components that can be used to implement the present invention (for example, the modules or components of FIG. 2a) are described in connection with FIGS. 2b and 2c. Turning to FIG. 2b, one embodiment of a computer is illustrated that can be used to practice aspects of the present invention, such as the various computer systems described herein. The systems and methods of the present invention can be implemented using computer hardware and computer readable memory containing information and instructions to carry out the disclosed method. In FIG. 2b, a processor 61, such as a microprocessor, is used to execute software instructions for carrying out the defined steps. The processor receives power from a power supply 278 that also provides power to the other components as necessary. The processor 61 communicates using a data bus 65 that is typically 16 or 32 bits wide (e.g., in parallel). The data bus 65 is used to convey data and program instructions, typically, between the processor and memory. In the present embodiment, memory can be considered primary memory 62, that is RAM or other forms which retain the contents only during operation, or it may be non-volatile 63, such as ROM, EPROM, EEPROM, FLASH, or other types of memory that retain the memory contents at all times. The memory could also be secondary memory 64, such as disk storage, that stores large amount of data. In some embodiments, the disk storage may communicate with the processor using an I/O bus 66 instead or a dedicated bus (not shown). The secondary memory may be a floppy disk, hard disk, compact disk, DVD, or any other type of mass storage type known to those skilled in the computer arts. One of ordinary skill will recognize that as data is transferred between two or more computing devices (in accordance with the above-described processing steps), the data is read from and written to one or more of these memory areas and the memory area is physically changed as a result of the process.

The processor 61 also communicates with various peripherals or external devices using an I/O bus 66. In the present embodiment, a peripheral I/O controller 67 is used to provide standard interfaces, such as RS-232, RS422, DIN, USB, or other interfaces as appropriate to interface various input/output devices. Typical input/output devices include local printers 279, a monitor 68, a keyboard 69, and a mouse 271 or other typical pointing devices (e.g., rollerball, trackpad, joystick, etc.).

The processor 61 typically also communicates using a communications I/O controller 272 with external communication networks, and may use a variety of interfaces such as data communication oriented protocols 273 such as X.25, ISDN, DSL, cable modems, etc. The communications controller 272 may also incorporate a modem (not shown) for interfacing and communicating with a standard telephone line 274. Finally, the communications I/O controller may incorporate an Ethernet interface 275 for communicating over a LAN. Any of these interfaces may be used to access the Internet, intranets, LANs, or other data communication facilities.

Also, the processor 61 may communicate with a wireless interface 277 that is coupled to an antenna 276 for communicating wirelessly with other devices, using for example, one of the IEEE 802.11 protocols, 802.15.4 protocol, or a standard 3G wireless telecommunications protocols, such as CDMA2000 1x EV-DO, GPRS, W-CDMA, or other protocol.

A further alternative embodiment of a processing system that may be used is shown in FIG. 2c. In this embodiment, a distributed communication and processing architecture is shown involving, for example, a server 270 communicating with either a local client computer 229a or a remote client computer 229b. The server 270 may implement the controller 112, and include processor 221 that communicates with a database 222, which can be viewed as a form of secondary memory, as well as primary memory 224. One or more databases 222 can implement the data tables 226, 227, 228, and 229. The processor also communicates with external devices using an I/O controller 223 that typically interfaces with local area network (LAN) 231. The LAN may provide local connectivity to a networked printer 228 and the local client computer 229a. These may be located in the same facility as the server, though not necessarily in the same room. Communication with remote devices typically is accomplished by routing data from the LAN 631 over a communications facility to the Internet 227. A remote client computer 229b may execute a web browser, so that the remote client 229b may interact with the server 112 as required by transmitted data through the Internet 227, over the LAN 231, and to the server 112.

### Automated Dimming

Many factors influence the lighting assistance provided by the sun to such an office. For example, it may receive light at times of the day different from other offices in the same building because of different exposures (e.g., south, north, east and west). Furthermore, offices on the same side of the building may be in the shadow of a neighboring building for different periods of time.

According to embodiments of the present invention, light fixtures such as fixtures 108 and 109 in rooms or offices may be coupled with associated light sensors 110 to detect ambient lighting conditions relevant to the associated light fixtures, and provide a signal based on the lighting conditions to the controller 112 which processes the signals. By reference to desired lighting conditions stored in a digital memory, the controller then determines which light fixtures to dim and when. The selective dimming of various lights can be used, for example, to “balance” or average the light in a work environment by dimming lights adjacent to a window having, for example, an eastern exposure in the early morning (when the morning light is brighter). Further, the controller may be coupled to a dimming unit 114 or a dimmer circuit as disclosed below and programmed with executable computer code (software) to change dimming levels as described above. The changes may be made at a slow pace such that the change in light output is hardly perceived by the occupants, and does not cause lighting fixtures to blink. The dimmer circuit may be coupled with processors, timers, light detectors, occupancy detectors, and/or other circuitry in various ways to efficiently dim a lighting source as needed.

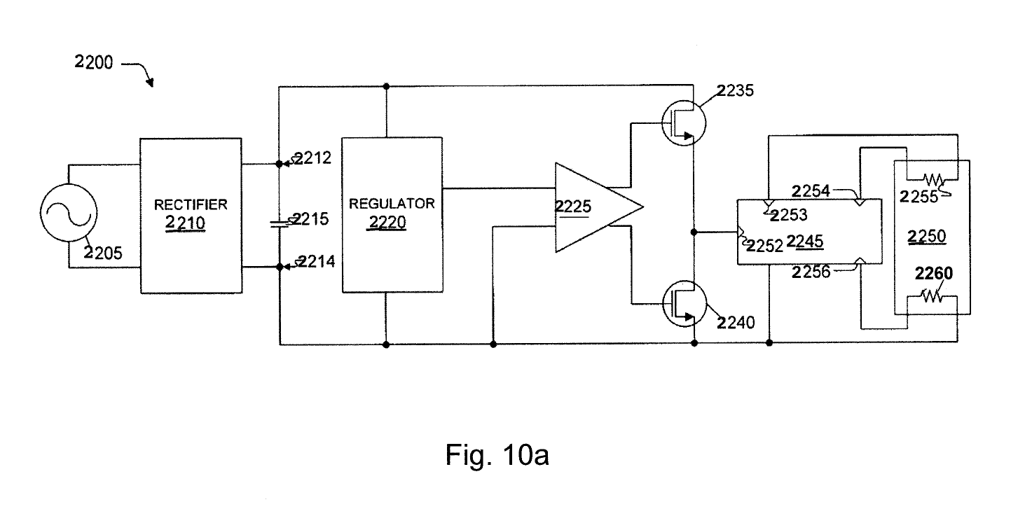

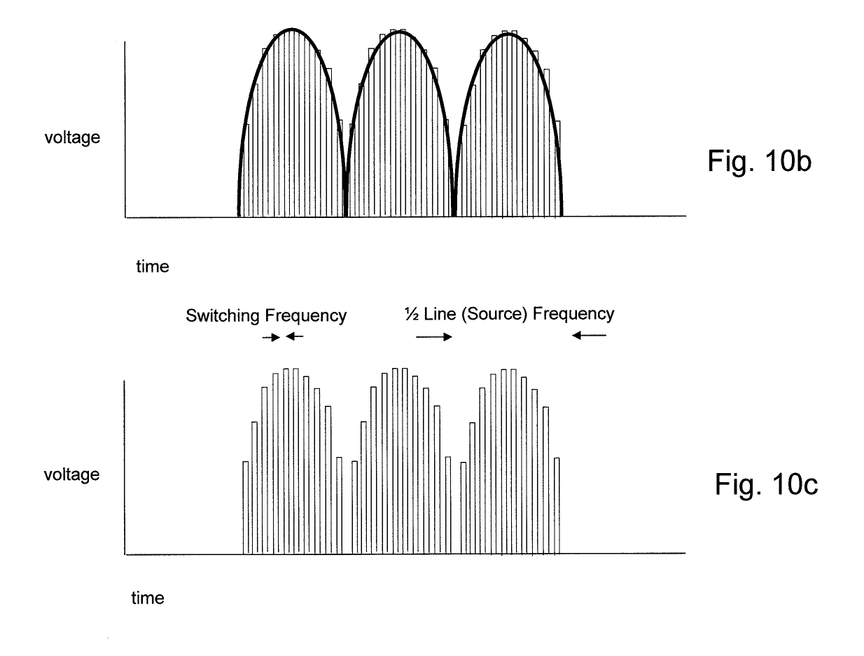

Furthermore, automated dimming systems using the disclosed dimmer circuit benefit from providing power to light sources via one of the ballast circuits disclosed herein. FIGS. 10-14 show ballasts useful, for example, for gas discharge lamps having filaments. These ballasts operate at a high power factor and allow continuous and steady dimming of coupled light fixtures without blinking through a large range of maximum output. As dimming is applied, these ballasts utilize less energy in close relation to the degree of dimming. Also, their component structure has a relatively long lifetime of operation.

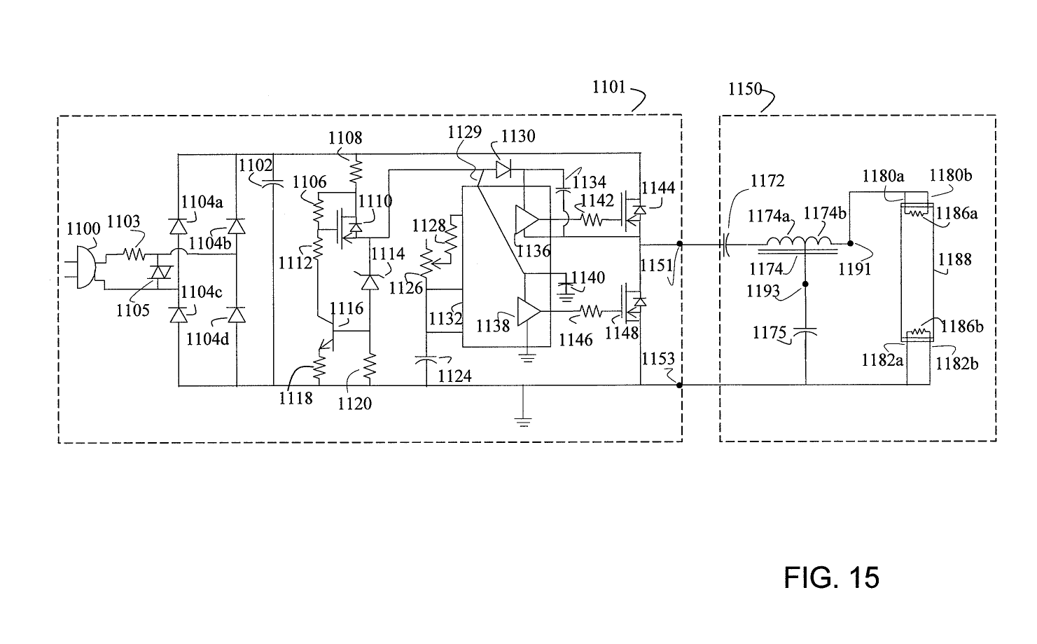

FIGS. 15-20 show ballasts useful, for example, for gas discharge lamps which do not have filaments (cold cathode configurations) such as CCFLs. These ballasts also operate at a high power factor, allow continuous and steady dimming of coupled light fixtures without blinking through a large range of maximum output, utilize less energy in close relation to the degree of dimming, and provide a relatively long lifetime of operation. Furthermore, use of cold cathode lamps provides rapid ionization, more efficient energy usage, manufacturing cost savings, and high durability. The cold cathode ballast described below uses fewer parts in the tank circuit than typical prior cold cathode ballasts, and allows effective dimming of a CCFL over a wide range with minimal flickering.

Methods and apparatus for dimming light sources are described herein that may be advantageously used with an automated system of the types just described. In the following examples, a dimmer circuit allows an automated control system to control the intensity of the light emitted by a light source with little or no flickering of the light. The dimmer circuit can be used with various light sources including gas discharge lamps (e.g., fluorescent lamps, high intensity discharge (HID) lamps, etc.), LED light sources, and incandescent lamps.

As used herein (and excluding any material incorporated by reference), “line” in this context refers to “power line” and thus the “line frequency” is the frequency in Hertz of the current or voltage provided by the external power source.

In a typical commercial or residential building, many light sources are typically required. As a result, a substantial amount of in-building electrical wire (also known as “inside wiring” or “in building wiring”) is required to electrically couple the light sources to their respective power source. Generally, the inside wiring itself has a small amount of parasitic inductance, which for some purposes can be estimated at 19 nH/inch. The sum of the inductances due to the in-building wire itself can cause a substantial amount of parasitic inductance to be present on the power wires coupled to the ballast circuits. While it can be generally assumed there is a certain amount of inductance present, the actual values present in a particular instance are usually not known, because the exact value is highly dependent on the particular building and other parameters which vary from installation to installation. Thus, parasitic inductance is usually present, but the degree to which it is present is not known. The presence of this inductance can cause undesirable effects with regard to operation of a conventional dimmer with a CFL or other gas discharge light sources.

Further, the conventional ballasts typically include a large electrolytic capacitor that stores energy for filtering the rectified output voltage. The combination of the capacitance in the light ballast and the parasitic inductance in the wire can produce an adverse effect on the operation of a conventional dimming circuit with respect to the ballast and light source resulting in a phenomenon known as “line current ringing.”

This causes a flicker that is perceivable to the human eye. As a result of the flicker, conventional dimmer circuits are not used with conventional ballast circuits using gas discharge type light sources as their operation is annoying to the user.

### Two Wire Dimmer

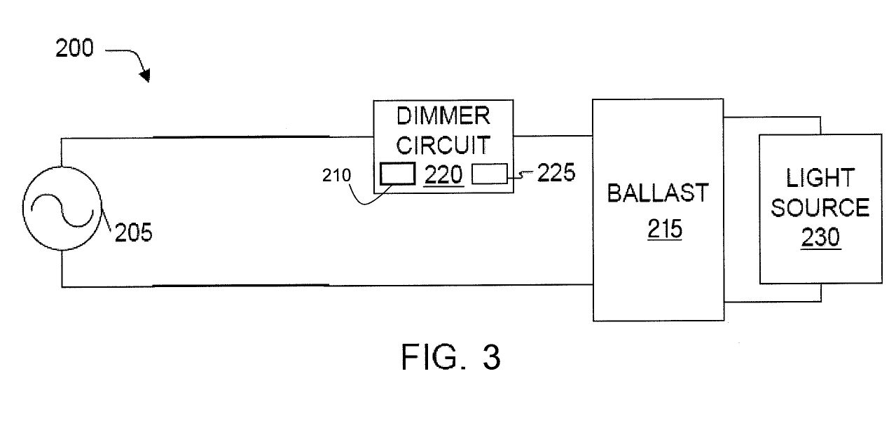

FIG. 3 illustrates one embodiment of a block diagram of a dimming unit 114 in the form of a dimmier circuit 200 in accordance with the present invention. The dimmer circuit 200 avoids the problem of perceivable flickering associated with prior art dimmers. In the illustrated embodiment of FIG. 2, a power source 205 (e.g., 120 VAC or 240 VAC, etc.), which typically provides voltage that alternates at a line frequency (e.g., 60 Hz in the U.S., 50 Hz in other countries, etc.), is coupled to a rectifier 210. Rectifier 210, which is coupled to a ballast 215 via a dimmer circuit 220, rectifies the line voltage of power source 205, thereby doubling the line frequency (e.g., to 120 Hz for the U.S., 100 Hz in other countries, etc.) conveyed to the dimmer circuit 220 and then the ballast 215. Dimmer circuit 220, which typically has a potentiometer configured by a user, adjustably limits the amount of energy provided to ballast 215. To prevent any perceived flickering, dimmer circuit 220 includes a charge circuit 225 to store energy therein (e.g., a voltage) to avoid the prematurely unlatching of a solid state switch. Ballast 215 also provides and limits current into a light source 230 to emit light there from. The ballast 215 may be, for example, the circuit described in U.S. patent application Ser. No. 12/205,564, filed Sep. 5, 2008, or the circuit described in U.S. patent application Ser. No. 12/277,014, filed on Nov. 24, 2008, the contents of both of which are herein incorporated by reference in their entirety.

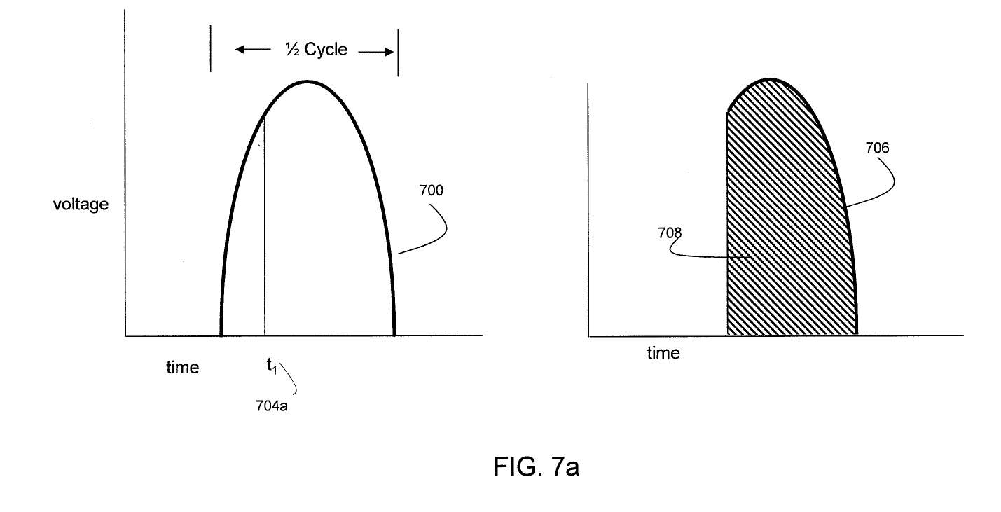

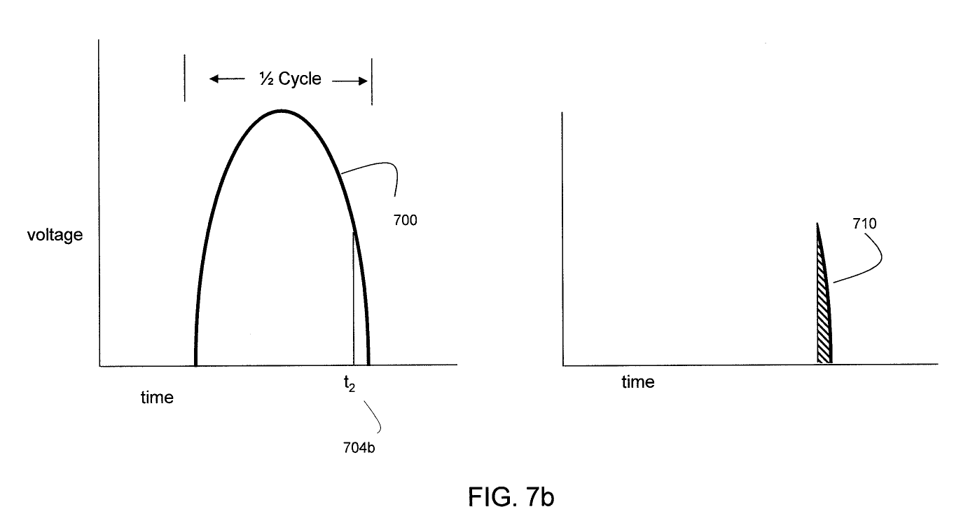

The dimmer circuit modifies the half wave voltage presented to the ballast from the power source as shown in FIG. 7a. In FIG. 7a, a voltage waveform 700 with a duration of a ½ cycle is shown based on the incoming power source (typically 60 Hz for a full cycle or 120 Hz for a half cycle). If the unmodified voltage wave is presented to the ballast, then there is no dimming. Typically during dimming, a leading portion of the voltage waveform is “sliced” based on a user-definable time, t₁ 704a. This is also known as “phase angle control.” This produces the resulting waveform 706, which is referred to herein as the “slice” of the waveform. In essence, by changing the point at which the incoming voltage is presented (called the “firing angle”), the size of the slice provided to the ballast, the amount of power (and light generated) is varied. Thus, dimming is accomplished by changing the time duration defining the size of the voltage slice (e.g., firing angle) presented to the ballast. The shaded portion 708, which is the area under the curve, represents the energy provided to the ballast. Hence, the smaller the voltage slice, the less energy is provided to the ballast, and the less light is produced from the light source.

In operation the dimmer circuit 220 generates light during a portion of each half-cycle of the line voltage (e.g., which is twice the frequency of a 60 Hz source, namely 120 Hz, etc.). The process repeats for each half cycle. At the beginning of a half cycle of voltage provided to the dimming circuit, the dimming circuit stores some of the incoming energy in a charging circuit. The charging circuit comprises various elements, but for this embodiment, the charge is stored in a capacitor which is coupled to the power source, and the stored charge in the capacitor increases as the incoming voltage increases.

As the voltage increases, there is a voltage at another point, a node, which also is increasing with respect to time, although at a different rate. The rate of increase at the node is determined by a RC circuit, not directly by the input voltage. Further, the rate of increase is settable by the user altering the “R” value of the R-C ladder circuit. This is accomplished a user-settable potentiometer. Thus, the time constant of the RC circuit determines the aforementioned t₁ of FIG. 7a, which is the point in time into the half cycle when the voltage waveform from the power source is sliced and presented to the ballast. If the voltage at this node reaches a certain threshold, (e.g. 30 volts), it will cause a diac to turn on. If the voltage does not reach the threshold, then the voltage at the node will continue to increase. During this same time, the voltage in the charge circuit is also increasing.

Once the diac is turned ON (also referred to herein as “activated”), the diac causes a solid state switch to turn ON, which provides the incoming voltage to the ballast. However, the possibility of a ringing current due to line inductance in the household wiring may cause the solid state switch, which can be embodied in a SCR, to turn OFF (also referred to as de-activated). In summary, the presence of additional voltage due to the parasitic inductance can cause the solid state switch to briefly encounter a decrease of current below its holding current, effectively shutting off the solid state switch. To prevent the solid state switch from prematurely shutting off, a voltage from a charge circuit is provided to the solid state switch to keep it in an ON condition.

However, the solid state switch must be kept ON for a short duration—only long enough to prevent the ringing current from inadvertently turning the solid state switch off. In any event, the solid state switch should not be kept ON by the charge circuit past the half cycle. Thus, the energy from the charge circuit is dissipated shortly after activating the solid state switch ON, which allows the solid state switch to turn OFF when the voltage across its terminals is near zero at the end of the half cycle. In other words, the charge circuit keeps the solid state switch ON for a short while after it is initially turned ON, to prevent it from prematurely turning OFF. In some embodiments, the switch is biased ON for a period of time in the range of approximately 100 to 2000 microseconds. The time period for which the switch is biased ON depends on the point (relative to the incoming voltage waveform) when the switch is initially triggered ON. Once the charge circuit is deactivated, the charge circuit does not by itself cause the solid state switch to turn OFF, but merely allows the solid state switch to turn OFF when conditions are appropriate.

When the voltage of the half cycle nears zero, and the current through the solid state switch is near zero, the solid state switch unlatches, and turns OFF, as is desired. Because the charge circuit is no longer preventing the switch from turning OFF, and the voltage across the solid state switch is zero, the solid state switch is able to turn OFF, unlatching the switch (i.e., opens) at the end of each half-cycle of line current. At the beginning of the next half cycle, the process repeats.

The operation of the charge circuit keeps the solid state switch in an ON condition regardless of the load current. Thus, in the event of an operating condition such as a ringing current, which would normally otherwise cause the SCR to experience substantially no current flowing from across its terminals and thereby turning it OFF, the gate of the SCR remains biased to keep the SCR latched ON. Further, the charge circuit is operable to allow the switch to shut OFF at the end of each half-cycle of the line voltage. Accordingly, a light source coupled to such a dimmer that implements the process described above would experience no perceivable flickering during its operation and would be presented with the waveform 706 of FIG. 7a.

FIG. 4 is a schematic diagram of an embodiment of a system 400 that includes a dimmer that implements the operation described above. In the illustrated embodiment of FIG. 4, a power source 402 is connected to a rectifier via its first terminal 404. Typically, the power source is a 120 VAC 60 Hz, but could be 240 VAC 50 Hz, or other values. Thus, in other embodiments which use, for example, 400 Hz AC power sources, the principles of the present invention can be adapted to function to dim lights as well. In particular, the power source 404 is connected to the anode of a diode 406 and the cathode of a diode 408. The cathode of diode 406 is connected to a first node 410 and the anode of diode 408 is connected to a second node 412. The cathode of a diode 414 is connected to node 410 and the anode of a diode 416 is coupled to node 412. The anode of diode 414 and the cathode of diode 416 are both connected to a ballast 418, which is further coupled to a light source 420 (e.g., a gas discharge lamp, a fluorescent lamp, a LED, CFL, etc.). Ballast 418 is also connected to a second terminal 422 of power source 402. In the illustrated embodiment, diodes 406, 408, 414, and 416 form a full wave bridge rectifier, such as the rectifier 210 of FIG. 2. Other embodiments can implement the full wave bridge rectifier using a single component, which packages the separate diodes into one device.

In the illustrated embodiment of FIG. 4, nodes 410 and 412 are further connected to a dimmer circuit 424, such as dimmer circuit 220 having charge circuit 225 in the embodiment of FIG. 2. In particular, node 410 is coupled to node 412 via a capacitor 426 and a primary winding 428. Node 412 is further coupled to a third node 430 via a secondary winding 432 and a diode 434. In the illustrated embodiment, the cathode of diode 434 is connected to node 430. Further, node 430 is coupled to node 412 via a capacitor 436, a zener diode 438, and a resistor 440, each of which is configured in parallel. Node 430 is coupled to the gate of a transistor 442 via a resistor 444.

In the illustrated embodiment, transistor 442 is implemented by an N-channel metal oxide semiconductor field effect transistor (MOSFET), but transistor 442 can be implemented by any suitable solid state device (e.g., a switch, a bipolar transistor, a P-Channel MOSFET, an insulated gate bipolar transistor, HEXFET, triac, sensitive gate SCR, etc.). The drain of transistor 442 is connected to node 410 and its respective source is connected to the gate of a silicon controlled rectifier (SCR) 446. In the embodiment of FIG. 4, node 410 is also coupled to node 412 via SCR 446. In other embodiments, a triac could be substituted for the SCR. Further, node 410 is coupled to a fourth node 448 via an adjustable resistor 450 (e.g., a potentiometer, etc.). The adjustable resistor 450 is configurable by the user and is typically a potentiometer. Node 448 is coupled to node 412 via a capacitor 452 and node 448 is further coupled to the gate of SCR 446 via a diac 454 (also, known as a four layer diode, STS, Shockely diode, sidac, etc). In other embodiments, the diac and SCR could be integrated into a common package called a quadtrac, logic triac, or alternistor triac.

The operation of the dimmer circuit 424 will be explained in conjunction with a half-cycle of the line frequency of the power source 402. In particular, the diodes 406, 408, 414, and 416 allow a line voltage to be present to the dimmer circuit 424 via node 410. Initially, the only current flowing from node 410 to 412 is due to current flowing through the adjustable resistor 450 and capacitor 452, and current through capacitor 426 in series with winding 428. However, although capacitor 426 stores energy at a voltage, it is of a small enough value that it does not effect the RC time constant of potentiometer 450 and capacitor 452. The adjustable resistor 450 and capacitor 452 increase the voltage at node 448 at a rate that is determined by the resistance value of the adjustable resistor 450, which is typically selected by a user. After a delay based in part on the value of adjustable resistor 450, the voltage at node 448 exceeds a threshold voltage associated with diac 454. As a result, diac 454 enters what is commonly referred to as a “breakdown” mode and allows current to flow through its respective terminals. In response, current flows into the gate of SCR 446, which causes SCR 446 to latch ON and couple node 410 to node 412 via a low impedance path. SCR 446 is latched ON, thereby causing its respective gate to lose control over its operation. SCR 446 remains latched ON until it experiences an operating condition causing it to unlatch, which is typically when the current flowing through its respective terminals is below its holding current. In this embodiment, the components comprising diac 454, adjustable resistor 450, and capacitor 452 comprise the “bias circuit” as these component initially bias the SCR into an ON condition. Other components can be used to construct a biasing circuit.

There is a nominal amount of current required to run the ballast. When the SCR turns ON, there is an excessive amount of current that rings in flowing from node 410 to 412. By “ringing” this means that there is a current peak above the nominal amount of current (thereby adding to the nominal current) or a net current less than the nominal current amount (thereby subtracting from the nominal current). When current level subtracts from the nominal amount, this can cause the current through the SCR to drop below the holding current level, causing it to turn off. The current added to the nominal amount is due to the parasitic inductance in the power line wiring, which is produced when the SCR turns on. Thus, a higher than normal current is provided to the ballast, which then reduces in level causing the current in the SCR drops to zero or near zero, resulting in the aforementioned ringing condition causing the SCR to turn OFF.

This undesirable condition is addressed in one embodiment by the charge circuit which comprises the component shown within the dotted line 499 in FIG. 4. The charge circuit ensures that the SCR does not inadvertently turn OFF during the current ringing condition. The operation of the charge circuit is now discussed.

When current begins to flow through SCR 446 (e.g., when SCR 446 is ON or activated), capacitor 426 discharges the energy stored therein as a current flowing through the primary winding 428, which induces a voltage in the secondary winding 432 that turns into a current causing the charging of capacitor 436. The transformer in this embodiment is a non-gapped, wound transformer, double E core, with a 4 to 1 turn ratio, and having a 10 micro-second hold up time at 50 volts. However, other configurations having similar functional properties can be used, as will be discussed below. In particular, primary and secondary windings 428 and 432 cause node 430 to have a voltage, but the voltage at node 430 is configured to not exceed the voltage at node 410 by means of zener diode 438. In this embodiment, the transformer can be viewed as a voltage transformer, where the voltage generated by the transformer is determined by the voltage associated with capacitor 426. As will be described in detail below, because node 410 is connected to power source 402, the voltage at node 430 is reduced because of the step-down of the transformer. This voltage at node 430 biases transistor 442 such that it supplies gate current to SCR 446 to prevent it from unlatching (i.e., turning OFF).

The amount of energy discharged by capacitor 426 depends on the amount of energy stored therein. Recall that the discharging of the capacitor is caused by the triggering of SCR 446, and thus the amount of energy stored in the capacitor is a function of when the SCR is triggered. Thus, the amount of energy stored (and discharged) depends on the relative time when the SCR 446 is triggered. For example, if the SCR is triggered shortly after the incoming line voltage increases above zero, (such as corresponding to time t₁ in FIG. 7a) there will be less energy stored in the capacitor compared to the point in time where the SCR is triggered later within the waveform (such as, 2×t₁ or twice the time period of t₁ which would be approximately at the peak of the voltage waveform). However, if the SCR is triggered later in the half cycle (e.g., on the “down-side” of the incoming voltage waveform), there is less energy stored in the capacitor compared to the middle of the waveform. This means that the charging circuit keeps the SCR latched ON for a shorter time period, which is appropriate to prevent the SCR from being latched after the end of the half cycle.

In the illustrated embodiment, the voltage from the secondary winding 432 causes a charge to be stored in capacitor 436, thereby causing node 430 to have a voltage present. Further, diode 434 prevents the charge in capacitor 436 from discharging back into the winding 432. However, if the voltage at node 430 exceeds a breakdown voltage associated with zener diode 438, zener diode 438 enters what is commonly referred to as the “avalanche breakdown mode” and allows current to flow from its cathode to its anode (i.e., into node 412). Once the voltage at node 430 does not exceed the breakdown voltage, the zener diode 438 recovers and prevents current from flowing into node 412. Stated differently, the zener diode 438 limits the voltage stored in the capacitor 436 so that its voltage does not exceed a predetermined threshold. While the zener diode could be omitted, it provides a safety mechanism to avoid damage to the FET 442.

Resistor 440 causes capacitor 436 to dissipate the energy stored therein at a predetermined time. Resistor 440 ensures that the energy in capacitor 436 will dissipate so capacitor 436 does not keep transistor 442 ON (and thereby keeping the SCR 446 ON) longer than desired. Resistor 444 is used as a current limiter if a bi-polar transistor is used and to prevent parasitic oscillation conditions if a MOSFET is used. The transistor 442 should only keep the SCR ON for a short duration so that the SCR is not turned OFF due to the ringing current, and certainly the SCR should not be kept ON past the duration of the half cycle. In particular, resistors 440 and 444 are configured to cause transistor 442 to have a gate-source voltage thereby turning ON and causing the gate of SCR 446 to have a gate-cathode current resulting from on the charge stored in capacitor 436. Stated differently, resistors 440 and 444 keep the gate of SCR 446 energized only for a period of time based on the amount of charge stored in capacitor 436. In the illustrated embodiment, zener diode 438, capacitor 436, and resistors 440 and 444 are configured to bias the gate of SCR 446 by way of transistor 442 for a period of time approximately in the range of 100 to 2000 microseconds. The duration of the biasing of SCR 446 by transistor 442 depends on the amount of energy stored in capacitor 436, which is charged from the energy stored in capacitor 426. Thus, the point in time relative to the input voltage waveform when the SCR is triggered impacts how long the SCR will be biased by the charge circuit. The biasing duration is also limited by the zener diode 438 and the resistor 440. Consequently, the charge circuit 499 biases SCR 446 for a short portion of each half-cycle of the line voltage and allows the SCR to unlatch itself at the end of each half-cycle. Although the biasing duration is variable, it is long enough (e.g., typically in the range of 100-2000 microseconds) to ensure that the SCR remains ON, but is not kept on past the end half cycle. The charge circuit provides a current through the gate to turn the SCR ON only when the SCR is OFF. That is, the charge circuit is configured to provide a biasing current to the SCR during the required time period when it is OFF, but no current is required if the SCR is latched ON. It is only when a ringing current condition exists that the SCR may become unlatched, and that is typically when the charging current provides current to turn the SCR back ON.

As described above, if driving a capacitive load such as an electronic ballast, the parasitic impedance in the wiring of a building may cause SCR 446 to experience a ringing current, which may cause the current flowing through the SCR 446 to be less than its holding current. In other words, SCR 446 may experience the operating condition that may cause it to unlatch prematurely. If so, then at the same time, current will begin to flow through adjustable resistor 450 and the capacitor 452, which will cause the diac 454 to retrigger. Thus, this will result in a flickering condition of the light source. However, as described above, capacitor 436 stores a charge in response to SCR 446 being turned ON, which causes the transistor 442 to have a gate-source voltage. As a result of the gate-source voltage of transistor 442, SCR 446 has a gate current due to the load current that was through the SCR and remains latched ON for substantially the same duration that transistor 442 is turned ON. That is, when SCR 446 is turned ON, it receives a current to prevent it from becoming unlatched as a result of the ringing current. As a result, the light source 420 does not flicker during the operation of each half-cycle of the line current.

FIG. 4 does not illustrate any sort of noise filter, and it is possible to place a noise filter on the output of the rectifier between diodes and the SCR, to prevent noise from being introduced back into the power source 402. This filters lowers noise by lowering the di/dt caused by ringing current.

FIG. 4 is unusual relative to the prior art in that it connects an SCR across the output terminals of a full wave bridge rectifier. This configuration is sometimes referred to a “shorted bridge” configuration. In most cases, a triac, or two SCRs connected back-to-back (“an anti-parallel configuration”) are used in lieu of a shorted bridge. However, the use of a single SCR is unconventional, because it was commonly thought using an SCR in a shorted bridge configuration would result in the SCR latching permanently in the ON condition, and therefore negate its usefulness in dimmer applications. Thus, generally, SCRs are not used in phase control dimmer circuits in shorted bridge configurations. Further, the holding current of an SCR is much lower than a triac (five to ten times less), which is an important parameter in dimming low level loads, such as when dimming LEDs and CFL lighting sources, which have lower current loads than incandescent lighting loads.

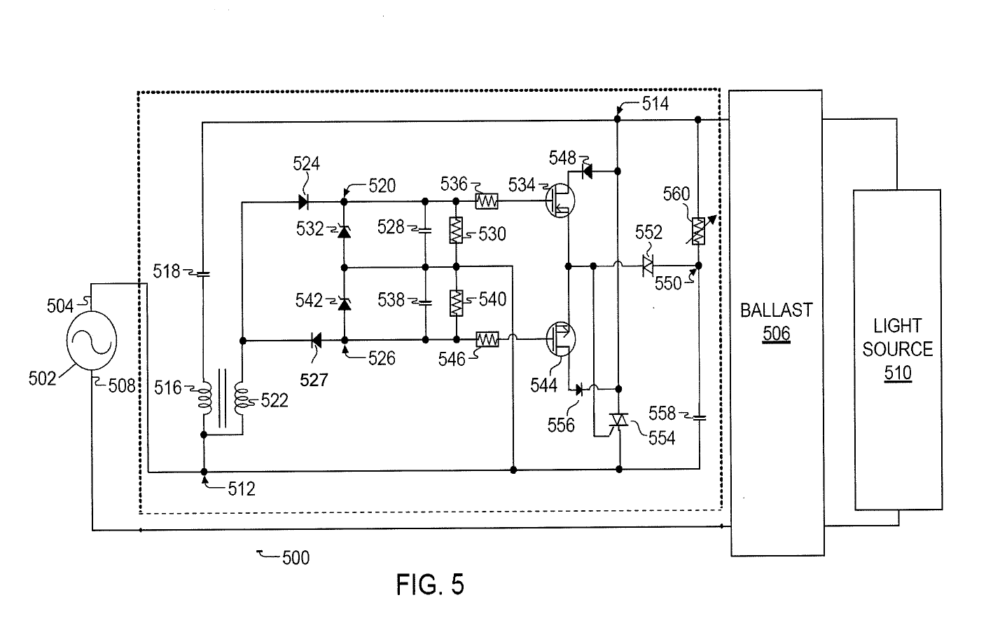

FIG. 5 illustrates another embodiment of a circuit 500 that may implement process 300. In this embodiment, there is no full wave rectifier bridge connected to the power source. Rather, each positive and negative half of the voltage cycle is processed by similar, but separate circuits.

In the embodiment of FIG. 5, a power source 502 is coupled to exemplary circuit 500 via its respective first terminal 504. In particular, the power source 502 is coupled to a ballast 506 via exemplary circuit 500. Further, exemplary circuit 500 is also connected to a second terminal 508 of power source 502. Ballast 506 is connected to a light source 510 to emit light there from. Because the power source is not rectified, the voltage is a full sinusoidal wave at node 512 at the line frequency.

The first terminal 504 of power source 502 is connected to a first node 512, which is further coupled to a second node 514 via a primary winding 516 and a capacitor 518. Node 512 is further coupled to a second node 520 via a secondary winding 522 and a diode 524. In particular, the cathode of diode 524 is connected to node 520 and its respective anode is connected to secondary winding 522. In addition, node 512 is coupled to node 526 via secondary winding 522 and a diode 527, which has its respective anode connected to node 526 and its cathode connected to secondary winding 522.

Node 520 is also coupled to node 512 via capacitor 528 and resistor 530, which are configured in parallel. Further, node 520 is also connected to the cathode of a zener diode 532, which is coupled to node 512 via its respective anode. Further still, node 520 is also coupled to the gate of a transistor 534 via a resistor 536. In the embodiment of FIG. 5, node 526 is coupled to node 512 via a capacitor 538 and a resistor 540, which are configured in parallel. In addition, node 526 is connected to the anode of a zener diode 542, which is coupled to node 512 via its respective cathode. Node 526 is also coupled to the gate of a transistor 544 via a resistor 546. In the illustrated embodiment of FIG. 5, transistor 534 is implemented by an N-Channel MOSFET and transistor 544 is implemented by a P-Channel MOSFET. Of course, transistors 534 and 544 can be implemented by any suitable device (e.g., bipolar transistors, HEXFET, etc.).

The drain of transistor 534 is coupled to node 514 via a diode 548. In particular, the anode of diode 548 is connected to node 514 and its respective cathode is connected to the drain of transistor 534. The source of transistor 534 is connected to the source of transistor 544, both of which have their respective sources that are further coupled to a node 550 via a diac 552. In addition, the sources of transistors 534 and 544 are connected to the gate of a triac 554. The drain of transistor 544 is coupled to node 514 via a diode 556. In particular, the cathode of diode 556 is connected to node 514 and its respective anode is connected to the drain of transistor 544.

In the illustrated embodiment of FIG. 5, node 512 is coupled to node 514 via the main terminals of triac 554. Node 512 is also coupled to node 550 via a capacitor 558 and node 550 is further coupled to node 514 via an adjustable resistor 560 (e.g., a potentiometer, etc.). In particular, resistor 560 is adjustable by a user and is operable to selectively allow energy to be provided through exemplary circuit 500 to cause light source 510 to emit light there from. In the illustrated embodiment, node 514 is further connected to ballast 506.

In the illustrated embodiment of FIG. 5, exemplary circuit 500 operates in a manner similar to the description of FIG. 4. In particular, the adjustable resistor 560 and capacitor 558 form a RC circuit having a time constant and is adjustable based on the resistance of the resistor 560. Initially, the capacitor 518 stores an amount of charge when the SCR 554 is turned OFF. When the voltage at node 550 exceeds a threshold voltage associated with the diac 552 (e.g., ±30 volts, etc.), current flows into the gate of SCR 554 to latch it ON, thereby forming a low impedance path from node 512 to node 514. In response, the capacitor 518 releases the energy stored as a current, which induces a current in the secondary winding 522.

If the current generated by the secondary winding 522 is negative, a current flows into node 526 and capacitor 538 stores the current as a voltage. However, zener diode 542 limits the voltage across capacitor 538. As a result of the voltage, the resistors 540 and 546 cause a predicated amount of current to flow into node 512. The resistors 540 and 546 are configured to limit the amount of current. As a result, a voltage is generated and causes transistor 544 to have a gate-source voltage, thereby turning ON transistor 544. However, because the resistors 540 and 546 limit the current, transistor 544 is turned ON for a period of time after SCR 554 latches ON. In some embodiments, the transistor 544 is operable for a range of approximately 100 to 1000 microseconds. As a result of turning ON transistor 544, triac 554 continues to have a gate current, thereby ensuring the triac 554 is latched for a period of time after turning ON.

On the other hand, if the current generated from secondary winding 522 is positive, a current flows into node 520 via diode 524. The current is stored as a charge in the capacitor 528 as a voltage; however, zener diode 532 limits the voltage stored therein. As a result of the voltage, the resistors 530 and 536 cause a predicable amount of current to flow into node 512. The resistors 530 and 536 are configured to limit the amount of current. In response to the current, a voltage is generated and causes transistor 534 to have a gate-source voltage, thereby turning it ON. However, because resistors 530 and 536 limit the current, transistor 534 is turned ON for a period of time once triac 554 is latched ON (e.g., typically between 100 microseconds-1000 microseconds). As a result of turning ON transistor 534, triac 554 continues to have a gate current thereby ensuring the triac 554 is latched for a period of time after turning ON.

In the embodiment of FIG. 5, exemplary circuit 500 is operable to allow current to flow in both directions across triac 554, which remains latched during both the positive half-cycle of the line current and the negative half-cycle of the line current. As a result, exemplary circuit 500 does not require a rectifier. On the other hand, in the embodiment of FIG. 4, the dimmer circuit 424 requires fewer components by implementing a rectifier and allowing current to flow in only one direction across the SCR 446.

FIG. 5 does not illustrate any sort of noise filter. It may be possible to add a small value inductor to the AC line, but doing so contributes to the current ringing problem. Any such inductance would be of a value, such that any ringing would be dissipated before the RC time constant expires of capacitor 528 and resistor 530 (or 538 and 540). Alternatively, the presence of a small resistor in the ballast circuit may function to reduce noise from ringing. The circuit of FIG. 5 can be easily adapted to 240 volt operation.

In the described embodiments, a dimmer circuit is provided that is able to dim light sources operating with a ballast having a capacitive load without noticeable flicker. Further, the dimmer circuit is capable of operating with any type of light source (e.g., incandescent bulbs, gas discharge lamps, LEDs, etc.) over the wide range of light output (e.g., from 20% to 100%) and for a variety of power loads. The dimmer circuit can be easily implemented into existing manufacturing processes without substantial additional costs. In addition, the dimmer circuit is capable of handling lower current, approximately in the range of 10 to 20 milliamps, thereby allowing the ballast to function with a single dimmable CFL. As a result, the described embodiments above are capable of handling low power light sources such CFLs.

FIG. 6a is an illustration of another embodiment of the invention as used for dimming a conventional CFL, typically in the 10-40 watt range. The diagram illustrated in FIG. 6a is similar in various respects to the diagram of FIG. 4. However, in FIG. 6a, a conventional CFL 602 (typically in the range of 10-40 watts) is dimmed using the circuit 601a. Because the conventional CFL incorporates an integrated ballast and light source, there is no separate ballast identified in FIG. 6a. Although a single CFL is illustrated, the dimmer circuit as illustrated can dim multiple CFL (or other loads) up to 300 watts. By reducing the value of the inductor 627, and replacing other components with appropriate higher ratings, one skilled in the art can adapt the embodiment of FIG. 6a to dim higher wattage loads. This embodiment would also function with linear fluorescent bulbs operating with a separate ballast.

In FIG. 6a, the theory of operation is similar to that as described for FIG. 4. A full wave bridge rectifier 604 receives household power at 120 VAC and at 60 Hz. The full wave bridge rectifier is depicted here as an integrated unit, although it could be made from individual diodes, as shown in FIG. 4. The frequency output of the rectifier is determined by the input line frequency (at 60 Hz, the half cycles would be at 120 Hz). The output voltage appears on node 603. Whether any current flows from node 603 to node 605 is determined by the latching status of SCR 620, which in one embodiment is rated at 8 amps, 400 v, with a holding current of 30 ma. Further, the point at which the SCR conducts is determined by resistor 624, which is a 100 K potentiometer settable by the user, and capacitor 626, which is 0.2 to 0.3 μf capacitor. This RC combination causes the voltage at node 625 to increase at a give rate, which at a certain threshold (30 volts in one embodiment), causes the DIAC 622 to breakdown, thereby causing the SCR 620 to latch, thus allowing current to flow through the SCR terminals. The DIAC in this embodiment is a four layer diode, with a trigger voltage of approximately 30 volts. The current from diac flows into the gate of the SCR, which causes the SCR to latch “ON.” Thus, current flows from node 603 to node 605.

As the current flows across the SCR, capacitor 606, which is a 0.1 μf capacitor, causes the charge to be transferred at a voltage into the transformer 608 and then into capacitor 612. This transformer in this embodiment can be viewed as functioning as a voltage transformer. The transformer can be made using a Ferrite Core No. 9478016002, using #27 wire, where the primary has 80 turns, and the secondary has 20 turns. The presence of current on the primary winding induces a current on the secondary windings, causing a voltage to appear at the cathode of diode 610 and the energy is stored in capacitor 612. Diode 610 is a conventional 1NF4004 diode and prevents any current from flowing back into the transformer.

The zener diode 614 is rated at 12 volts and 0.5 watt, and prevents the voltage at the cathode of diode 610 from exceeding 12 volts due to the release of energy from capacitor 612 through resistor 616. Resistor 616 has a 1K value and resistor 616, which is a value of 10K. The presence of the voltage at the resistors causes the transistor 618 to have a gate-source voltage, which turns the transistor 618 ON. The transistor in this embodiment is a FET IRFU420 from International Rectifier™. This transistor causes the SCR's gate to be energized, and keeps the SCR from turning off.

As noted previously, the DIAC turns “ON” the SCR at a delayed point relative to the start of each half cycle. The time at which this occurs is determined by the RC value of capacitor 626 and resistor 624. Since resistor 624 is a user-settable potentiometer, the time value varies based on the user's setting. The varying delay at which the DIAC turns the SCR ON determines the energy delivered to the CFL, and therefore determines the light produced.

FIG. 6a also includes a line filter 627, which may be present in a commercial embodiment of the invention. The line filter, embodied as an inductor, lowers the di/dt of the current thereby reducing the high frequency electrical noise being introduced back into the power lines. Because of the potential proliferation of dimmers, such noise limiting inductors (or other equivalent circuitry) are used to avoid introducing noise on the power line infrastructure, whether it be in the building where the dimmer is being used, or otherwise. Because the noise filter reduces the change in current (e.g., di/dt), it by itself can be used in some embodiment (as discussed below) to facilitate the current ringing problems.

FIG. 6b is another embodiment, which is similar in concept to FIG. 6a, which again is similar to FIG. 4. This embodiment also is designed to be used with a CFL having an integrated ballast, although it can be used with other types of light sources. This embodiment uses a different structure for providing energy to the charge circuit. Unlike FIG. 6a, which used a capacitor 606 in series with transformer 608 to provide current through the diode 610, the embodiment in FIG. 6b uses a inductor having a primary winding 651a and a secondary winding 651b. The primary winding 651a functions as an noise filter just as inductor 627 does in FIG. 6a. However, the secondary winding which is coupled to the primary winding (similar to a transformer) functions similar to the transformer 608 in FIG. 6a. Thus, when SCR 620 is turned ON by the diac, current flows through the primary winding of inductor 651a inducing a voltage in the other winding 651b, which in turn causes the energy to charge capacitor 612 via diode 610 and resistor 611. In this embodiment, the transformer can be viewed as a current transformer which pushes a charge into capacitor 612 and also acts as a filter. The remainder of the circuit's operation is similar to that as described previously.

FIG. 6c is another embodiment, which is similar in concept to FIG. 6a, which again is similar to FIG. 4. This embodiment also is designed to be used with a CFL having an integrated ballast, but again can be used with other types of light sources. In FIG. 6c, the embodiment is designed for operation with a 240 volt AC, 50 Hz, power source as depicted by the plug 650. Hence, such a design would be appropriate for certain European and Asian countries which operate at this voltage and frequency. Other power sources may be used, such those that operate at 208 v AC 60 Hz, or other variations, which are typically greater than 200 volts AC. Many of the component values are similar or the same and one skilled in the art would readily recognize that the certain components would have to be adapted for the higher voltage. For example, the full wave bridge rectifier 652 would have a higher rating, such as 600 v, compared to applications defined for 120 VAC. In addition, the transistor 654 must accommodate the higher voltage. In this embodiment, a triac 656 is used instead of an SCR, and the triac 656 would have to be rated to accommodate a higher operating voltage, such as 600 v. The potentiometer 658 would require twice the resistance, namely up to 200K. Finally, the transformer 660 would require 10 turns on the secondary winding. The operation of this circuit is similar to that described for FIG. 6a. A bridge rectifier 652 is used to trigger the triac bidirectionally from a unidirectional signal from the FET 654. The above circuit could be adapted for 120V AC operation by changing the transformer turns ration to 4:1 instead of 8:1, and using a 100K potentiometer. If the full wave bridge 660 comprises standard recovery diodes, then diode 662 may be added, which is a ‘fast’ diode.

FIG. 6d is another embodiment, which includes a subset of the components shown in embodiments illustrated in FIG. 6a and FIG. 6b. This embodiment uses a SCR 620 as before, which is activated by current provided by DIAC 622. In turn, DIAC 622 is activated when the voltage at node 625 reaches a threshold voltage.

As noted previously, the SCR 620 can be de-activated, or turned OFF, by the presence of a ringing current due to inductance in the power lines, which the full wave bridge processes into a ringing current present on node 603 when SCR 620 is turned ON. In the alternative embodiment shown in FIG. 6d, the value of the inductor 691 is selected so as to not only perform the function of filtering noise preventing from being introduced back into the power line network, but it also prevents the presence of the ringing current on node 603. This is accomplished because inductor 691 stretches the current pulse, which prevent the SCR from un-latching. The inductor in one embodiment has a value of approximately 200 micro Henries (μH). This value is sufficient to prevent a ringing current for about 200 microseconds after the SCR 620 has been turned on. The value of the inductor is such that successful operation is possible for loads greater than 20 watts. Thus, the load shown in FIG. 6d is illustrated as a CFL light 692, in a range of 20-50 watts, although a single CFL is typically 42 watts or less. The present embodiment will also dim incandescent lighting loads as well. However, the potential of current ringing causing flickering in fluorescent lights is obviously inapplicable if only incandescent light sources are used.

The inductor in this embodiment preferably comprises #21 wire turned around a powered iron core, such as an E75-26 core available from Micrometals™. For applications supporting a low power load (e.g., less than 20 watts), the SCR could become unlatched, and cause flickering. This can be avoided by using a SCR with a lower holding current, such as those readily available having a 6-8 ma holding current.

As shown in FIG. 7a, the voltage for a initial half-cycle is shown as line 700. Although this diagram is discussed in the context of the circuit of FIG. 6a, which incorporates a rectifier, the first half cycle of FIG. 7a is the same regardless of whether or not a rectifier is incorporated in the embodiment. Specifically, if a rectifier is incorporated, then the next half cycle of the voltage waveform is rectified (e.g., a positive value) and looks similar to line 700. If a rectifier is not incorporated, then the next half cycle is not rectified, and is negative (not shown). The ½ cycle is 100 Hz if the power source is operating at 50 Hz, or 120 Hz if the power source is operating at 60 Hz, depending on what power characteristics are provided.

The RC value (based on the adjustable potentiometer) discussed previously defines the time value or delay (i.e., firing angle) at which the diac reaches the threshold voltage, and thus turns on the SCR. In FIG. 7a, the time value t₁ 704a is shown relative to the half cycle. If the value t₁ is reached early on in the half cycle, the SCR is turned ON for the remainder of the half cycle, producing a block of energy denoted separately as the area 708 under the curve 706. The area under the curve 708 corresponds to the energy provided to the ballast, and hence determines the light produced by the light source. On the other hand, if the user adjusts the potentiometer to have a longer time value, the result is that the SCR is turned on at a later time. In FIG. 7b, this is shown as occurring at t₂ 704b, which results in a smaller amount of energy provided to the ballast, depicted separately as area 710. The greater the energy provided to the CFL (or ballast and lamp source), the greater the luminance generated by the lamp. Thus, the energy associated with area 710 in FIG. 7b results in less light relative to FIG. 7a, which is consistent with a ‘dimmed’ condition of the light source. Subsequently voltage waveforms would be similar in shape as discussed above, but may be negative if no rectifier is present.

The above dimmer can be manufactured to be contained in a conventional dimmer switch housing with a shape and size allowing it to be installed in a conventional single gang work box (i.e., the box used in construction to contain electrical switches). This allows the dimmer switch to be retrofitted into existing residential or commercial applications, as well as for new construction. The embodiments of the dimmer disclosed herein can accommodate lighting load applications of 5-300 watts, and different component values may be scaled for higher (e.g., 300+) wattage applications. Such values for higher wattage applications can be readily determined by one skilled in the art. Such applications include dimming single fixture lighting sources, or a plurality of lighting sources controlled by a single dimmer. Further, the aforementioned dimmer can function with a variety of lighting technologies and provide flicker-free dimming over a wide range of luminescent output of the lamp. Further, multiple light sources can be dimmed using a single dimmer.

The dimmer described herein has an additional advantage of effecting a linear or approximately linear dimming response as the dimmer switch is operated, and can dim certain dimmable CFLs down to as low as 20% of maximum luminous intensity. Further, the dimmer can effectively dim lighting loads having a lower power load compared to prior art dimmers, which often do not function well with low wattage CFL bulbs. The present dimmer is particularly well suited for dimmable low wattage LED based lights. These features are improvements over many commercially marketed dimmer circuits for CFL bulbs. Further, the dimmer contains no programmed microprocessor. The advantages of this dimmer potentially lead to wider use of energy-saving CFL bulbs, and further save energy by allowing more CFL bulbs to be operated at reduced energy consumption.

In the above embodiment, a potentiometer in the disclosed circuit that determines the light output is operated by a user. The user varies the potentiometer setting to obtain the light output as desired. In other embodiments, the dimmer may be incorporated into a system where the value of the resistance is controlled automatically by an additional controller circuit, for example, on a set schedule in response to a programmable timer operating a digitally controlled potentiometer, or in response to sensors, as described elsewhere herein.

The resistance value itself, or the RC time constant formed by the combination of the resistance and capacitance values, may be adjusted based on various conditions. For example, the dimmer circuit can be provided with a occupancy detector and a clock or timer, and embodied in a night-time security lighting system. In lieu of a clock, the system may include a photodetector. Such devices commonly control outdoor lighting, and upon detecting occupancy, turn on a security light. Such a device may incorporate multiple light output levels. For example, at night (as determined either by a clock or by a photodetector) and when occupancy is not detected, the lights can be dimmed to a certain level (e.g., 50%) to provide a low level security light. When the occupancy detector detects occupancy, the light is then turned on to full power, often for a limited time period after which no further occupancy is detected. After the limited time period expires, the light returns to the lower level. At dawn, the light is then completely turned off by a signal from the clock or the photodetector. In such embodiments, a control circuit would determine when the diac turns on to cause the partial light level in the absence of occupancy, and change the time when the diac turns the SCR on (or the time delay caused by the RC time constant) based on when occupancy is detected such that full light is produced. Such circuits are well known to those skilled in the art, and can be found, for example, in U.S. Pat. No. 7,164,238, the contents of which is incorporated by reference.

In other embodiments, the time delay and dimming level may be varied by other means. Continuing with the security example, a photocell could measure ambient darkness for controlling the security light, as described in more detail elsewhere herein. Such a circuit would cause the security light to be activated, initially at a very low light output level. As darkness increases, as detected by the photocell, a commensurate change in the time delay would occur so as to cause the light to gradually increase its output. This would avoid turning on the lamp at full power, when full power may not be initially required based on ambient conditions. In other embodiments, a microprocessor such as the controller 112 can be programmed to cause the light power to gradually increase over a set time period by changing the time delay according to its program.

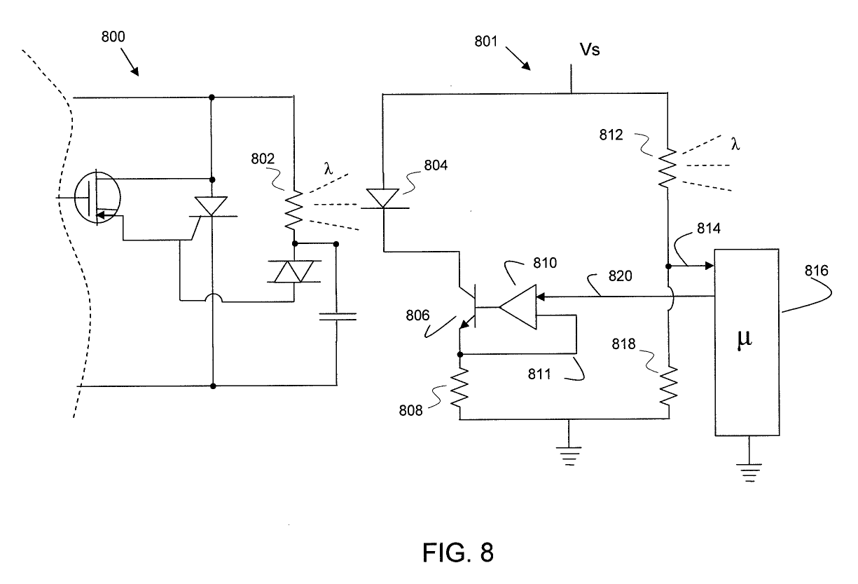

Another embodiment of a daylight harvesting system is shown in FIG. 8. In FIG. 8, there are two main portions of the system. The first portion 800 is based on the previous embodiments of dimming units (see, e.g., FIG. 6a) and only discloses a portion of the previous embodiment. In this case, the adjustable resistor 624 of FIG. 6a has been replaced with a photo-sensitive resistor 802. This device alters its resistance based on the amount of light detected by it. The second portion 801 of the system detects the ambient light and controls the resistance of the photo-sensitive resistor 802, such as cadmium-sulfide cells well known to those skilled in the art. The control of the photo-resistor is accomplished by using a LED 804. Thus, based on the amount of light generated by the LED, the resistance of the photo-resistor 802 is changed, and impacts the RC constant and dimming level as discussed earlier. One advantage of this embodiment is that the photo-resistor 802/LED 804 combination functions as an opto-isolator between the first portion 800 and the second portion 801. Further, such opto-isolators are readily available as an integrated unit.

The second portion detects the ambient light conditions via a photo-resistor 812, which is placed to detect the desired ambient light conditions as appropriate. The photo-resistor 812 and a second resistor 818 form a voltage ladder, such that an input 814 measurement voltage changes according to the light conditions. The input is provided to a microprocessor or microcontroller 816 which is able to convert the analog voltage reading to a digital value and process it according to its program. The controller 816 is programmed to effect the desired operation.

The controller 816, based on the input voltage reading 814 then adjusts an analog output 820. The output is provided to an operational amplifier 810 which drives a transistor 806. When the transistor 806 is turned ON, current flows from the LED 804 through the transistor 806 and is limited by resistor 808. Thus, based on the level of the current passing through the LED, the light level and therefore the resistance of the photo-resistor 802 can be changed by the controller 816. In this manner, the controller can be programmed to dim a light (or series of lights) controlled by the dimmer, based on detected ambient light conditions. Similarly, the controller could receive other inputs (such as occupancy detection, time of day, etc.) and use these inputs to alter the resistance of photo-resistor 802. Those skilled in the art will recognize that the microprocessor could utilize external A/D and/or D/A circuits. Similarly, those skilled in the art will readily recognize that the digital microcontroller 816 can be replaced with analog circuitry to control the brightness of LED 804.

It should be understood that the controller 816, the detection portion 801, and the dimming portion 800 can be coupled by various wireless or wired means as discussed above.

The purpose of daylight harvesting is to save energy when ambient natural light conditions allow reduction of artificial light. The present dimmer effectively accomplishes this when operated with a light source using the ballast described in U.S. patent application Ser. No. 12/277,014, filed on Nov. 24, 2008. The use of such a ballast with the dimmer described herein allows a generally commensurate reduction in energy consumption when dimming. Thus, the combination realizes the benefits of daylight harvesting while maintaining a high efficiency and high power factor, without any flickering of light, even when dimmed to a very low level. Thus, this allows artificial lights to be dimmed when there is sufficient ambient light and increased gradually as ambient light decreases. This combination allows energy savings to be realized.

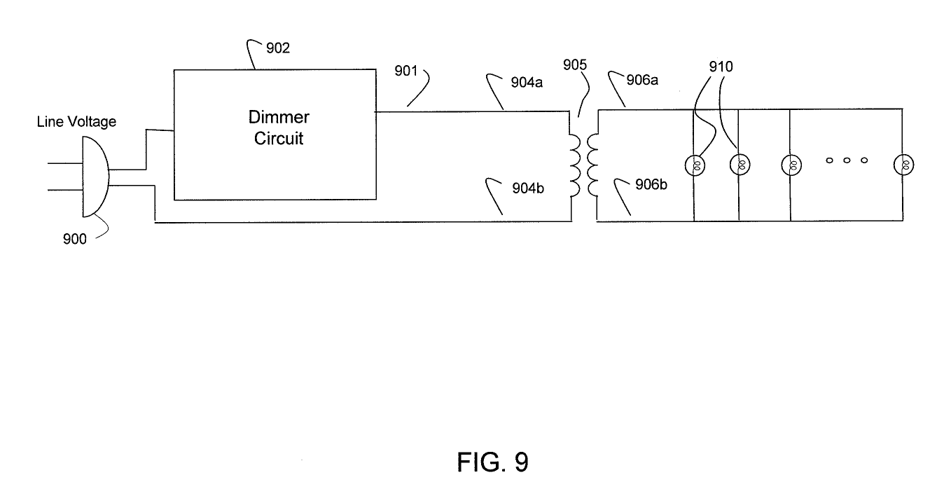

FIG. 9 illustrates another embodiment of the present invention wherein the dimmer is used for dimming low voltage lighting, such as landscaping (outdoor) lighting or ornamental lighting (e.g., signage or holiday lights). In FIG. 9, a dimmer circuit 902, which may be any of the previously identified embodiment of the dimmer circuits, is used to connect to line voltage via a plug 900. The output 901 of the dimmer circuit 902 is connected a transformer 905 by connecting to the input terminal 904a on the primary winding. The transformer typically is a step-down transformer, and converts the input voltage, which can be as high as the line voltage (when not dimmed) to a lower voltage, such as 12 volts. A series of light sources 910 (such as LEDs or other types) are connected in parallel to the secondary winding of the transformer. Such applications may be used for low-voltage lighting applications. When the dimmer circuit 902 is activated, the voltage output to the transformer 905 will have less energy delivered relative to the line voltage into the dimmer circuit, and the light output of the light sources 910 will be dimmed. The dimmer circuit can also be combined with the ambient light detection circuit of FIG. 8 to automatically dim the lights, or with other circuitry for accomplishing the same function.

### High Power Factor Ballast

FIG. 10a illustrates a block diagram of one embodiment of a ballast circuit 2200 suitable for use with the present invention. The ballast circuit 2200 is configured to have a high power factor, generally approaching a power factor of unity (e.g., 0.90-0.99, etc.). In particular, the example ballast circuit 2200 includes a power factor correction capability that is performed in a single stage of impedance transformation, thereby eliminating the need for a separate high power factor correction circuit while retaining substantially the same functionality. Thus, fewer components are required relative to the prior art.

In the example of FIG. 10a, the ballast 2200 includes a power source 2205 that is connected to a rectifier 2210. The power source 2205 is typically an alternating voltage source that provides commercially available voltage (e.g., 120 or 240 VAC) having a magnitude alternating at a line frequency (e.g., 60 Hertz (Hz)). A line filter (not shown) is also typically incorporated to prevent noise from being introduced back into the power network. Rectifier 2210 is typically a full wave rectifier that inverts the negative magnitude of the voltage provided via the power source, thereby doubling the frequency of the line voltage (e.g., to 120 Hz). Rectifier 2210 conveys the rectified voltage onto a first node 2212 and a second node 2214. The output of the rectifier 2210 provided to nodes 2212 and 2214, is similar in waveform to that shown in FIG. 1c. The rectifier provides an unfiltered, rectified voltage. This voltage is DC, and has the shape of a rectified AC voltage waveform.

The first node 2212 and the second node 214 are connected via a high frequency capacitor, such as a polypropylene capacitor 2215, also referred to as a bypass capacitor herein. In the example of FIG. 10a, the capacitance value of the capacitor 2215 is selected to have a value such that it presents a large impedance to the rectified voltage (i.e., at the line frequency), thereby not substantially affecting the rectified voltage at the line provided via rectifier 2210 during operation of the ballast. This would provide a high impedance at the switching frequency, typically in the range of several thousand ohms. This is in distinction to the prior art that uses a high voltage, low frequency capacitor across the output of the rectifier, such as a large value electrolytic capacitor, to filter out the 120 Hz ripple due to the line frequency, which removes the “valleys” in the rectifier output. The capacitance value of capacitor 215 in the example of FIG. 10a is selected to store energy which is released at a high frequency, generally in the kilohertz (20-80 kHz) range. As such, capacitor 2215 in the example of FIG. 10a has value of approximately 0.1 to 3 microfarads (μF) and is made of any suitable material (e.g., polypropylene, etc.) for a ballast having a power output as required, which in this embodiment is approximately 25 watts. In other embodiments, capacitor 2215 may have a value of approximately 1 to 30 μF for a ballast having a power output of approximately 120 to 250 watts. Stated in more general terms, capacitor 2215 generally has a capacitance value in the range of 4 to 120 nanofarads (nF) per watt of power of the output lamp, and typically around 50 nF/watt when 120 VAC is used. If 240 VAC is used, then capacitance value is half the above. The capacitor 2215 is typically a polypropylene capacitor that has a lifespan much greater than larger electrolytic capacitors that typically are used in conventional ballasts.

Ballast circuit 200 also includes a regulator 2220, (generically referred in the industry as a housekeeping supply circuit) connected to nodes 2212 and 2214. Regulator 2220 generates a substantially constant voltage that exceeds a first threshold (e.g., 10 volts, etc.) to provide power to a driver 2225. Because the voltage at nodes 2212 and 2214 is not filtered, a regulator is required to provide a steady input voltage to the driver 2225. The voltage waveform from the rectifier has at each half cycle a “valley” wherein the voltage drops to zero or near-zero, albeit for a short time. In the illustrated example, the driver 2225 is configured to alternately actuate one of a first transistor 2235 and a second transistor 2240 at a high frequency, referred to herein as the switching frequency, typically at a frequency of 20 kHz or more. The example transistors 2235 and 2240 are both implemented using vertical N-Channel metal oxide semiconductor (NMOS) field effect transistors, although one of ordinary skill in the art would know that the transistors 2235 and 2240 can be implemented by any other suitable solid state switching device (e.g., a P-channel metal oxide field effect transistor, an insulated gate bipolar transistor (IGBT), a lateral N-channel mode MOS transistor, a bipolar transistors, a thyristor, gate turn off (GTO) device, etc.).

Driver 2225 and transistors 2235 and 2240 form a half-bridge topology that is implemented to cause a resonant circuit or “tank circuit” 2245 to power a light source 2250 in the illustrated example. To form the half-bridge topology, the drain of the first transistor 2235 is connected to the first node 2212 and the source of the second transistor 2240 is connected to the second node 2214. Thus, the voltage present on the node 2212 and the drain of the first transistor 2235 is the rectified voltage waveform 2260 shown in FIG. 2b. The gates of the transistors 2235 and 2240 are both connected to first and second outputs of the driver 2225, respectively, and the source of the transistor 2235 is connected to the drain of the transistor 2240, both of which are also connected to the resonant circuit 2245. Because the transistor 2235 switches the voltage from node 2212 at a high frequency square wave 2265 in FIG. 10b, the resulting voltage at input 2252 is the high frequency square wave modulated by the line frequency as shown in FIG. 10c. Both FIGS. 10b and 10c illustrate the aforementioned “valleys” 2260 having a period of twice the line frequency.

The resonant circuit 2245 has a high resonant frequency that is slightly lower than the switching frequency of the transistors. Typically, the lowest frequency operable for practical purposes is 18 kHz, and the upper limit is limited by other practical considerations, but maybe as high as 80 kHz. The resonant circuit is also connected to the second node 2214 and a light source 2250 (e.g., a gas discharge lamp, a fluorescent lamp, a light emitting diode (LED), etc.).

In particular, a first input 2252 is connected to the source and drain of NMOS transistors 2235 and 2240. A first output 2253 of the resonant circuit 2245 is connected to a second input 2254 of the resonant circuit 2245 via a first filament 2255 of the light source 2250. Further, in the example of FIG. 10a, a second output 2256 of the resonant circuit 2245 is connected to the second node 2214 via a second filament 2260 of the light source (e.g., lamp or tube) 2250. As will be described in detail below, the resonant circuit 2245 can be viewed as a coupling device matching impedance of the tube with the power source. The resonant circuit functions to store energy and selectively charges and discharges energy into the light source 2250 at the switching frequency, which greatly exceeds the line frequency of the rectified current which is at the line frequency, thereby exciting the light source 2250 to visually emit light. Further, the resonant or tank circuit 2245 presents an impedance to the power source 2205 to thereby limit the current flowing into the light source 2250. The tank circuit increases the input line voltage by circulating energy in the tank circuit, and presents an alternating voltage across the ends of the bulb 2250. In the present invention, the bulb is ionized or said to be ignited at the beginning of each half cycle (120 Hz) of the input power voltage.

The tank circuit presents a variable input impedance. When the input voltage at node 2252 is just rising, such as shown with square wave 2270 of FIG. 10c, the impedance is higher because of a high Q factor (which represents an unloaded circuit) of the tank circuit. When the input voltage is low, the bulb has not been ionized and the tank circuit has a high Q factor. As the input voltage increases, the bulb ionizes resulting in a lower Q factor of the tank circuit, allowing more current to flow. This means the current on the load is largely in phase with the voltage from the source, which results in a high power factor for the ballast.

In operation, the ballast circuit 2200, is connected to a power source (e.g., an alternating current source, etc.). When power is provided, the ballast charges a high frequency bypass capacitor (corresponding to capacitor 2215 of FIG. 10a). Specifically, the bypass capacitor presents a large impedance to a line frequency current of the power source (e.g., 60 Hz, 120 Hz, etc.) (block 310). In addition, power is supplied to a regulator that provides power to actuate a driver circuit, for example. In such an exemplary circuit, the energy source (e.g., a power supply, etc.) is coupled to a resonant circuit via a first node. In response, the energy source supplies energy at the line frequency (60 Hz) which is combined with the energy from the capacitor at a high frequency (e.g., about 40 KHz, or whatever is the switching frequency) to the resonant circuit. In particular, the bypass capacitor provides the high frequency energy in the form of a current via the first node when the first transistor is closed. When the resonant circuit receives the line frequency energy and the high frequency energy (in the form of current), the resonant circuit has a voltage with a positive magnitude, thereby causing a light source connected to the resonant circuit to ionize the gas and emit light therefrom for the first half cycle.

After light is emitted from the light source, the resonant circuit is coupled to the second node. As a result, the resonant circuit has a voltage with a negative magnitude, and the energy is circulated within the tank circuit and within the bypass capacitor, thereby causing the powered light source to ionize the gas and emit light during the second half cycle. During this time, the bypass capacitor is also charged from the power source. If the power is still turned on to the ballast, the process repeats. In the present invention, there is no ionization during a brief time period while the rectified unfiltered DC input voltage is in a “valley.” This point corresponds to the zero crossing point of the AC input line voltage. The time period during which the bulb is not ionized is typically at least 200 microseconds. However, this short time period is not perceivable to the human eye and the bulb may be generating light due to persistence of the phosphor in the bulb.

In operation of the exemplary circuit just described, high frequency energy is stored in the bypass capacitor, which continually recycles the high frequency energy during its operation. The high frequency current has a frequency generally in the range of approximately 20 to 80 KHz. Thus, the high frequency energy continually recycles via the bypass capacitor at the switching frequency, thereby preventing substantial energy loss. Further, the energy source is directly connected to the resonant circuit via a low impedance path to prevent substantial loss of energy. Accordingly, the resulting circuit implements a process generally having a high power factor, high efficiency, and a near ideal crest factor.

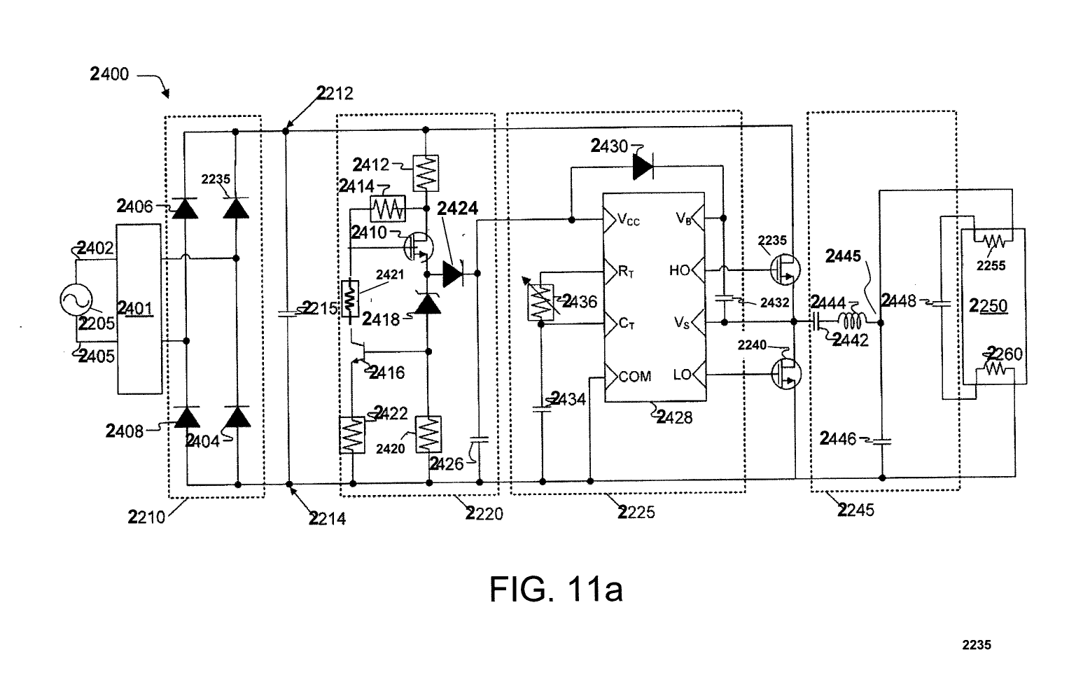

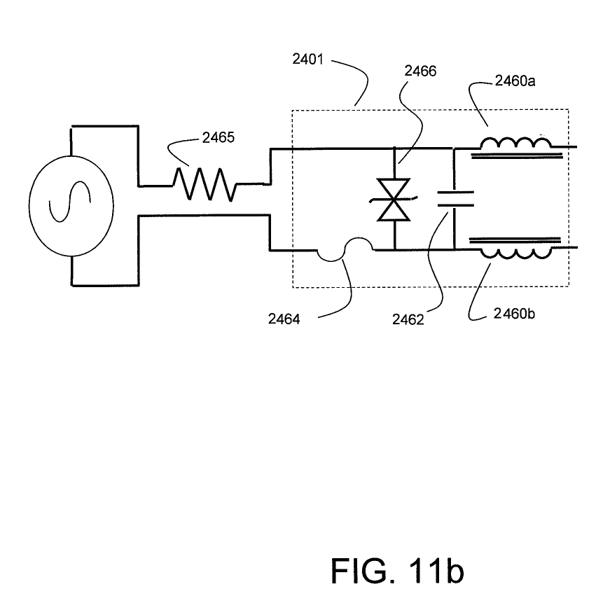

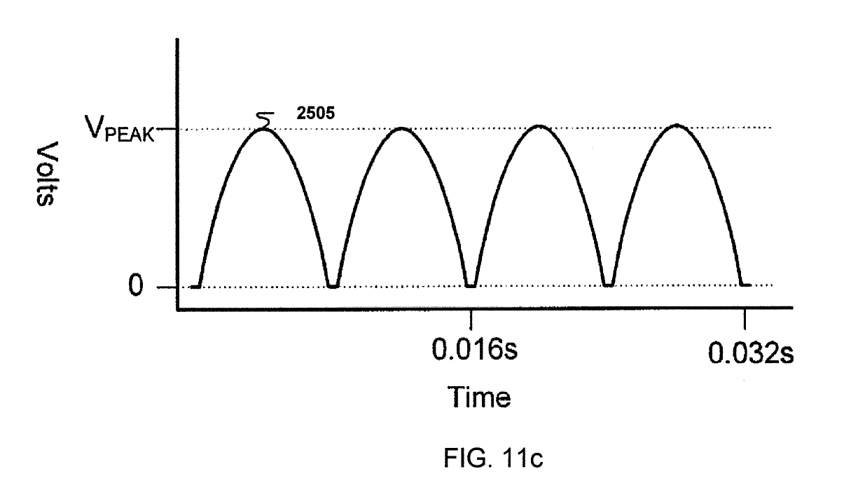

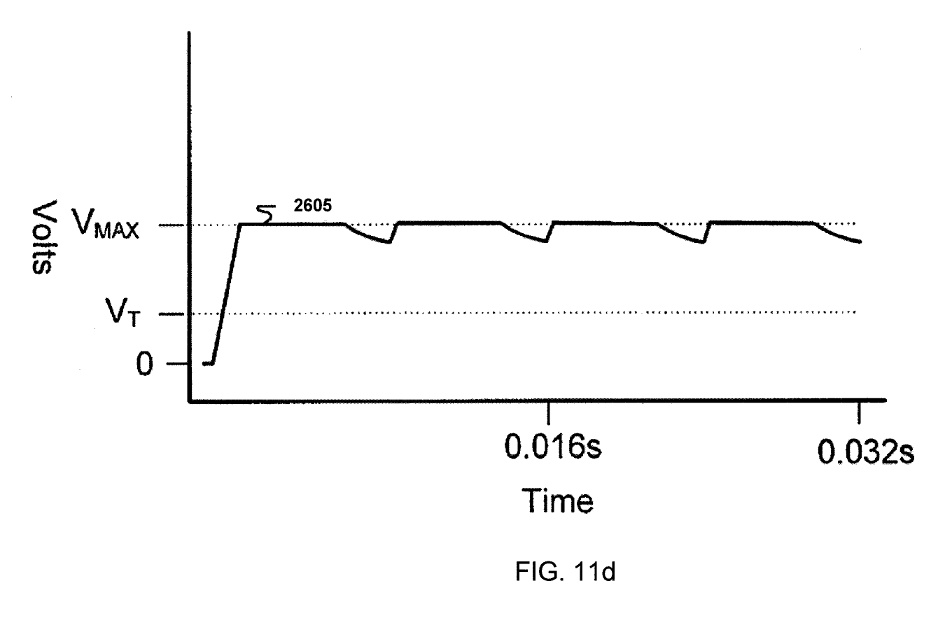

FIG. 11a is a schematic diagram of an exemplary circuit 2400 that may implement the operation just described. In FIG. 11a, power source 2205 is coupled to rectifier 2210 via a line filter 2401, which insulates power source 2205 from noise due (e.g., electromagnetic interference, etc.) generated by the remainder of the ballast circuit. This is discussed in further detail below. More particularly, a first terminal 2402 of the power source 2205 providing household power is coupled to the anode of a diode 2403 and the cathode of a diode 2404 via the line filter 2405. The cathode of the diode 2403 is connected to the first node 2212 and the anode of the diode 2404 is connected to the second node 2214. Further, a second terminal 2405 of the power source 2205 is connected to the anode of a diode 2406 and the cathode of a diode 2408 via the line filter 2405. The cathode of the diode 2406 is connected to the first node 212 and the anode of the diode 2408 is connected to the second node 2214. The first node 212 and the second node 2214 are connected via the capacitor 2215, which presents a low impedance to high frequency energy.

The value of capacitor 2215 is typically a 0.8-1.5 μF polypropylene capacitor for a 23 watt light source, and 0.22 μF for a 5 watt light source. The value can be adjusted as appropriate for the output load, but typically is 4 μF or less for a typical CFL. The value of capacitor 2215 is small enough so as to not impact the output rectified voltage at node 2212. Specifically, the value should not preclude the output voltage presented at node 2212 from dropping down to 15% or less of its peak voltage of the rectifier output at the end of each half cycle. In other words, the voltage at the bottom of the “valley” should be no more than 10-18 volts.

Voltage regulator 2220 is also connected to first and second nodes 2212 and 2214 and is configured to provide a substantially constant output voltage to the driver circuit. In the illustrated example, voltage regulator 2220 is implemented using an NMOS transistor 410 that is connected to the first node 2212 via a resistor 2412. The drain of NMOS transistor 2410 is connected to its respective gate via a resistor 2414. The gate of NMOS transistor 2410 is further connected to a collector of a transistor 2416 via an optional resistor 2421, which has its respective base connected to the anode of a zener diode 2418. Resistor 2421 reduces the gain of the transistor thereby reducing possibility of oscillations in transistor 2410. The cathode of zener diode 2418 is connected to the source of NMOS transistor 2410.

In addition, the base of transistor 2416 is connected to second node 2214 via resistor 2420 and its emitter is connected to the second node 2214 via a resistor 2422. In the example of FIG. 11a, the source of the NMOS transistor 2410 is connected to the cathode of a diode 2424 and the anode of diode 2424 is connected to the second node 2214 via an energy storage device, such as a capacitor 2426, (referred to herein as a housekeeping filter capacitor) which typically has a value of 10-30 μF. As will be described below, capacitor 2426 stores energy therein to aid in providing a substantially constant voltage to the driver 2225, even in conjunction with operation of a dimmer. The capacitor 2426 also is used as a “bootstrap charging capacitor” for assisting diode 2430 in charging capacitor 2432 discussed below. Thus, capacitor 2426 also functions in conjunction with the driver 2225, but is shown as a component of regulator 2220 for illustration sake.

In the illustrated example of FIG. 11a, driver 2225 is implemented using any suitable circuit that selectively actuates transistors 2235 and 2240. Driver 2225 in the exemplary circuit of FIG. 11a includes, for example, an International Rectifier™ Part No. 2153, which is a self-oscillating half-bridge driver circuit 2428. However, one of ordinary skill in the art would understand that any suitable driver circuit could be implemented to perform the functions that the driver 2225 provides (e.g., a 555 timer, processor, or other source of a suitable pulse, including PWM square wave generators, etc.). In other embodiments, transistors 2235 and 240 may be integral with the driver circuit 2428 (e.g., an integrated circuit such as the STMicroelectronics™ L6574, etc.).

Referring to the driver 2225, regulator 2220 provides the substantially constant (i.e., regulated) voltage via diode 2424, which also isolates voltage regulator 2220 from driver 2225. Stated differently, diode 2424 prevents current from flowing from capacitor 2426 into regulator 220 when the voltage of the first node 2212 falls below the voltage stored in capacitor 2426. In the embodiment of FIG. 11, capacitor 2426 and the cathode of diode 2424 are also connected to the supply voltage (Vcc) of driver circuit 2428 to provide a substantially constant voltage to driver circuit 2428. The value of the capacitor may be sized so as to allow operation with a dimmer, such as a phase control dimmer, which may limit the voltage provided to the rectifier, and therefore to the ballast. Thus, even if a dimmer is dimming the input voltage by clamping of the input voltage wave form to the ballast for a certain time period, the capacitor must be sized to provide sufficient power to the driver to allow it to continue to operate through the greatest range of dimming. The capacitor 2426 and the cathode of the diode 2424 are also connected to the anode of a diode 2430, which is connected to the high side floating supply voltage (V_{B}) of the driver circuit 2428 via its respective cathode. Further, the cathode of the diode 2430 is connected the high side floating supply offset voltage (Vs) of the driver circuit 2428 via a capacitor 2432 this capacitor supplies the driver power for the switching FET 2235.

In the illustrated embodiment of FIG. 11a, the frequency of driver circuit 2428 is adjusted by selecting different resistance and capacitance values. More particularly, the oscillating timing capacitor input (C_{T}) on pin 3 of the driver circuit 2428 is connected to the second node 22214 via a capacitor 2434. Further, the oscillator timing resistor input (R_{T}) of the driver circuit 2428 is connected to the oscillating timing capacitor input (C_{T}) of the driver circuit 2428 via an adjustable resistor 2436 or impedance (e.g., a potentiometer, a transistor presenting a variable resistance or impedence, etc.). In such a configuration, the switching frequency of driver circuit 2428 can be variably controlled by adjusting the resistance of resistor 2436, which is typically set during manufacturing, for example. In other embodiments, a fixed resistance value for resistor 2436 can be used.

In the illustrated example, the resistance value of the resistor 2436 and the capacitance value of the capacitor 2434 configure the driver circuit 2428 to produce pulses at a frequency in the range of approximately 20 to 100 KHz. Specifically, the pulses are alternately produced by driver circuit 2428 and are output via the high side gate driver output (HO) and the low side gate driver output (LO). Stated differently, during the first half cycle of a period of the switching frequency (i.e., the half of the time period for a single cycle), the high side gate driver output of the driver circuit 2428 produces a pulse. During the second half cycle of the period (i.e., the low side of the cycle) of the switching frequency, the low side gate driver output of the driver circuit 2428 produces a pulse. Typically, there is a dead time between pulses when neither transistor is turned on, e.g., the time after the first pulse ends and before the second pulse begins.

In the embodiment of FIG. 11a, the high side gate driver output (HO) is further connected to the gate of NMOS transistor 2235 and the low side gate driver output (LO) on pin 5 is connected to the gate of NMOS transistor 2240. In other examples, driver circuit 2428 may be connected to the gates of transistors 2235 and 2240 via resistors to prevent parasitic oscillations, for example. If the resistors are present, these may be around 31 Ohms. NMOS transistors 2235 and 2240 are also connected to the high voltage floating supply return (Vs) of the driver circuit 2428 via their source and drain, respectively. The drain of NMOS transistor 2235 is connected to the first node 2212 and the source of NMOS transistor 2240 is connected to the second node 2214.

As described above, the source of the NMOS transistor 2235 and the drain of the NMOS transistor 2240 are connected to the resonant or “tank” circuit 2245, which selectively stores a charge therein. In the illustrated example, the resonant circuit 2245 includes a capacitor 2442 in series with an inductor 444. The capacitor 2442 functions in part as a DC blocking capacitor. Its value is in some embodiments is 1/10 the value of capacitor 2215 as a rough rule of thumb. However, other ratios can be used, but may not be optimized for the power factor. Typically, the capacitor 2442 has a value from 1 μF to 0.01 μF.

The inductor 2444 is generally a gapped core inductor that is capable of handling a large peak current. The inductor is larger than what is used in a typical prior art ballast of the same power, because this inductor processes both the lower line frequency current (e.g., 120 Hz) as well as the higher, switching frequency current (e.g., 20-100 kHz) and must avoid saturation at the lower frequency. This is in contrast to prior art ballasts which process a filtered DC output voltage, resulting in a largely constant DC voltage with little ripple. Hence, the prior art inductors in the tank circuit are not designed to conduct a line frequency current. In FIG. 11a, the inductor stores energy from both the low and high frequency currents. The inductor is gapped so as to reduce the heat caused during operation and to eliminate saturation at peak current of the low frequency current (which can be 3-4 amps, in some embodiments). The size of the gap depends on the permeability of the core material and is typically in a range of 0.1″ to 0.3″, which is much larger than found in a typical prior art ballast. Further, to handle the large current, the wire used is typically “litz” wire (also known as Litzendraht wire), which is wire made from a number of fine, separately-insulated strands specially braided or woven together for reduced skin effect and hence lower resistance to high frequency currents for lower RF losses. The inductor's rating is largely determined by the higher frequency operation and can be sized roughly by the following formula: 30/watts=X mH, where “watts” denotes the desired output from the light source. The inductor value must be such that it allows the circuit function to operate within the desired frequency range (18-80 kHz) and preferably above 40 kHz in order to meet certain energy efficiency standards. Thus, one rule of thumb is that a 15 watt light source would typically require a 30/15=2 mH inductor. Further, the value of the inductance varies with the frequency of operation desired according to equation (1) below. Thus, a variety of values can be used which range up to 3 times the resultant inductance or ⅓ of the above result, that is, the range could be as low as ⅔ mH to as high as 6 mH. As the resonant frequency of the tank circuit is increased, the inductance value of the inductor is lowered.

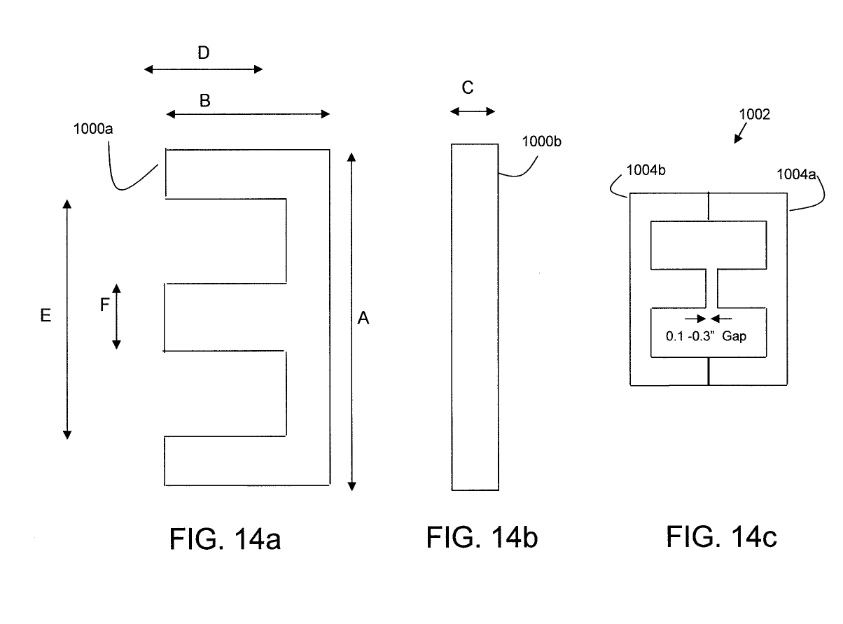

FIG. 14a-c show the dimensions of a portion of a typical inductor core, wherein a side view of the inductor 1000a is shown in FIG. 14a, an end view 1000b is shown in FIG. 14b. The inductor 1002, comprising a “double E” core 1004a, 1004b is shown in FIG. 14c. The following values that could be typically used for a range of power output up to 38 watts at 40 kHz, wherein A=1″, B=0.63″, C=0.25″, D=0.507″, E=0.74″, F=0.25″ and the gap is between 0.1 and 0.3″ but could be as high as 0.5″. Those skilled in the art will recognize that a variety of shapes, wire, material, and configurations are possible in order to meet the functional requirements of the inductor.

The inductor 2444 is connected to the second node 2214 via a capacitor 2446 to store a charge therein and excite the light source. Further, the inductor insures that the current is in phase with the supply voltage, thereby contributing to the high power factor of the circuit. Further still, the inductor 2444 is connected to a capacitor 2448 via the first filament 2255. The capacitor 2448 is also connected to the second node 2214 via the second filament 2260. The capacitor 2448 receives current and stores a charge therein to excite the light source via current flowing across the filaments 2255 and 2260. The resonant frequency of the example resonant circuit 2245 is described by equation 1 below:

$${f}_{R} = \frac{1}{2 π \sqrt{\frac{{L}_{444} {C}_{442} ( {C}_{446} + {C}_{448} )}{( {C}_{442} + {C}_{446} + {C}_{448} )}}} \qquad Equation [ 1 ]$$

where f_{R} is the resonant frequency of the circuit, L₄₄₄ is the inductance value of the inductor 2444, C₄₄₂ is the capacitance value of the capacitor 2442, C₄₄₆ is the capacitance value of the capacitor 2446, and C₄₄₈ is the capacitance value of the capacitor 2448. In the illustrated embodiment, the capacitor 2446 is configured to have a different value such that it has a different energy potential than the capacitor 2448. In particular, the capacitor 2446 provides a larger voltage to allow the lamp 2250 (FIG. 2) to turn on. The summation of capacitor 2446 and capacitor 2448 impacts the resonant frequency of the tank circuit. Typically, the value of capacitor 2448 is determined by the desired current flow through the filaments, which have a resistance typically set by the manufacturer or by an industry standards body for a particular country. Typically, capacitor 2215, capacitor 2442, and capacitor 2446 are made from polypropylene, but could be made from polyester, providing each has a low equivalent series resistance (ESR) value. These capacitors typically can not be electrolytic capacitors, because electrolytic capacitors generally have large ESR characteristics.

The values of the components in the circuit vary on the output power of the lamp and the desired resonant frequency. In certain embodiments, values for 120 VAC operation of certain components are illustrated in the table below:

| | | | | | Inductor | |
|---|---|---|---|---|---|---|
| Em- | | | | | (typically | |
| bodi- | Output | Capacitor | Capacitor | Capacitor | 0.034 litz | Freq. |
| ment | Power | 2442 | 2446 | 2448 | wire) | (kHz) |
| 1 | 42 W | 0.047 μF | 15 nF | 8.2 nF | .72 mH | 47 |
| 2 | 32 W | 0.1 μF | 37 nF | 15 nF | .901 mH | 27 |
| 3 | 15 W | 0.1 μF | 12 nF | 10 nF | 1.672 mH | 30 |

In embodiment 1 and 3, the operation is for a CFL bulb, whereas embodiment 2 is for a pair of 4 foot tubular lamp bulbs. For embodiments 1, and 2, the inductor can be made from an Elna bobbin part # CPH-E34/14/9-1S-12PD-Z. For embodiment 3, the inductor can be made from an Elna/Fair-Rite core #9478375002. In the above embodiments, it is possible to use a 1 μF capacitor for output powers of 15-42 watts.

The other values of the circuit shown in FIG. 11a are summarized as follows:

| | |
|---|---|
| Driver 428 | IR Corp IR2153 or IR2153D |
| Transistors 2235, 2240 | N FET 250 v, 0.47 Ohm |
| Capacitor 215 | 1 μF 250 v, polypropelene |
| Diodes 2406, 2403, 2408, 2404, | 1 A, 400 v general purpose diode, |
| | 1N4004 |
| Diode 2430 | 1 A, 400 v fast diode, 1NF4004 |
| Transistor 2416 | 2N2222 |
| Capacitor 2432 | 1 μF 25 v, electrolytic |
| Capacitor 2426 | 22 μF 25 v, electrolytic |
| Resistor 2412 | 220 Ohm |
| Resistor 2414 | 1 M Ohm |
| Resistor 2422, 2421 | 1k Ohm |
| Diode 2418 | 14 v, 10%, 200 mW, Zener |
| Resistor 2436 | 50k potentiometer |
| Capacitor 2434 | 220 pF, mica |

Those skilled in the art will realize that other values or type of components may be used.

The embodiment of FIG. 11a is suitable for operation with a dimmer, due to the presence of the voltage regulator circuit 2220. Because the voltage present on node 2212 is an unfiltered, rectified AC voltage (e.g., DC), the voltage has a periodic valley of zero volts. A typical half cycle rectified voltage wave form 2472 that is present at node 2212 is shown in FIG. 7 as described above. At the time that the DC voltage is zero at node 2212, the voltage regulator circuit 220 ensures that a stable DC output voltage is nevertheless provided to the driver circuit 225.

When operated with a dimmer, the voltage provided to the ballast circuit may not be that as shown as waveform 700 in FIG. 7a. When operating, a dimmer typically clamps a portion of the waveform to zero for a defined time period. This time period is determined in part by the user turning a potentiometer in the dimmer to effect different dimming levels. Thus, in one instance, the time may be set at t₁ 704a as shown in FIG. 7a. The resulting voltage wave form 706 has the portion prior to t₁ clamped to zero, so that the resulting waveform has a period of time where the input supply voltage to the ballast is zero. The shaded portion under the wave 706 represents the energy provided to the ballast, and the less energy provided to the ballast, the less light produced by the light source. Thus, during the time period up to t₁ the voltage regulator circuit 2220 ensures that the driver circuit still receives a DC operating voltage.

The operation of the example of FIG. 11a will be explained in conjunction with FIGS. 11c, 11d, 12a, 12b, and 13, which illustrate the operation of the circuit 2400. As described above, the rectifier circuit 2210 rectifies the current provided via the power source 2205, thereby creating a voltage waveform at 120 Hz. The exemplary waveform of FIG. 5 illustrates the voltage differential between the first node 2212 and the second node 2214, which is denoted by the reference numeral 2505. As seen, the waveform valleys go to zero or near zero (less than 10-18 volts), because as mentioned previously, capacitor 2215 presents a large impedance to the line frequency of the power source 2205 and does not substantially affect the rectified alternating current (DC) at the nodes 2212 and 2214. Consequently, the voltage at node 2212 dips from a peak voltage to essentially zero volts each half cycle. The value of capacitor 2215 should not significantly impact the low frequency output voltage waveform of the rectifier.

In addition, the line filter 2401 is configured to prevent high frequency energy from the capacitor 2215 from entering back into the power source 2205. The filter 2401 is typically not required to be present in commercial products embodying the invention, such as shown in FIG. 11b, but typically a filter circuit of some form is included when the ballast is designed to power 40 watt or higher fluorescent lamps. As shown in FIG. 11b, the line filter may comprise other components, such as a fusible link 2464 and a transient suppressor 2466 (which although not required for filtering purposes, may be present nevertheless). The filter includes capacitor 2462 across in the input mains, and chokes 2460a and 2460b in series with the input mains. The capacitor is typically 0.1 μF and each choke is typically 190 μH. This line filter attenuates the high frequency signals generated by the ballast from being introduced back into the power source. The transient suppressor is shown as part of the line filter, but it protects transient voltage spikes from the power source. A resistor 2465 may be incorporated in addition to the filter 2401, which is effective for absorbing energy that may facilitate dimming of the ballast for certain applications. If the resistor is present, a 30 ohm, 5 watt value may be used for a 10 watt CFL.

Returning to FIG. 11a, the operation of the voltage regulator 2220 and resistor 2414 causes the NMOS transistor 2410 to have a gate-source voltage and, in response, it turns on to conduct current. In the illustrated example, the resistor 2412 generally configures the transistor 2410 to operate in the safe operating area and in the event of excessive current flow, it experiences a failure thereby uncoupling the transistor 2410 from the node 2212. Initially, the zener diode 2418 conducts current into the base of transistor 2416 causing the NMOS transistor 2410 to block current from flowing into the second node 2214 by presenting a large impedance of transistor 2410, which causes the current to flow toward the gate drive supply voltage (Vcc) on pin 1 of the driver circuit 2428. When current flows toward the gate drive supply voltage, the capacitor 2426 stores the current energy as a voltage to provide a substantially constant voltage to the driver circuit 2428. As a result, the driver circuit 2428 turns on and produces pulses via its respective outputs at a frequency determined by the resistance value of the adjustable resistor 2436 and the capacitance value of the capacitor 2434. In some embodiments, the adjustable resistor may be connected to another resistance in series (typically around 33 k), to avoid a condition where the adjustable resistor is set to zero (or a very low) resistance, thereby potentially damaging the driver integrated circuit. In other embodiments, the adjustable resistor can be set during manufacturing in order to adapt imprecise component values in the resonant circuit and set the switching frequency of the transistors. In other embodiments, the adjustable resistor 2436 can be a fixed value resistor or equivalent depending on the desired operating frequency.

However, when the voltage across the zener diode 2418 exceeds a corresponding breakdown voltage (e.g., about −14.0 volts, etc.), the zener diode 2418 enters what is commonly referred to as “avalanche breakdown mode” and allows current to flow from its cathode to its anode. In response, the current flows across the resistor 2420 and causes the transistor 2416 to have a base-emitter voltage (V_{BE}), thereby turning on the transistor 2416. The transistor 2416 sinks current into the second node 2214, which reduces the gate-source voltage of the NMOS transistor 22410 and the current through the zener diode 2418. Once the current in the zener diode 2418 does not exceed the design of the output of the regulator value, the zener diode 2418 recovers to the design value and reduces the current from flowing into the resistor 2420. That is, as illustrated in the example of FIG. 6, by reducing the voltage at the source of the NMOS transistor 2410 denoted by reference numeral 605, the voltage supplied to the driver circuit 2428 does not substantially exceed the predetermined threshold voltage (Vₘₐₓ). In the example of FIG. 11a, the resistance value of the resistor 2422 is selected to reduce the loop gain of the transistor 2416 to prevent oscillations and the resistance value of the resistor 2420 is selected to prevent a leakage current from flowing via the zener diode 2418 into the base of transistor 2416.

Thus, the example voltage regulator 2220 is configured to provide a substantially constant (i.e., regulated) voltage to the driver 225. When the rectified voltage provided via the rectifier 2210 falls below a predetermined threshold voltage (V_{T}), the voltage output by the voltage regulator 2220 decreases. However, as illustrated in the example of FIG. 11d, the energy storage device 2426 has a corresponding voltage that exceeds a minimum threshold voltage (V_{T}) and continues to provide energy to the driver circuit 2428. In addition, when the voltage at the node 2212 falls below the voltage of the regulator 2220, the diode 2424 prevents current from flowing backwards from the capacitor 2426 into the NMOS transistor 2410 and resistor 2412 from the constantly discharged tank circuit via 2212.

The driver circuit 2428 is configured to generate a signal that alternately actuates one of the transistors 2235 and 2240 at the switching frequency, which is much higher than the line frequency. In particular, during the first half (or a portion thereof) of a single cycle of the switching frequency, the high side output (HO) of the driver circuit 2428 produces a high side pulse to turn on transistor 2235 while transistor 2240 is turned off. Typically, the high side pulse has a duration that does not exceed half of the time period of a cycle of the switching frequency. When the driver circuit 2428 turns on transistor 2235, the transistor 2235 couples the node 2212 to the resonant circuit 2245 via a low impedance path.

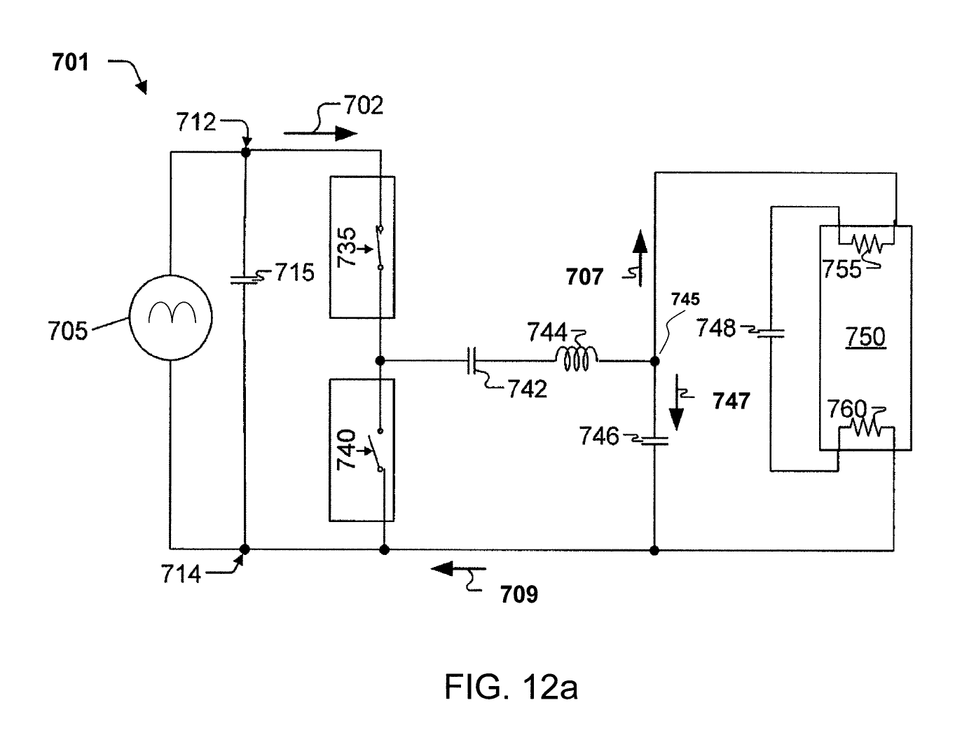

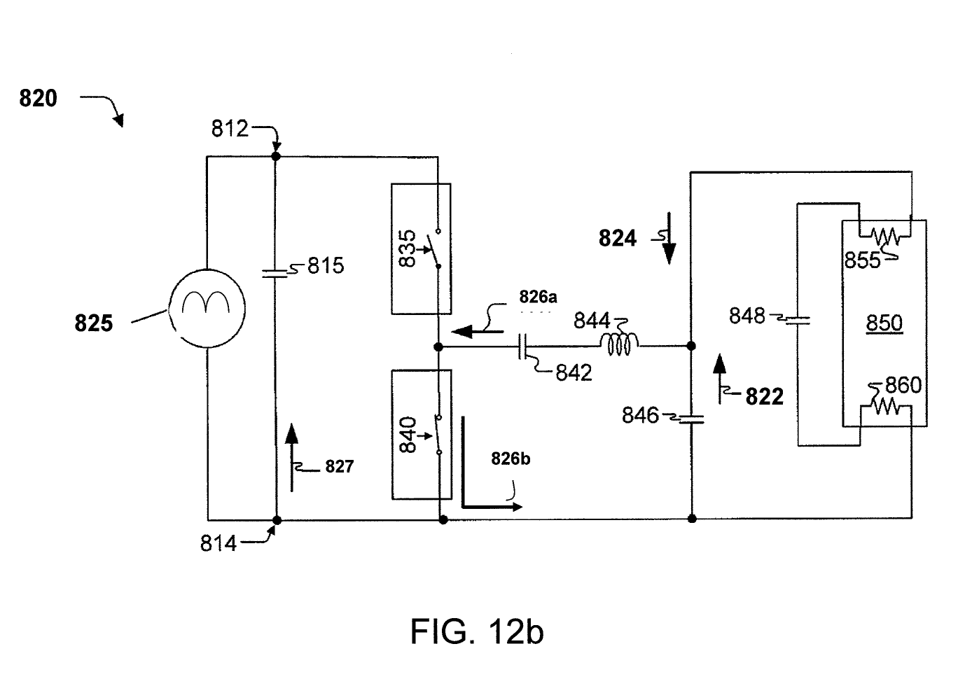

The example of FIG. 12a illustrates an equivalent circuit 701 of a ballast circuit 2400 of FIG. 11a. In this illustration, a rectified AC voltage (e.g., a time varying DC voltage waveform where each waveform is half of a sine wave) is represented as an unfiltered rectified power source 705, which produces a waveform similar to that shown in FIG. 11c. Initially, energy represented by a current denoted by reference numeral 702 flows from the power source 705 and the capacitor 715 and into the resonant circuit because the transistor 740 is turned off. The current 702 includes both current based on (twice) the line frequency (2*60 Hz=120 Hz) and high frequency current (e.g., 20 kHz). In the example of FIG. 12a, the capacitor 742 presents a high impedance to the low frequency current, thereby shaping the line frequency current flowing into the inductor 744. As the current leaves the inductor 744, a current denoted by reference numeral 747 having the high frequency current flows into the capacitor 746, which stores a portion of the current as a voltage. In addition, a current having the line frequency current and the high frequency current denoted by reference numeral 707 flows into the filament 755 and a portion of current is stored in capacitor 748 as a voltage. When this process occurs at the beginning of the half cycle of the rectified AC voltage, there is not enough voltage present on the bulb to cause ionization and light to be generated. However, as the input voltage at node 712 increases, and the energy stored in the resonant circuit also increases, the voltage across the light source 750 quickly increases to a point where the voltage is sufficient to initiate ionization and maintain the generation of the light at the light source 750. When this, occurs, then as a result of the line current and the high frequency current in the light source 750, the light source 750 emits a light that is generally visually perceptible. In addition, the line frequency current and a portion of the high frequency current, which are denoted by reference numeral 709 in the illustrated example, leaves the resonant circuit 2245 and returns to the power source 705 and capacitor 715. Slightly before the end of the first half cycle at the switching frequency, the energy stored in capacitor 715 is discharged to its lowest level. Because the transistors operate above the tank circuit's resonant frequency, the transistor switches at zero or near zero current levels.

During the second half of the time period of the switching frequency, the low side output (LO) of the driver circuit 2428 produces a low side pulse to turn on the transistor 2240 just after transistor 2235 is turned off. When the driver circuit 2428 turns on the transistor 2240, the transistor 2240 couples the node 2214 to the resonant circuit 2245 via a low impedance path. The second pulse generally has a duration that is less than 50% of the time period of the switching frequency (e.g., less than a half-cycle).

The example of FIG. 12b illustrates an equivalent circuit 820 of the ballast circuit 2400 (FIG. 11a) when the switch 840 is closed. Two simultaneous events are occurring. First, a low frequency current 827 is continuously charging capacitor 815. Recall that capacitor 815 is discharged to its lowest point after switch 835 has closed. After switch 835 is opened, capacitor 815 is no longer discharging, and is recharged by the unfiltered rectified voltage from source 825. Second, when switch 840 is closed, there is no current flowing and no energy stored in the inductor. Once switch 840 is closed, the capacitors in the resonant circuit discharge, generating a current. The flow of current 826a when the transistor 840 couples the node 814 to the resonant circuit is the sum of the currents 822 and 824 (which is from the charge in capacitors 846 and 848). Capacitor 842 stores an additional charge compared to capacitors 846 and 848 based on the low frequency current which previously flowed through it, that is not clamped by the bulb. Current 826a flows through the switch 840 back into the resonant circuit as shown by 826b. Thus, the energy in the resonant circuit is recirculated. At the same time, the voltage across the inductor and capacitors 846 and 848 changes polarity, and this causes the voltage across the light source 750 to experience a negative “mirror” of the voltage present in the prior switching half cycle.

As described above, by turning on the transistor 840, the resonant circuit is connected to the second node 814 via a low impedance path. In response, the capacitors 842, 846 and 848 discharge the voltage therein as currents denoted by reference numerals 826a, 822 and 824, respectively. The currents 822 and 824 flow into the inductor 844 and charge the capacitor 842 as a voltage, thereby causing the resonant circuit 2245 to have a negative voltage with respect to the second node 814. As a result of current leaving the capacitors 846 and 848, the light source 850 is actuated to visually emit light. After a delay, the capacitor 842 discharges producing a current as denoted by reference numeral 826, which flows into the node 814. At the end of the second half cycle of the carrier frequency, the resonant circuit stores substantially no energy and all the energy is stored in the inductor, with very little, if any, current flowing. Thus, the driver circuit is continually driving switches 835 and 840 even when there is no current flowing through the switches.

Thus, in FIG. 12a, when switch 735 is closed, the resonant circuit is energized both from the line voltage (unfiltered DC voltage) and the small energy in capacitor 715, which is added to the energy already stored in the resonant circuit. Then, in the next half of the switching cycle, in FIG. 12b, switch 835 is opened, and switched 840 is closed. The capacitors in the resonant circuit discharge, causing the voltage to become negative across the bulb. Assuming the bulb has been ionized, the bulb functions as a voltage regulator to limit the maximum absolute voltage that can exist across its terminals. During bulb ionization, current 822 is largely constant, and current 824 is varying with the AC input line current. It should be noted that this description is in terms of a single switching cycle at a high frequency, and that the process is repeated for other switching cycles wherein the input voltage from the power source may be at a lower or higher voltage, thereby impacting the relative charges, voltages, and currents of the various elements in the circuit.

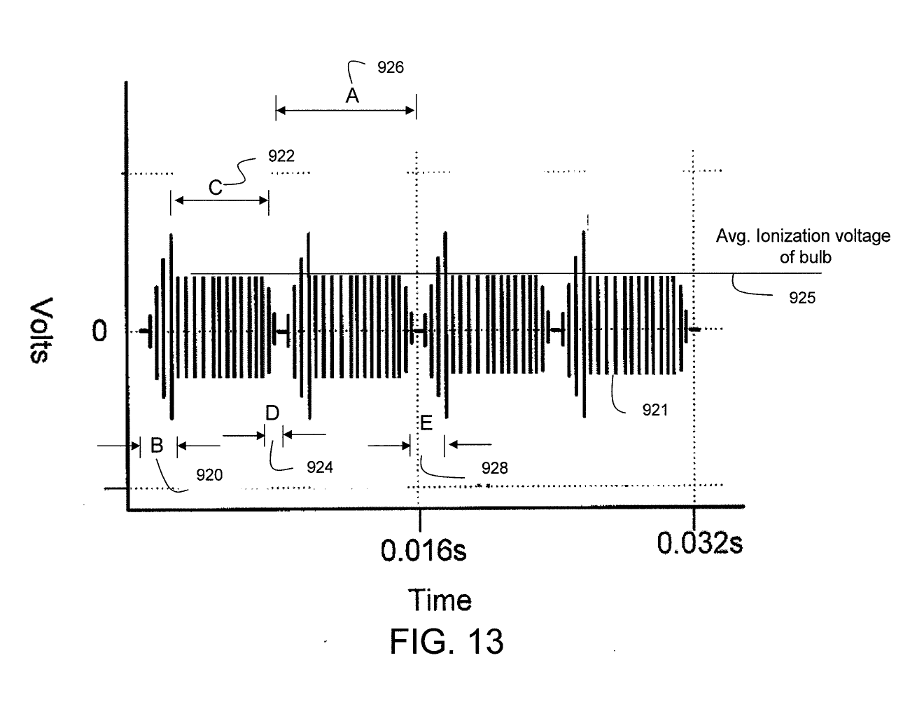

The illustrated voltage waveform of FIG. 13 illustrates diagrammatically the theory of voltage present in the resonant circuit across the light source during operation. FIG. 13 illustrates a number of half line cycles (120 Hz), wherein a given half cycle A 906 is half the line frequency (e.g., 120 Hz or 0.008 seconds). At this time scale shown in FIG. 13, the individual voltages 901 at the switching frequency (e.g., 40 kHz) are difficult to identify individually, and the figure is not necessarily drawn to scale. (If drawn to scale, the high switching frequency waveforms would be indistinguishable).

Each half line cycle in time period A 926 shows a similar pattern. In time period B 920, which occurs at the beginning of the half cycle, the switch 735 of FIG. 12a introduces energy from the rectified AC line. However, because the rectified AC voltage is just increasing from zero volts, the energy introduced into the resonant circuit is relatively small. Further, any energy stored in bypass capacitor 715 is added as well into the resonant circuit. The energy is stored as a voltage in the capacitors of the resonant circuit. Because of the cumulative aspect of energy stored in resonant circuit, the voltage across the light source increases faster than the increase in the rectified AC voltage. Then switch 735 opens, and shortly thereafter switch 740 closed, which is depicted in FIG. 12b. At this point, the energy is converted into the inductor from the capacitors and back into the capacitors at a reversed polarity and the voltage across the bulb is reversed. During a short time period B 920 in FIG. 13, the voltage rapidly increases in the unloaded resonant circuit because the tube has not ionized. No ionization occurs in the tube, and while there may be some continued light generated by phosphoresce in the tube, there is no active ionization occurring to generate light.

This process builds up voltage across the tube until ionization occurs (around 20-35 volts of the input voltage to the resonant circuit), which occurs at the beginning of time period C 922. The tube acts as a voltage clamping regulator to keep the voltage relatively constant across it (that is, the magnitude or absolute value of the voltage, recognizing it is either positive or negative in value), which is shown as an average ionization voltage level 910 in FIG. 13. This process continues for much of the remainder of the half-cycle, until the unfiltered DC input voltage to the resonant circuit decreases below a point where ionization is no longer maintained. This is shown as time period D 924. Thus, before ionization, all the energy in the resonant circuit is circulated, and after ionization, most of the energy in the resonant circuit is circulated (because a portion is transferred to the bulb for generating light).

The voltage change over the beginning, peak and falling voltage edges of the rectified AC input to the tank (which is switched by transistors 735 and 740) and the constant ionization voltage of the bulb causes a large change in current to be linearly processed by capacitor 742 and inductor 744. As compared to a traditional ballast with a filtered DC supply, this change in current causes a large change in Q.

Thus, there is short time period at the beginning of a half cycle and the end of the half cycle shown as period E 9228, where ionization does not occur in the tube, and there may be no light generated as a result of ionization. Consequently, unlike the prior art which initiates ionization in the tube and maintains the ionization during normal operation (e.g., while power is applied to the ballast), the present invention causes ionization to initiate every half cycle, or 120 time per second. Further, there is a time period every half cycle where light due to ionization may stop, although light may continue to be generated for a short time due to the persistence of the phosphorescence. However, the time period when the voltage is too low to generate ionization is very short, and does not create a perceptible condition for humans.

The current flowing into the resonant circuit at the line frequency is largely maintained as a rectified sine wave, which means that the current load is largely in phase with the voltage at the line frequency from the power source. Further, the resonant circuit does not store any significant energy (inductive or capacitive) to distort the low frequency current during the time period between the half cycles, thereby causing the resonant circuit to appear as a resistive load to the power supply. Thus, the present circuit maintains a high power factor during operation. In particular, because the current flowing through the resonant circuit is substantially similar to a sine wave, the crest factor of the illustrated example is approximately the square root of 2 (e.g., about 1.5), which is close to an ideal crest factor. Contrast this to the prior art ballasts which require a dedicated power factor correction circuit to obtain a suitable crest factor.

In addition, the example ballast circuit of present invention does not require a large electrolytic capacitor as used in conventional ballasts to store substantial amounts of low frequency energy because the high frequency energy is continually recycled by a non-electrolytic bypass capacitor. Further, the impedance presented to the power source 2205 is modified only by the resonant circuit and the example circuit 2400 contains only a single inductor. As a result, the embodiments described herein are able to realize a high power factor (typically above 0.9) with a single stage of processing with respect to the power source without incorporating the components found in a traditional power factor correction circuit. In addition, because the described examples do not require a large, high voltage, low temperature electrolytic capacitor, the lifespan of ballasts of the present invention is substantially increased.

### Cold Cathode Ballast

The aforementioned ballast circuitry can be adapted in another variation for providing power to a fluorescent lamp in a cold cathode fluorescent lamp (CCFL) configuration or mode of operation. This arrangement can be used for a variety of fluorescent lamp types, including compact fluorescent lamps (“CFLs”), linear tubular (removable) lamps, and tubular arrangements of other shapes. Advantageously, this arrangement can be used with an integrated lamp and ballast combination, such as a CFL.

CCFLs do not rely on a filament to be heated when started (nor in normal operating mode). Pre-heating is used to reduce the required ionization voltage of lamps using filaments. Thus, the initial voltage needed to ionize the tube in a CCFL mode of operation is typically higher relative to ballasts that provide power to filaments in the fluorescent lamp. However, fluorescent lamps that rely on a filament are typically not as efficient because the heat in the filaments does not generate light. Further, the operation of a bulb can be adversely impacted if a filament is broken or degraded in some manner. Further, filaments represent an additional component cost and manufacturing cost to the lamp. While the required starting voltage to initiate ionization in a CCFL configuration is higher than a lamp using filaments, ionization occurs faster in the present invention during initial startup because in part there are no filaments to heat. In the CCFL configuration, a high voltage sufficient to cause ionization is applied to the ends of the tube. Because the tank circuit provides the required ionization voltage very quickly, the bulb quickly ionizes. Once ignited, the tube presents a lower impedance (e.g., negative value) and thus a ballast is required to limit the current. This is true regardless of whether filaments are used. Once ignited, there is no significant difference in the voltage required to maintain ionization in a lamp having filaments as compared to a lamp without filaments.

It is possible to also operate a fluorescent bulb having filaments in a CCFL configuration, i.e., without heating the filaments. In this configuration, the ends of the filaments can be simply shorted together, and they are not relied upon for starting the lamp. In other embodiments, only one terminal of each filament may be connected to the tank circuit, with the other terminal of each filament not connected. From an electrical perspective, shorting the filaments can be considered equivalent to removing the filaments because the filament resistance is reduced to zero. Hence, the present invention can be adapted to function with conventional four-pin fluorescent bulbs, as well as two-pin linear bulbs. Consequently, a “CCFL” bulb as used herein refers to a bulb used in a cold cathode mode—e.g., there is no filament in a bulb that is heated. Thus, a CCFL may have a filament, but if present, it is not heated. The present invention can also be adapted to CFLs having integrated ballasts, and avoids the need for incorporating filaments in the bulbs of CFLs. This reduces component cost and manufacturing complexity.

FIG. 15 illustrates one embodiment of the present invention used in a CCFL configuration. This embodiment is designed for an input line voltage at 120 VAC, 60 Hz operation, unless noted otherwise. Those skilled in the art can readily adapt the circuit for other voltages/frequencies. In FIG. 15, the ballast portion 1101 is the same as described earlier, and hence its description is not repeated again. The value of the bypass capacitor 1102 is in the range previously disclosed (generally under 1 μF) as appropriate for the particular load of the fluorescent lamp. Its value does not appreciably distort or modify the rectified voltage from the full wave bridge rectifier. The scope of “distort” or “modify” means that the rectified voltage waveform is not precluded from having valleys at each half-cycle where the rectified input voltage drops to 50% or less, and in one embodiment to 15% or less, of the peak input voltage. In other words, if the valley on the input line voltage waveform (see, e.g., FIG. 10b) does not drop down to at least 15% of the peak voltage, then the capacitor value is too large, and distorts the rectified AC input voltage. The ballast portion 1101 connects with a tank circuit 1150 at input nodes 1151 and 1153. [Ray, Karl will add a paragraph on reactance.]

The value of the bypass capacitor in the CCFL configuration (as well as in non-CCFL configurations) is selected such that it presents a high impedance at the line frequency, and a low impedance at the switching frequency. The reactance is defined by the following formula:

$${X}_{c} = \frac{1}{2 π fC}$$

In the case for a 23 watt CCFL operating at a switching frequency of 40 kHz, a 1 μf capacitor typically used would present an impedance of about 4 ohms. However, this same capacitor would have an impedance at the line frequency of 60 Hz of about 2653 ohms. The line frequency is generally fixed by the power source (e.g., 60 Hz) and thus a high impedance is presented by the bypass capacitor, typically greater than 1500 ohms. However, the switching frequency can vary in different embodiments (typically ranges from 18 kHz to 80 kHz) and consequently the impedance at the high switching frequency can varies in proportion to the switching frequency. For example, at 80 kHz the impedance of the same 1 μf capacitor would be 2 ohms. Consequently, the impedance of the bypass capacitor at typical switching frequencies is typically less than 100 ohms.

However, the tank circuit is different compared to previous embodiments and the tank circuit 1150 comprises capacitors 1172 and 1175, an inductor 1174, and lamp 1188. In this embodiment, lamp 1188 is illustrated as having two filaments 1186a and 1186b (e.g., a four-pin gas discharge tube), but each filament has its corresponding leads (1180a, 1180b, and 1182a, 1182b) connected together. Thus, the potential across each filament is zero volts. In other embodiments, a two-pin, filament-less tube can be used. The use of the bulb with filaments in FIG. 15 is merely to illustrate that filament type bulbs can be used, and does not imply that only lamps with filaments must be used. Further, in other embodiments, only one lead of each filament may be connected, but again, in this configuration the filament is not heated to facilitate startup.

In this embodiment, the inductor 1174 is configured as a tapped inductor. One portion 1174a (to the left of the tap) comprises about half of the total inductance and the other portion 1174b (to the right of the tap) comprises the other half. From an implementation perspective, the first portion comprises about ¾ of the total number of windings and the second portion comprises about ¼ of the number of windings. This demarcation point occurs typically at a center tap of the inductance value (not a center tap of the number of turns). These portions will be referred to herein as the “right portion” 1174b and “left portion” 1174a, and is merely convenient nomenclature to illustrate the invention in light of FIG. 15. This should not be interpreted as limiting the configuration or location of the inductor or portions thereof in a physical embodiment. Further, the ratio of turns on the right portion is not limited to 25% of the total number of turns, but can be in a range typically from 10% to 40%. Further, even this range can be exceeded, but operation becomes less than optimum.

The two windings on the inductor are mutually electromagnetically coupled so as to create an interaction, a so-called ‘transformer action.’ Thus, the inductor can also be viewed as acting as a transformer (e.g., an “autotransformer”). The use of a tapped inductor can be viewed as functionally equivalent to a transformer having a specified inductance on the primary winding. Thus, it may be possible to implement the aforementioned tank circuit using components other than a tapped inductor, but which function equivalent to the tapped inductor.

The tap is connected to node 1193, so that a resonant circuit is formed from node 1151, through capacitor 1172, the left portion of inductor 1174a, to node 1193, and then to node 1153. This portion forms an LC circuit that resonates having a sinusoidal voltage when a square wave-like voltage is provided to the inputs of the tank circuit from the ballast portion 1101. The portion of the inductor to the right of the tap 1174b does not contribute its inductance to the resonant circuit. Specifically, because node 1193 is tapped within the inductor, the right side inductance of the right portion 1174b of inductor 1174 is not used to determine the L value in the resonant circuit.

The inductance associated with the left portion of the inductor, along with the capacitor 1172, determines the resonance of the tank circuit. Thus, the inductor 1174 can be viewed as having a transformer action with respect to generating a voltage for the bulb, but also as having an inductance value for purposes of determining the resonance of the tank circuit.

The inductor value 1174a should be selected (along with the capacitor value of capacitor 1175) so that the resonant frequency of the tank circuit is less than the frequency of the incoming alternating voltage at nodes 1151 and 1153. Further, the value of the inductance of the entire inductor should be such that the inductor operates in a non-saturated or a limited saturated mode of operation. This can be accomplished by use of an inductor using certain materials, core size, and gapping to produce the appropriate inductance value as previously disclosed. Specifically, the presence of a 60 Hz rectified sinusoidal component in the input voltage at nodes 1151 and 1153 should result in no or limited saturation of the inductor. Avoiding saturation of the inductor requires using a typically larger inductor in the tank circuit than is found in the tank circuits of the prior art.

In this embodiment, capacitor 1172 in conjunction with capacitor 1175 determines the total capacitance of the tank circuit, and therefore determines the resonance frequency of the tank circuit (obviously, the inductance value of the inductor also plays a part in determining the resonance frequency). However, the capacitance of the tank resonant circuit is largely determined by the capacitor 1175 as it is smaller in value. Capacitor 1172 also acts as a DC blocking capacitor and removes any DC component in the input square wave provided to the tank circuit by ballast portion 1101. This capacitor ensures a symmetrical (balanced) current is provided to the lamp. Thus, capacitor 1172 electrically isolates the inductor and the bulb from the DC component in the input voltage waveform. Further, capacitor 1172 also limits the current that would otherwise saturate the inductor from the rectified power line frequency (e.g., 120 Hz) present on the input voltage waveform.

Capacitor 1175 is also part of the resonant circuit and is present between node 1193 and node 1153. Capacitor's 1175 main purpose is to act as a resonant capacitor for the inductor in the resonant circuit. In this embodiment, the tank circuit can be viewed as having an LC resonant circuit within it, with a portion of the tapped inductor (e.g., the right side) that is outside the resonant circuit, but still part of the tank circuit. Capacitor 1175 also adjusts for any voltage imbalance in the lamp.

In one embodiment of the invention corresponding to FIG. 15, the values of the components are as follows: left-side portion of the inductor 1174a has an inductance of 1.1 mH, the right side portion of the inductor 1174b is about 0.9 mH (providing a total of 2 mH), capacitor is 12372 is 12 nF, and capacitor 1172 is 0.047 μF or less.

When the tank circuit resonates, the voltage across nodes 1191 and 1153 increases and is presented to the ends of the lamp 1188. Although these nodes are attached to the filaments, the presence of the filaments is insignificant to the analysis of the circuit, because they are connected together. The voltage across the lamp is based on the whole of inductor 1174, not just a portion of it. In other words, even though inductor portion 1174a is in the resonating portion of the tank circuit (and inductor portion 1174b is not), the voltage generated and presented to the lamp is based on both inductor portions 1174a, 1174b. Thus, the voltage is “boosted” by the second set of windings (and hence, these windings may be referred to as “boost windings” or as a “tertiary winding”). The presence of the additional inductor portion 1174b results in a higher voltage to the lamp than what is generated at the tap (which is node 1193). Thus, the right side portion of the inductor 1174b creates an added voltage to the voltage produced at node 1193. This added voltage is designed so that it is sufficient to initiate ionization. The peak voltage at node 1193 (which is the inductor tap) is less (by approximately by 25%-33%, which is the ratio of the windings for 1174b) than the peak voltage at node 1191 during the ramp-up leading to ionization. The voltage generated by the tank circuit and supplied to the bulb results the energy in the inductor being ‘pushed’ into the lamp. Further, the transformer action of the tapped inductor reduces the peak current through the bulb caused by the low frequency voltage (e.g., 120 Hz) compared to other embodiments previously described (e.g., non-CCFL mode of operation).

Once ionization occurs, the voltage across the lamp is reduced. Recall that the nature of an ionized lamp is that it clamps or limits an applied voltage. Thus, once ionized, the voltage across the lamp will not exceed a certain value (depending on the lamp and other factors) and this clamps the voltage at node 1191 to typically around 100 volts for a CCFL. During ionization, the peak voltage at node 1193 (which is the inductor tap) is less (by approximately by 25%-33%, which is the ratio of the windings for 1174b) than the peak voltage at node 1191.

When the bulb ionizes, the bulb forces a reduction in voltage that causes a current surge from the tube. Because the inductor portion 1174b is in series with the current passing through the lamp, the inductor portion 1174b serves to limit the rate of change of current flowing through the lamp. There is a leakage inductance associated with the inductor 1174b, that limits the current. The leakage inductance could be modeled as a separate inductor in series with the inductor, and which is represented as being part of inductor 1174b in FIG. 15. Inductor portion 1174b therefore limits rapid changes of current through the lamp at the time ionization, and this contributes to the longevity of the lamp.

Unlike prior art systems, capacitor 1175 does not discharge as much energy through the lamp at high voltage. The peak voltage across the capacitor at node 1193 is lower than the peak voltage at node 1191, which is the voltage across the lamp. Thus, the capacitor typically discharges 30-60% less energy than prior art ballasts having a capacitor across the lamp. Thus, the voltage across capacitor 1175 peaks typically around 67-70 volts for 120 VAC operating, and is typically less than the 80-100 volts at node 1191, which is the voltage after ionization of the lamp.

Although the bulb is ionized each half cycle of the line power input frequency, the presence of the inductor portion 1174b and capacitor 1175 aid in the longevity of the bulb. First, the inductor portion 1174b ‘cushions’ the current generated by the bulb during ionization by limiting the rate of change (di/dt) of the current, and second, the two-part inductor results in a lower voltage at node 1193, which is the voltage across capacitor 1175. When capacitor 1175 discharges, it does so at a lower voltage and energy level compared to the prior art. In other words, the presence of the boost windings of 1174b increase the voltage to the bulb, and requires less current in the tank to reach the ionization voltage. Hence, capacitor 1175 is smaller, and is required to discharge less energy by the bulb during initial ionization. This may allow use of smaller and less expensive capacitors.

The tank circuit of FIG. 15 provides other benefits. First, there are typically fewer parts in the tank circuit compared to the prior art. In FIG. 15, only two capacitors and a tapped inductor are used in addition to the bulb. Because filaments are not used to facilitate ionization, the possibility of broken or degraded filaments hampering starting is not a factor and the ballast can be adapted to operate with bulbs either having filaments or not. Further, because there are no filaments to heat, which takes a few milliseconds or more, ionization occurs faster at initial startup. Specifically, as soon as the voltage across node 1191 exceeds the ionization level, the bulb ionizes. Typically, this occurs twice as fast than if filaments are heated. Also, the average voltage across capacitor 1175 is not as great as the average voltage across the lamp during operation (and is in fact, about 30% less due to the voltage contributed by the transformer action of the tapped inductor). Because the voltage on the capacitor when the lamp ionizes is less than the voltage across lamp, there is less charge to be dissipated out of the capacitor into the lamp. This contributes to the longevity of the bulb. Further, the leakage inductance present in the tapped inductor limits the peak current from the discharge of the capacitor 1175 in the tube during ionization at each half-cycle which also thought to aid in the longevity of the bulb.

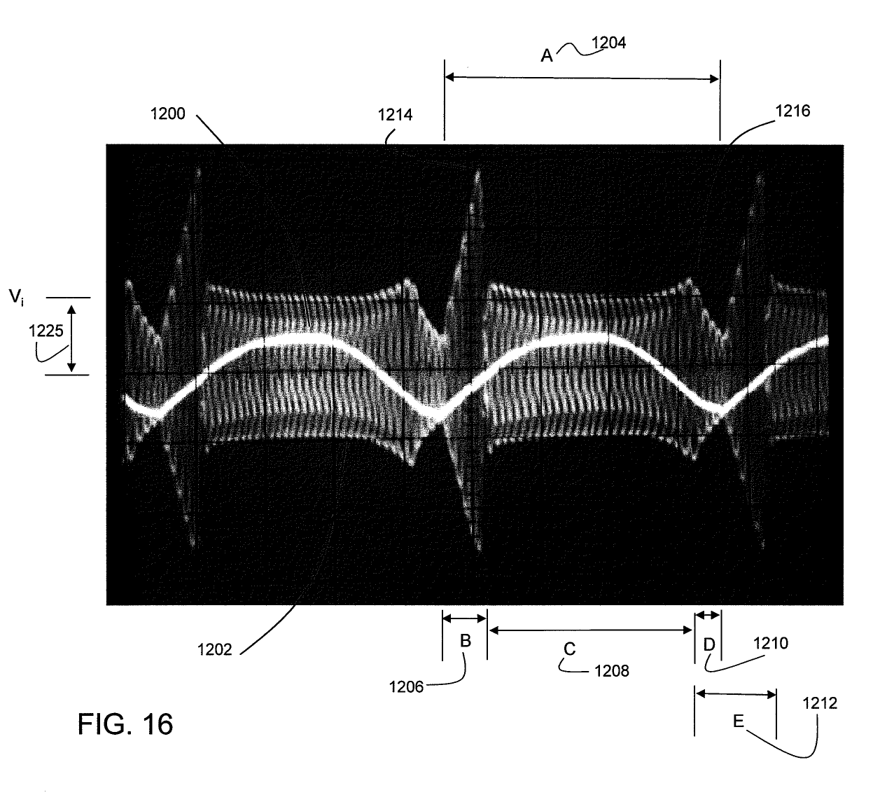

In this embodiment, the lamp is re-ionized every 1/120 of a second, which is every half cycle of the input power frequency (at 60 Hz). The voltage waveform across the lamp is illustrated in FIG. 16. In FIG. 16, the rectified AC voltage 1200 is illustrated as a rectified sine wave having a peak of around 160 volts and a period of 1/120 of the line input frequency. The 1/120 time period represents a half cycle, which is twice the line frequency of the input voltage. This pattern is repeated every half cycle of the input voltage frequency and one example of the half cycle is shown as Time Period A 1204. Further, Time Period A 1204 is also illustrates another instance of the repeating high frequency voltage waveform 1202 across the ends of the bulb.

The time leading up to ionization is illustrated as Time Period B 1206. In the tank circuit embodiment of FIG. 15, the time period leading up to ionization occurs faster than in non-CCFL configurations because of the presence of the inductor boost windings which provide an additional voltage boost. Thus, the corresponding time period for ionizing the CCFL bulb is less as the voltage in the tank circuit as shown in FIG. 16 during Time Period B builds up rapidly. The curved envelope of the high frequency voltage buildup during Time Period B reflects the sine wave voltage 1200 during the same time.

Once the voltage at the bulb reaches an ionization level 1214, the bulb ionizes, and clamps the voltage to a lower level (typically around 100 volts), shown as the ionization voltage V₁ 1225. The time period of ionization is illustrated as Time Period C 1208. During this time, light is being generated by the lamp.

Eventually, the AC voltage continues to drop and tank circuit is no longer able to sustain ionization, and Time Period D 1210 is entered. This time period reflects that ionization of the bulb is no longer maintained, and the tank voltage begins to drop.

The transformer action of tapped inductor 1174 provides a brief current flow to the tank circuit at the end of ionization, thereby extending the time which the bulb is ionized. Consequently, with both the ionization Time Period B 1206 and the discharge Time Period D 1210 shortened relative to non-CCFL embodiments, the time period of ionization (Time Period C 1208) is longer. Because the ionization period is longer, the CCFL embodiment generates light longer than without the tapped inductor.

Further, during Time Period D, the residual energy in the tank diminishes, but does not completely dissipate before the next half cycle begins. Thus, the lamp voltage typically does not reach zero volts during the ‘non-ionization time’ (Time Period E 1212). The non-ionization time is the time which the bulb is not ionized, and comprises Time Period B and Time Period D. Although the bulb may not be ionized, that does not necessarily mean that light is not being generated from the bulb. A typical fluorescent bulb comprises a phosphorous coating which persists in generating light. Thus, it is not obvious from FIG. 16 if, or when, light is no longer being generated by the bulb during the period of non-ionization.

Although the tank circuit 1150 can be used with other ballast designs, using the tank circuit with the ballast portion 1101 results in a highly efficient ballast, having a high power factor with long bulb life. The presence of the bypass capacitor 1102 (which is selected to be suitable with the load of the lamp) aids in achieving a high power factor, and the presence of resistor 1103 (around 3-5 ohms) reduces noise when the ballast is operated with prior art dimmer circuits and which may be necessary to function with prior art dimmers. The operation of the ballast can be combined with the dimmer circuit as disclosed in U.S. patent application Ser. No. 12/353,551, filed on Jan. 14, 2009, entitled Method and Apparatus for Dimming Light Sources, the content of which is incorporated herein by reference. When the dimmer circuitry is combined with the ballast 1101 and tank circuit 1150, the combination provides a highly efficient, high power factor, long lasting lighting system that is also dimmable.

The dimmer acts to limit the incoming power to the ballast by modifying each half cycle of power to the ballast. The dimmer circuit can be viewed as “slicing off” or controlling the phase angle of the input power for a portion of the input power half cycle as shown in FIG. 7a. During the portion of the input power cycle when power is applied (e.g., the portion that is not sliced, e.g., portion 474 in FIG. 7a), the bulb is ionized for that portion of the cycle and then ends ionization at the end of the half-cycle. Thus, the effect of dimming increases the non-ionization time.

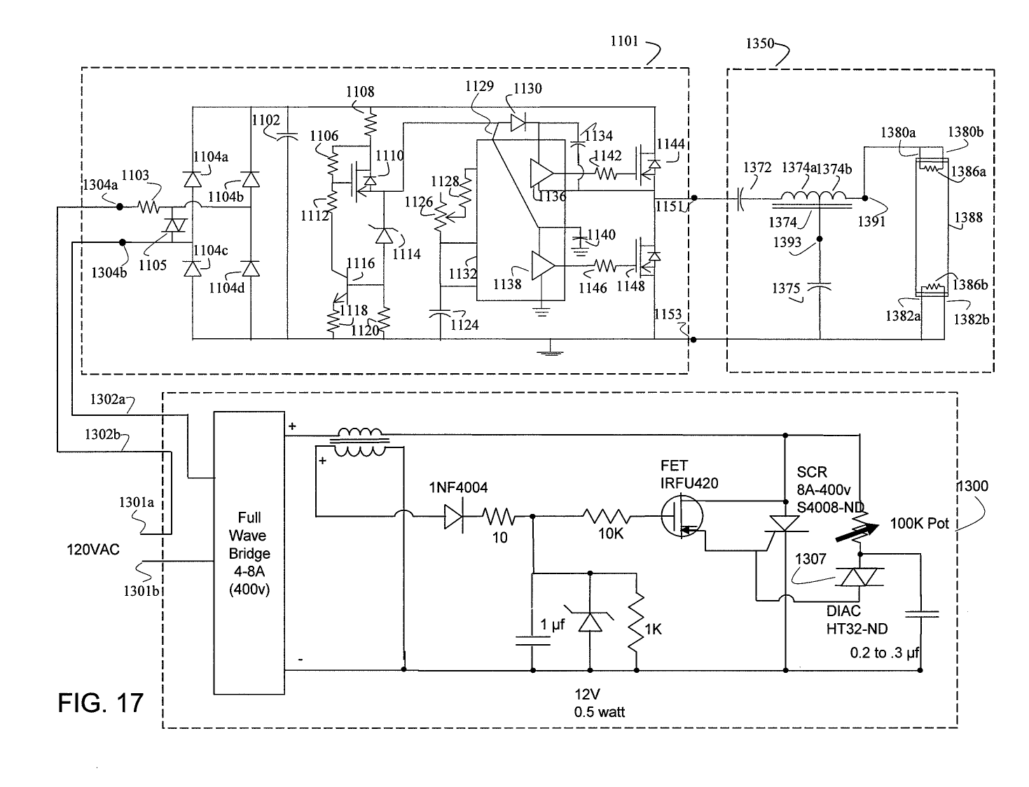

The circuit diagram of the ballast 1105 connected to a dimmer is shown in FIG. 17. In FIG. 17, the dimmer circuit 1300 receives 120 VAC from a household power at inputs 1301a, 1302b. The remainder of the circuit 1300 operates as discussed in the aforementioned patent application. The outputs 1302a and 1302b from the dimmer circuit are the modified power voltage which is provided to the inputs of the ballast circuit at nodes 1304a and 1304b. Thus, the ballast is configured to receive the voltage waveform from the dimmer as illustrated in FIG. 7a, subject to the dimmer being set appropriately.

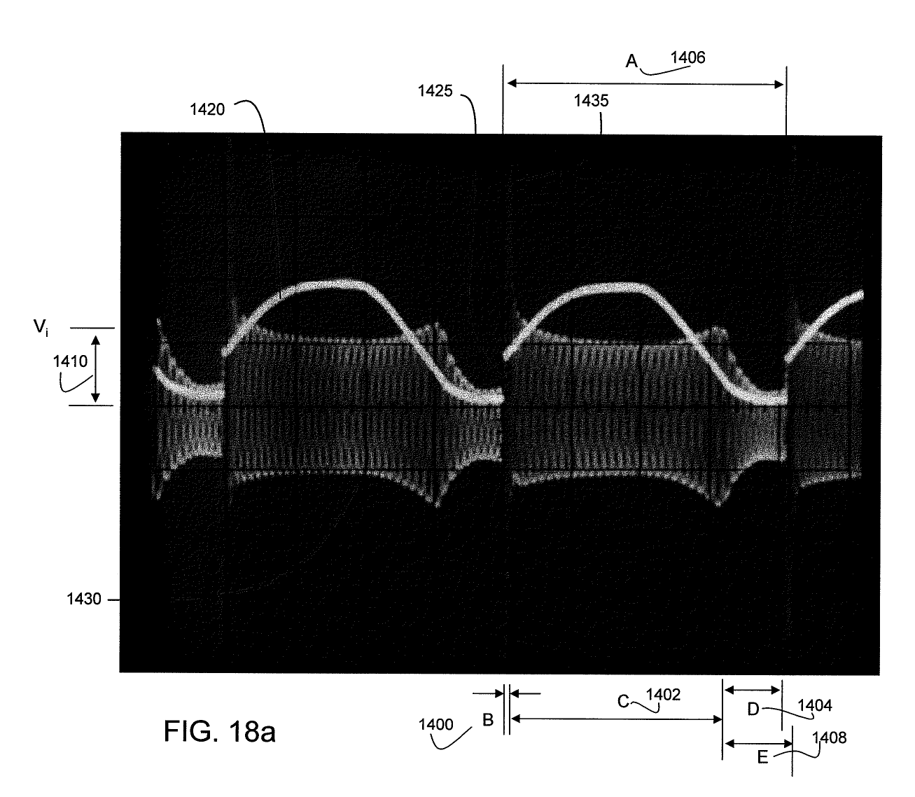

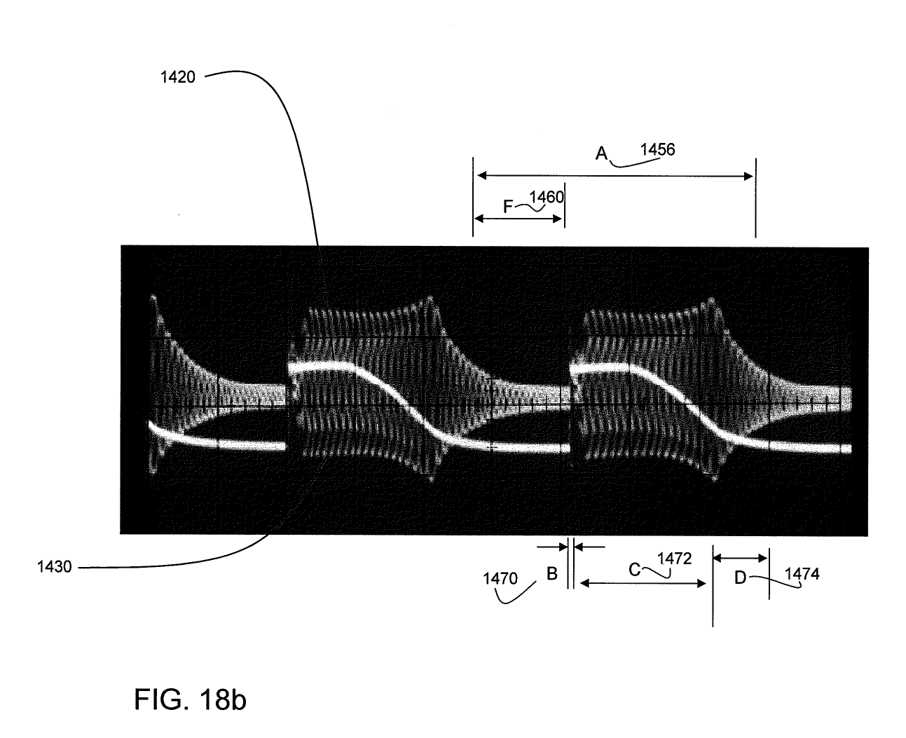

The impact of dimming on the voltage across the lamp is illustrated in FIGS. 18a-b. In FIG. 18a, the voltage waveform is shown when a dimmer is present, but no dimming is performed—e.g., the dimmer provides as much of the incoming AC voltage power to the ballast as possible. The AC rectified voltage 1420 is present and has a period corresponding to Time Period A 1406. However, the AC rectified voltage exhibits a slight ‘step function’ change 1425 at the beginning of each half cycle. This step function is because the dimmer circuit requires a certain minimum input line voltage (about 35 volts) before the diac 1307 of FIG. 17 triggers and allows the incoming AC voltage to the ballast. Thus, the ballast during Time Period B 1400 receives a near instantaneous increase in the input power. This ‘jolt’ of input voltage is amplified by the tank circuit and causes the tank circuit to generate an immediate voltage spike 1435 across the lamp. Thus, Time Period B 1400 which is the time period for tank circuit to build up voltage for ionization is relatively very short. The lamp then ionizes (which is shown as Time Period C 1402), followed by Time Period D 1404, where the lamp is not ionized.

When the dimmer is activated, it blocks a beginning portion of each AC input voltage half cycle from being passed to the ballast. The length of this portion is based on the setting of the dimmer. The effect of this is shown in FIG. 18b. In FIG. 18b the input rectified AC voltage 1420 is shown, and it still has a period of 1/120 of a second. However, the beginning of the input AC voltage is zero for the beginning portion based on the dimmer setting. Thus, in FIG. 18b, the beginning of the cycle corresponds to the beginning of Time Period A 1456. The portion in which the dimmer clamps the input voltage is shown as Time Period F 1460, which is about 33% of the total Time Period A 1456.

Once the dimmer allows the input voltage to pass to the ballast, the voltage is significantly above zero volts, and the result is that the tank circuit generates a very high and short spike during Time Period B 1470, which causes the lamp to ionize. During Timer Period C, the lamp is ionized until the input AC voltage drops in value, and Time Period D 1474 is entered. The end of Time Period D represents the end of the input voltage period. The time periods overlaid on the voltage waveforms are not to scale, and hence the end of Time Period D is approximately indicated. During this time period, the tank circuit is still resonating, and not all of the energy has dissipated, hence there is some voltage across the tube during Time Period F 1460 even though no light is being generated.

In prior art ballasts, the presence of non-ionization time is problematic because prior art ballasts are designed to continuously ionize the bulb. Prior art ballasts typically ionize a bulb once (when it is started) and are not designed to re-ionize the bulb at each half cycle. Thus, many prior art ballasts are not dimmable. Recall that prior art ballasts may incorporate a filament to facilitate initial starting and may maintain power to the filament during normal operation. When the bulb has been running, it is easier to restart a bulb after ionization is interrupted, because the gases in the bulb have been already heated. Thus, in the prior art, if the ballast is running, a certain amount of non-ionization time can be tolerated if the ballast is operated with a dimmer because the temperatures of the lamp have risen during operation and the bulb can be easily re-ionized. However, if the non-ionization time is too long, the bulb becomes difficult to re-ionize and flickering of the bulb occurs, or, at worst, the lamp goes out. In some prior art ballasts, when the bulb is dimmed, the ballast also reduces the current flowing in the filament. This requires a higher ionization voltage in the lamp, which the ballast may not be able readily provide. Thus, many prior art ballasts are not dimmable, or have a narrow dimming range and quickly begin to flicker when dimmed. In some cases ionization stops completely and the lamp goes out. Even if the prior art ballast is configured to quickly re-ionize the bulb, the presence of the current surge created by the bulb during ionization, along with a capacitor discharging at a high voltage level, contributes to shortening the life of the bulb. Hence, many conventional ballasts are not designed to be dimmed, or if they are, the reliability of the bulb can be adversely impacted by dimming.

In contrast, the present invention does not have these adverse impacts because the ballast is designed to re-ionize the bulb every half cycle during normal operation. Thus, the voltage waveform in FIG. 18b, which illustrates the impact of dimming, only alters the operation by increasing the non-ionization time. Because the ballast in the present invention is designed to re-ionize the bulb after the non-ionization time of each half cycle, merely increasing the non-ionization time neither impacts its fundamental operation nor contributes to shortening the life of the bulb.

Further, use of the aforementioned dimmer circuit in FIG. 17 avoids any “ringing” current which can also cause the bulb to flicker. In addition, application of the filter resistor 1003 in the ballast contributes to reducing noise, flicker, and other adverse effects due in part to the ringing current which prior art dimmers may not mitigate. Thus, the present invention allows effective dimming of a CCFL over a wide range with minimal flickering.

The tank circuit of FIG. 15 can be combined with other energy savings circuitry, such as disclosed in U.S. patent application Ser. No. 12/366,886, filed on Feb. 6, 2009, entitled “Energy Saving Circuitry For A Lighting Ballast,” the contents of which are incorporated herein by reference. Specifically, a detection circuit can added to the tank circuit to detect when the tank circuit is operating as well as detecting whether the bulb has been removed. Detection of the steady state operation can be used to then activate a more efficient power source in the ballast portion 1101 which then supplies power to the integrated driver circuit 1132, while at the same time the voltage regulator in the ballast portion 1101 is deactivated. Essentially, a more efficient power source is substituted to power the integrated driver circuit.

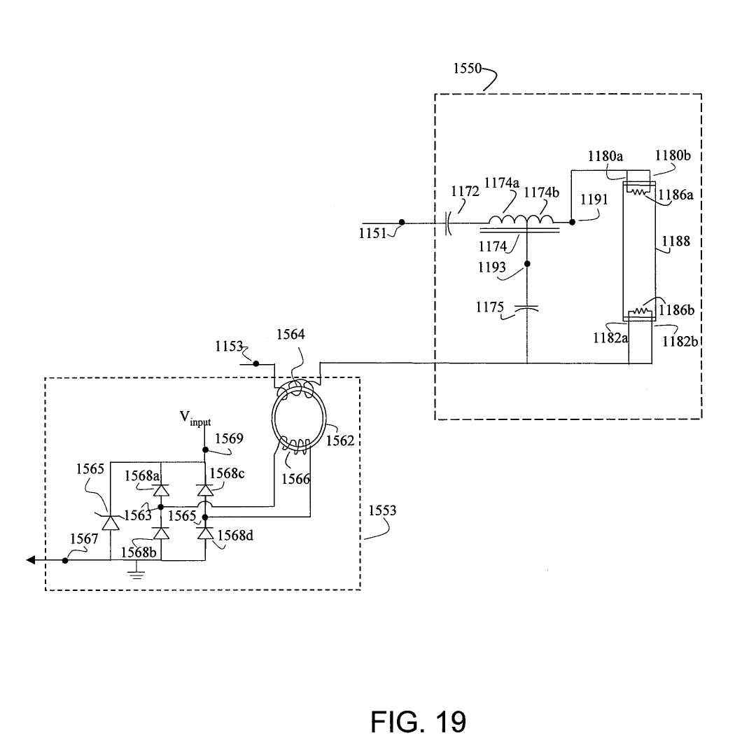

One embodiment described in the aforementioned patent application (application Ser. No. 12/366,886) that can be adapted to FIG. 15 involves using a current transformer detecting current in the tank circuit and is shown in FIG. 19. The current detection circuit 1553 comprising a transformer 1562 which detects a current in the tank circuit by a primary winding 1564. The transformer generates an output current via a secondary winding 1566, which in turn is provided to nodes 1563 and 1565 of a full wave bridge circuit comprising diodes 1568a-d to produce an output signal 1567. Protection diode 1565 across the full wave bridge is optional. The output signal is then used to both deactivate the voltage regulator in the ballast portion 1101 as well as act as a more efficient, alternate source of power to the integrated circuit. Details of the use and description of operation are found in the aforementioned application. However, because current will flow in the resonant circuit (e.g., specifically, current passes through node 1153 or 1193 in FIG. 15) regardless of whether a tube is installed or not, the detection circuit is unable to detect when a bulb is present. Specifically, current can flow in the tank circuit if no tube is present. This type of detecting arrangement may be suitable for a ballast having an integrated (e.g., non-removable) lamp, because the ballast is always operated with the lamp and always has the lamp present to clamp excess voltages in the tank circuit.

However, application of the current detection circuit to the tank circuit of FIG. 15 involving linear, tubular lamps that are removable, detects current even if the ballast is operated without the lamp. This can readily occur if the lamp is being replaced while the ballast is operating. In this scenario, the tank circuit voltage is not limited by the lamp. Recall that a normally functioning lamp limits the voltage across its ends by ionizing the gas therein, but if there is no lamp, the voltage is not limited and potentially unsafe voltages may develop.

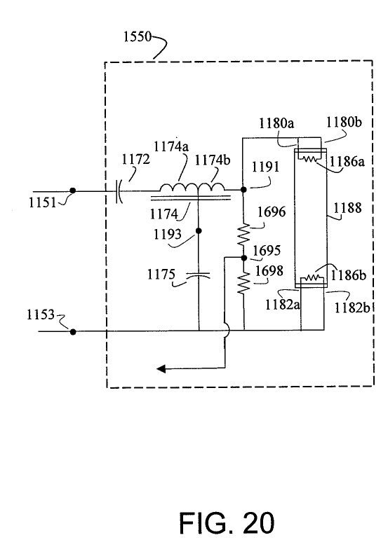

One approach to detecting the removal a bulb is shown in FIG. 20. In FIG. 20, a voltage ladder is created by placement of resistors 1696 and 1698 in series across node 1191 and 1153. Typically, resistor 1696 typically has a very high resistance (1 MΩ-10 MΩ). This high value ensures little current flow when the ballast is operating (and hence very little energy is wasted). Resistor 1698 has a lower value, (1K-100KΩ) and produces a voltage at node 1695 when current is flowing. The voltage produced at node 1695 is indicative of whether the lamp is present or not. During normal, steady state operation, the voltage at node 1695 is determined by the voltage at 1191. When the bulb is removed, the voltage at node 1191 is not clamped by the bulb, and increases in value. This causes the voltage at node 1695 to correspondingly increase. Thus, the voltage at node 1395 indicates the removal or absence of the bulb.

The voltage at node 1695 can be also considered a signal voltage provided as input to the driver integrated circuit, as disclosed in the aforementioned patent application. This is used to set the switching frequency of the ballast. Thus, a change in the signal voltage can alter the switching frequency and lower the voltages produced in the tank circuit, creating a safer condition.

Further, the same voltage at node 1695 in FIG. 20 can be used to detect an end-of-life condition in the bulb. All gas discharge bulbs have a limited life, as the gas contained therein degrades, leaks out, or otherwise fails to perform as well when new. As the lamp ages, the voltage required to both initiate ionization and maintain ionization slowly increases over time. Thus, as the bulb ages, the voltage at node 1691 increases reflecting the higher voltage required. As the voltage at node 1691 increase, so does the voltage at node 1695. Thus, the voltage at node 1695 provides an indication of the lamp condition. This value can be measured, used to control the ballast, or otherwise provide information regarding the operation of the ballast and tube.

### Automated System Operation

FIGS. 21 and 22 are flow diagrams of one embodiment of a process according to the present invention that can be carried out by the system 100 including the controller 112. In this example, the system includes the components shown in FIGS. 1 and 2.

FIG. 21 shows the manner in which the controller 112 in one embodiment of the invention receives and responds to input signals from occupancy sensors 120. At block 281, the controller 112 receives program data comprising settings indicating how the controller should respond to various occupancy sensor data, and stores such data in storage database or table 229 under control of the lighting control program module (LCPM) 213. This program data is entered by way of a user input device such as the remote client computer or terminal 236. This program data stored in table 229 indicates whether the electric power supply 116 to each dimming unit should be enabled or disabled in response to occupancy sensor data, depending on the location of the sensors and the light fixtures they control.

At block 282, LCPM 213 receives into the RAM memory 244 current occupancy sensor data representing the state of occupancy in the room 102 as measured by the occupancy sensor 120. The LCPM stores this occupancy data in the data table 227. If, at block 283, the LCPM determines that the occupancy data is from a sensor in a safety zone, or if, at block 284, the occupancy sensor data indicates the presence of occupancy in the room, the process goes to block 289, where the LCPM instructs the electric power supply 116 to initiate or continue power to the dimming units associated with the occupancy sensor providing the data. The associations between sensors and dimming units and the lighting fixtures they control are stored in data table 226. If the occupancy sensor data neither is from a safety zone nor indicates occupancy, then at block 285 the LCPM notes the time of the receipt of the sensor data, as indicated by a clock (not shown) in the controller 112, and computes the time elapsed since the sensor data last changed from indicating occupancy to indicating no occupancy. The LCPM then compares that computed elapsed time of no occupancy to program data retrieved from the table 229 which contains a user setting of the continuous time of no occupancy after which the light fixtures associated with the occupancy sensor 120 should be turned off. If such setting is exceeded (or in the alternative, equaled), the power to the dimming unit 114 is disabled. The process returns to block 282 for receipt of new occupancy data from the same or a different occupancy sensor 120. The power to the dimming unit 144 remains disabled until the occupancy sensor for the area served by that dimming unit again senses occupancy. The instructions sent to the power supply 116 at blocks 288 or 289 are stored in one of the status data tables 228 with the time the instruction was sent.

FIG. 22 shows the manner in which the controller 112 in one embodiment of the invention receives and responds to input signals from photo sensors 110. At block 291, similar to the initial processing of occupancy data described above, the controller 112 receives program data comprising settings indicating how the controller should respond to various photo sensor data, and stores such data in table 229 under control of the lighting control program module (LCPM) 213. This program data is also entered by way of a user input device such as the remote client computer or terminal 236. This program data stored in table 229 indicates at what illumination level each light fixture 108 or 109 or commonly controlled groups of fixtures should be set by the associated dimming unit, is response to data received from associated photo sensors 110.

At block 292, LCPM 213 receives into the RAM memory 244 current photo sensor data representing the state of occupancy in the room 102 as measured by the photo sensor 110. The LCPM stores this occupancy data in the data table 227. If, at block 293, the LCPM determines that power is presently enabled by the power supply 116 to the relevant dimming circuit 114, the LCPM compares at block 294 the photo sensor data to program data retrieved from the table 229 which contains a user setting of the desired level of illumination of the light fixtures given current conditions including the photo sensor reading and optionally other factors, such as the time of day, the track of shadows from neighboring structures, the position of the fixture relative to windows or skylights, and the like.

If, at block 295, the illumination level is not within a preselected margin of variance from the setting, at block 296 the LCPM sends an instruction signal to the dimming unit to alter the dimming level of the light fixtures to meet the settings. At block 298, the dimming unit 114 adjusts the power supplied to the light fixture or fixtures in accordance with the instruction signal. The process then returns to block 292 to receive additional sensor data. The instructions sent to the dimming unit 114 at block 298 are stored in one of the status data tables 228 with the time the instruction was sent.

The processor 221 under control of the LCPM 213 receives data from many occupancy and photo sensors at regular intervals. Each signal received from a sensor identifies the sensor that is the source of the data communicated by the signal. As necessary, the processor buffers and processes the received discrete data in a well known manner. In the above manner, the illumination level may be adjusted according to the measured illumination level in the area 106 of the room 102 monitored by the photo sensor 110. Or, in the case of no occupancy for a predetermined duration of time determined from occupancy sensor data, illumination may be turned off in the room.

In the case of time cycling or time proportioning as described above, according to which illumination of an area is varied in response to sensor input by turning on or off one or more light sources, rather than dimming all the light sources, a process similar to that shown in FIG. 21 will apply, depending on whether gradual dimming to power off or reverse dimming to full power on is utilized. In the embodiment in which the dimming units are not used, at block 282, data is received from any relevant sensor (photosensor, occupancy sensor, timer, etc.) monitoring a parameter upon which the controller will produce control signals to operate the power switches 118 to one or more light fixtures 108, 109. At block 286, the LCPM 213 compares the sensor data to program data retrieved from the table 229 which contains a user setting of a desired conditions in the area being monitored. If, at block 287, the measured conditions do not fall within a predetermined tolerance of the desired conditions, the process goes to one of block 288 or block 289 where the LCPM generates and sends instruction signals having content appropriate to change the state of various individual power switches 118 to provide or remove power to respective ballast circuits associated with respective light fixtures. For example, the LCPM may configure the states of the power switches to turn respective members of a group of light fixtures on or off in a particular spatial pattern with respect to the area, in order to reduce or increase its illumination by the group of light sources. Furthermore, the controller may be configured to rotate over time which of the group of fixtures is switched on or off to create desired patterns, so as to even out the effect of repeated cycling on and off on the fixtures of the group.

In the embodiment in which dimming units are used to gradually move to off or full on, steps (not shown in the drawing) are added after block 287 according to which the LCPM 213 generates and sends appropriate control signals to instruct the respective dimming units to gradually lower or raise the illumination level of the respective fixtures until approaching a no noticeable illumination or full illumination state. This can occur over several seconds to several minutes. As well known in the art, the control signals can be generated to provide discrete steps between illumination levels or a continuous variation between levels. In the case of gradual dimming to no noticeable illumination, the LCPM then instructs the respective power switches to disable power to the respective dimming units and fixtures.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

1. A system for automatically adjusting a light source in response to changes in ambient illumination level, comprising
at least one photosensor positioned to receive illumination from an area;
a controller coupled to receive an illumination level signal from the photosensor and configured to generate a control signal varying with the illumination level;
a ballast circuit configured to be coupled to enable receipt of a time-varying DC voltage at a first node with respect to a second node, said DC voltage varying at twice a line frequency, and said DC voltage being rectified from an AC voltage power source alternating at said line frequency, wherein the ballast circuit is configured to present the DC voltage varying at twice the line frequency across said first terminal and said second terminal of a bypass capacitor, wherein the ballast circuit is further configured to allow said DC voltage to drop to 15% or less of a peak value of said DC voltage every half cycle of the line frequency, said ballast circuit comprising:
a first switch coupled to the first node operable to selectively couple the first node to a resonant circuit, the resonant circuit having a resonant frequency less than a first frequency and configured to be coupled to a light source, wherein the resonant circuit stores energy during a first portion of a cycle of the first frequency, and a second switch operable to selectively couple the resonant circuit to the second node during a second portion of the cycle of the first frequency;
said first and second switches configured to be coupled to provide an operating voltage to a light source positioned to provide illumination to the area; and
a dimming circuit coupled to the controller and to the ballast circuit, the dimming circuit configured to receive and modify an AC line voltage based on the control signal to produce the time-varying DC voltage.

2. The system of claim 1, further comprising a switching circuit coupled to selectively switch the AC line voltage to the dimming circuit.

3. The system of claim 1, wherein the dimming circuit includes a digitally controlled potentiometer coupled to receive the control signal.

4. The system of claim 1, where the dimming circuit includes an opto-isolator including a photo-sensitive resistor coupled to receive the control signal.

5. The system of claim 1, wherein the dimming circuit comprises:
a solid state switch configured to selectively couple a third node to a fourth node, wherein the third node receives a line voltage at a line frequency;
a biasing circuit coupled with the controller and configured to actuate the solid state switch after a delay after the beginning of a half-cycle of the line frequency, the delay based on the control signal received from the controller; and
a charge circuit coupled to said third node, said fourth node, and to a gate of the solid state switch, said charge circuit configured to maintain activation of the solid state switch for a period of time beginning with said actuating of the solid state switch and ending prior to ending of the half-cycle.

6. The system of claim 1 wherein the bypass capacitor is of a value so that the DC voltage drops to less than 18 volts every half cycle of the line frequency.

7. The system of claim 1 wherein the bypass capacitor is fully discharged every half cycle of the line frequency.

8. The system of claim 1, wherein the resonant circuit comprises:
a first capacitor having a first terminal coupled to the first and second switches;
an inductor having a first terminal coupled to a second terminal of the first capacitor wherein said inductor is of a value to allow an DC current at the line frequency and a second current at the first frequency to simultaneously flow through said inductor but not saturate said inductor;
a second capacitor having a first terminal coupled to the second terminal of the inductor, the second terminal of the capacitor coupled to the second node; and
a third capacitor having a first terminal and a second terminal, said first terminal and said second terminal configured to be coupled to a first and second filament of the light source.

9. The system of claim 8 wherein a value of the bypass capacitor is of a value to allow current flow through the light source to cease each half cycle at the line frequency.

10. The system of claim 8, wherein the resonant circuit configured to be coupled to said light source is coupled to said light source, wherein the inductor and the first capacitor are operable to simultaneously limit the flow of the DC current at the line frequency and the second current provided to the light source.

11. A ballast circuit of claim 6, wherein the capacitor comprises a polypropylene capacitor having a capacitance value in the range of 25-100 nanofarads per watt of power of the light source to be coupled to the resonant circuit when the household power is 120 v.

12. The ballast circuit of claim 1 wherein the AC voltage from said power source is processed by the dimmer circuit, and further comprising:
a voltage regulator circuit configured to provide a regulated DC input voltage to a driver circuit for actuating said first switch and said second switch, wherein said voltage regulator circuit is configured to provide the regulated DC input voltage to the driver circuit.

13. A method of automatically adjusting a light source in response to changes in ambient illumination level, comprising:
measuring the illumination level in an area;
providing an AC line voltage at a line frequency to a dimming circuit;
modifying the line voltage with the dimming circuit in response to the measured level of illumination in the area;
utilizing the modified line voltage to charge energy in a non-electrolytic bypass capacitor such that the bypass capacitor is discharged every half cycle at the line frequency, the bypass capacitor coupled to a first node and a second node;
storing energy in the bypass capacitor to subsequently produce a high frequency current from the bypass capacitor;
selectively coupling the bypass capacitor to a resonant circuit via the first node for a first time period, wherein coupling the resonant circuit to the first node results in an operating voltage at a light source, wherein said operating voltage at the light source is the result of at least the combination of a first current from an output of the dimming circuit at the line frequency and the high frequency current from the bypass capacitor; and
selectively coupling the resonant circuit to the second node for a second time period, wherein coupling the second node generates a negative voltage in the resonant circuit at the light source and allows energy from the dimming circuit to be stored in the bypass capacitor.

14. The method of claim 13, wherein the step of selectively coupling the bypass capacitor to a resonant circuit via the first node comprises coupling the resonant circuit to a first terminal of a rectifier wherein said rectifier produces a DC voltage having a rectified sine wave shape at twice the line frequency.

15. The method of claim 14, wherein when an AC voltage at the input of the rectifier crosses a zero voltage point, said voltage at the light source is insufficient to ionize the bulb.

16. The method of claim 13, wherein the step of modifying the line voltage with the dimming circuit in response to the measured level of illumination in the area comprises gradually modifying the line voltage so as to reduce illumination output of the light source; and then terminating provision of the AC line voltage to the dimming circuit.

17. A system for automatically adjusting a light source in response to a control signal, comprising
a controller configured to generate a control signal based on a parameter associated with an area a light source is positioned to illuminate;
a ballast circuit configured to be coupled to receive a time-varying DC voltage at a first node with respect to a second node, said DC voltage varying at twice a line frequency, and said DC voltage being rectified from an AC voltage power source alternating at said line frequency, wherein the ballast circuit is configured to present the DC voltage varying at twice the line frequency across said first terminal and said second terminal of said bypass capacitor, wherein the ballast circuit is further configured to allow said DC voltage to drop to 15% or less of a peak value of said DC voltage every half cycle of the line frequency, and said ballast circuit comprising:
a first switch coupled to the first node operable to selectively couple the first node to a resonant circuit, the resonant circuit having a resonant frequency and configured to be coupled to a light source, wherein the resonant circuit stores energy during a first portion of a cycle of the first frequency, and a second switch operable to selectively couple the resonant circuit to the second node, the second switch allowing all or some of the energy stored in the resonant circuit to be recirculated into the resonant circuit during a second portion of the cycle of the first frequency;
said first and second switches being configured to be coupled to provide an operating voltage to the light source positioned to provide illumination to the area; and
a dimming circuit coupled to the controller and to the ballast circuit, the dimming circuit configured to receive and modify an AC line voltage based on the control signal to produce the time-varying DC voltage.

18. The system of claim 17, further comprising a sensor positioned to monitor the parameter in the area as the parameter changes over time.

19. The system of claim 17, wherein the parameter is selected from the group consisting of: illumination level in the area; occupancy of the area; time of day in the area.

20. The system of claim 17, wherein the parameter is a first parameter and wherein the controller is configured to generate a control signal based on the first parameter and on a second parameter associated with the area.

21. The system of claim 20, further comprising a second sensor positioned to monitor the second parameter.

22. A method of automatically controlling a gas-discharge lamp in response to a control signal, comprising:
generating a control signal based on a parameter associated with an area the lamp is illuminating;
providing an AC line voltage at a line frequency;
rectifying the AC line voltage and modifying the rectified AC voltage at the line frequency in response to the control signal;
selectively switching at a switching frequency by a first solid state switch the modified rectified AC voltage at the line frequency thereby providing a plurality of switched DC voltages to a resonant circuit;
producing a plurality of alternating lamp voltages by said resonant circuit to said lamp wherein:
a first portion of said plurality of alternating lamp voltages increase in magnitude of voltage for a first time period during which said lamp is not ionized,
a second portion of said plurality of alternating lamp voltages remain at a steady state ionization voltage for a second time period due to ionization occurring in said lamp,
a third portion of said plurality of alternating lamp voltages decrease in magnitude of voltage for a third time period during which said lamp is becomes nonionized, and
wherein said first time period, said second time period, and said third time period occur during a half cycle of said line frequency;
said step of modifying the rectified AC line voltage resulting in altering the light output of said lamp.

23. A system for automatically adjusting illumination of an area in response to a control signal, comprising:
a ballast circuit coupled to a light source, the ballast circuit coupled to receive a time-varying DC voltage at a first node with respect to a second node, said DC voltage varying at twice a line frequency, and said DC voltage being rectified from an AC voltage power source alternating at said line frequency, wherein the ballast circuit is configured to present the DC voltage varying at twice the line frequency across a first terminal and a second terminal of a bypass capacitor, wherein the ballast circuit is further configured to allow said DC voltage to drop to 15% or less of a peak value of said DC voltage every half cycle of the line frequency, and said ballast circuit comprising:
a first switch coupled to the first node operable to selectively couple the first node to a resonant circuit, the resonant circuit having a resonant frequency less than a first frequency and configured to be coupled to a light source, wherein the resonant circuit stores energy during a first portion of a cycle of the first frequency, and a second switch operable to selectively couple the resonant circuit to the second node during a second portion of the cycle of the first frequency;
said first and second switches being coupled to provide an operating voltage to said light source;
a power switch coupled to the ballast circuit, the power switch being selectively alterable from a first state in which the power switch allows an AC line voltage to said ballast circuit to a second state in which the power switch prevents said AC line voltage to said ballast circuit based on a control signal; and
a controller configured to generate said control signal and to provide said control signal to said power switch so as to selectively alter the state of said power switch based on a parameter associated with an area the light source is positioned to illuminate.

24. The system of claim 23, further comprising:
a plurality of said ballast circuits each coupled to one of a plurality of said light sources; and
a plurality of said power switches each coupled to a respective one of the ballast circuits; and wherein
said controller is configured to be capable of selectively determining the content of the control signal for each of said power switches so as to selectively determine the state of each said power switches based on said parameter.
